(19) United States
(12) Patent Application Publication
(10) Pub. No.: US 2026/0304392 A1
(43) Pub. Date: Oct. 1, 2026

(54) DEVICE COORDINATION FOR HOLOGRAPHIC COMMUNICATIONS

(71) Applicant: QUALCOMM Incorporated, San Diego, CA (US)

(72) Inventors: Mickaël MONDET, Louannec (FR); Prashanth Haridas HANDE, San Diego, CA (US); Peerapol TINNAKORNSRISUPHAP, San Diego, CA (US); Simone MERLIN, San Diego, CA (US); Ravi AGARWAL, San Diego, CA (US)

(21) Appl. No.: 19/089,417

(22) Filed: Mar. 25, 2025

(51) Int. Cl. H04W 72/0446; H04L 43/0864; H04W 56/00; H04W 72/1268; H04W 76/30

(52) U.S. Cl. CPC H04W 72/0446; H04L 43/0864; H04W 56/003; H04W 72/1268; H04W 76/30

(57) ABSTRACT

Methods, systems, and devices for wireless communications are described. One or more wireless communication devices may utilize techniques to coordinate holographic communications. For example, respective devices (e.g., user equipment (UEs)) may modify a frame timing for transmitting frames associated with holographic communications, such that each device may receive frames from other devices in a relatively coordinated manner. In some examples, the devices may be configured in a first communication mode (e.g., an always-on communication mode) for communicating the frames and modifying the frame timing. After the frame timing is aligned among the devices, a request to exit the first communication mode may be transmitted, and one or more of the devices may be configured with a power saving mode for the holographic communications. Additionally, or alternatively, an application server may receive timing information from each device, and the application server may provide respective indications for frame timing adjustments.

### FIELD OF TECHNOLOGY

The following relates to wireless communications, including device coordination for holographic communications.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE).

### SUMMARY

The systems, methods, and devices of this disclosure each have several innovative aspects, no single one of which is solely responsible for the desirable attributes disclosed herein.

A method for wireless communications by a wireless communication device is described. The method may include receiving a first control message indicating a first communication mode associated with holographic communications between a set of multiple wireless communication devices, the set of multiple wireless communication devices including the wireless communication device, modifying an uplink frame timing based on a round trip time and a set of multiple data frames received while operating in accordance with the first communication mode, transmitting, based on modifying the uplink frame timing, a message including a request to exit the first communication mode, and receiving a second control message indicating a configuration of a power-saving mode associated with the holographic communications, where receiving the second control message is in accordance with the request to exit the first communication mode, and where the power-saving mode corresponds to less frequent communications than the first communication mode.

A wireless communication device for wireless communications is described. The wireless communication device may include one or more memories storing processor-executable code, and one or more processors coupled with the one or more memories. The one or more processors may individually or collectively be operable to execute the code to cause the wireless communication device to receive a first control message indicating a first communication mode associated with holographic communications between a set of multiple wireless communication devices, the set of multiple wireless communication devices including the wireless communication device, modify an uplink frame timing based on a round trip time and a set of multiple data frames received while operating in accordance with the first communication mode, transmit, based on modifying the uplink frame timing, a message including a request to exit the first communication mode, and receive a second control message indicating a configuration of a power-saving mode associated with the holographic communications, where receiving the second control message is in accordance with the request to exit the first communication mode, and where the power-saving mode corresponds to less frequent communications than the first communication mode.

Another wireless communication device for wireless communications is described. The wireless communication device may include means for receiving a first control message indicating a first communication mode associated with holographic communications between a set of multiple wireless communication devices, the set of multiple wireless communication devices including the wireless communication device, means for modifying an uplink frame timing based on a round trip time and a set of multiple data frames received while operating in accordance with the first communication mode, means for transmitting, based on modifying the uplink frame timing, a message including a request to exit the first communication mode, and means for receiving a second control message indicating a configuration of a power-saving mode associated with the holographic communications, where receiving the second control message is in accordance with the request to exit the first communication mode, and where the power-saving mode corresponds to less frequent communications than the first communication mode.

A non-transitory computer-readable medium storing code for wireless communications is described. The code may include instructions executable by one or more processors to receive a first control message indicating a first communication mode associated with holographic communications between a set of multiple wireless communication devices, the set of multiple wireless communication devices including the wireless communication device, modify an uplink frame timing based on a round trip time and a set of multiple data frames received while operating in accordance with the first communication mode, transmit, based on modifying the uplink frame timing, a message including a request to exit the first communication mode, and receive a second control message indicating a configuration of a power-saving mode associated with the holographic communications, where receiving the second control message is in accordance with the request to exit the first communication mode, and where the power-saving mode corresponds to less frequent communications than the first communication mode.

In some examples of the method, wireless communication devices, and non-transitory computer-readable medium described herein, modifying the uplink frame timing may include operations, features, means, or instructions for calculating a set of multiple time offsets based on the round trip time and the set of multiple data frames, where each time offset of the set of multiple time offsets includes a respective difference between a first time and a second time, the first time including a time instance that may be the round trip time after transmission of a first frame by the wireless communication device, the second time including a reception time of a data frame of the set of multiple data frames from a respective wireless communication device of the set of multiple wireless communication devices, calculating a mean time offset based on the set of multiple time offsets, and modifying the uplink frame timing based on the mean time offset.

Some examples of the method, wireless communication devices, and non-transitory computer-readable medium described herein may further include operations, features, means, or instructions for comparing the mean time offset to the round trip time, where modifying the uplink frame timing may be based on the mean time offset being different from the round trip time.

Some examples of the method, wireless communication devices, and non-transitory computer-readable medium described herein may further include operations, features, means, or instructions for calculating an evaluation time offset for each evaluation period of one or more evaluation periods, each evaluation period of the one or more evaluation periods including a set of multiple consecutive traffic periods, and each traffic period of the set of multiple consecutive traffic periods corresponding to a reception window during which the set of multiple data frames may be received.

Some examples of the method, wireless communication devices, and non-transitory computer-readable medium described herein may further include operations, features, means, or instructions for calculating, for each traffic period of the set of multiple consecutive traffic periods, a respective mean time offset based on a set of time offsets associated with each traffic period, where each time offset of the set of time offsets includes the respective difference between the first time and the second time, and where calculating the evaluation time offset includes and calculating the evaluation time offset based on the respective mean time offsets.

Some examples of the method, wireless communication devices, and non-transitory computer-readable medium described herein may further include operations, features, means, or instructions for calculating, for each traffic period of the set of multiple consecutive traffic periods, a reception window size of the reception window corresponding to each traffic period, the reception window size being based on a first data frame and a last data frame of the set of multiple data frames received from the set of multiple wireless communication devices, calculating, for each evaluation period, a mean reception window size based on the reception window sizes, where modifying the uplink frame timing includes, and modifying the uplink frame timing based on the evaluation time offset or the mean reception window size, or both.

In some examples of the method, wireless communication devices, and non-transitory computer-readable medium described herein, modifying the uplink frame timing may include operations, features, means, or instructions for modifying the uplink frame timing in accordance with the evaluation time offset based on a time instance corresponding to the evaluation time offset being outside of a threshold timing window.

In some examples of the method, wireless communication devices, and non-transitory computer-readable medium described herein, modifying the uplink frame timing may include operations, features, means, or instructions for modifying the uplink frame timing in accordance with the mean reception window size based on a time instance corresponding to the evaluation time offset being included in a threshold timing window, where modifying the uplink frame timing may be further based on the mean reception window size failing to satisfy a target reception window size.

In some examples of the method, wireless communication devices, and non-transitory computer-readable medium described herein, transmitting the message may include operations, features, means, or instructions for transmitting the message based on a time instance corresponding to the evaluation time offset being included in a threshold timing window and based on the mean reception window size satisfying a target reception window size.

Some examples of the method, wireless communication devices, and non-transitory computer-readable medium described herein may further include operations, features, means, or instructions for transmitting one or more messages including a request to enter the first communication mode based on the round trip time changing from a first round trip time to a second round trip time different from the first round trip time, receiving a third control message indicating the first communication mode, and modifying the uplink frame timing based on the second round trip time and a set of multiple additional data frames received while operating in accordance with the first communication mode.

Some examples of the method, wireless communication devices, and non-transitory computer-readable medium described herein may further include operations, features, means, or instructions for transmitting, based on modifying the uplink frame timing, a second message including the request to exit the first communication mode and receiving a fourth control message indicating a second configuration of the power-saving mode associated with the holographic communications, where receiving the fourth control message may be in accordance with the request to exit the first communication mode.

Some examples of the method, wireless communication devices, and non-transitory computer-readable medium described herein may further include operations, features, means, or instructions for receiving one or more control messages including an indication of a set of parameters associated with modifying the uplink frame timing, where modifying the uplink frame timing includes and modifying the uplink frame timing in accordance with the set of parameters.

In some examples of the method, wireless communication devices, and non-transitory computer-readable medium described herein, the set of parameters includes an activation parameter, a round trip time parameter, one or more evaluation period parameters, one or more uplink offset steps, a threshold quantity of evaluation periods, a target reception window size, or any combination thereof.

In some examples of the method, wireless communication devices, and non-transitory computer-readable medium described herein, modifying the uplink frame timing may include operations, features, means, or instructions for modifying the uplink frame timing using one or more uplink offset increments.

In some examples of the method, wireless communication devices, and non-transitory computer-readable medium described herein, the message includes an indication of one or more parameters associated with the power-saving mode and the configuration of the power-saving mode may be based on the indication of the one or more parameters.

In some examples of the method, wireless communication devices, and non-transitory computer-readable medium described herein, the first communication mode may be based on a service associated with the holographic communications being established with one or more network entities and the first communication mode may be associated with a quantity of physical downlink control channel (PDCCH) monitoring occasions that satisfies a threshold quantity of PDCCH monitoring occasions, or a quantity of scheduled uplink resource grants that satisfies a threshold quantity of scheduled uplink resource grants, or any combination thereof.

Some examples of the method, wireless communication devices, and non-transitory computer-readable medium described herein may further include operations, features, means, or instructions for transmitting the message including the request to exit the first communication mode may be via radio resource control signaling, via one or more medium access control-control elements, via uplink control information, or any combination thereof.

A method for wireless communications by a wireless communication device is described. The method may include transmitting a timing information report indicative of a transmission time of a data frame transmitted by the wireless communication device and respective reception times of a set of multiple data frames received by the wireless communication device, where the data frame and the set of multiple data frames are associated with holographic communications between a set of multiple wireless communication devices including the wireless communication device, receiving a timing update message including an indication to modify an uplink frame timing associated with the holographic communications, where the indication to modify the uplink frame timing is based on the timing information report, and modifying the uplink frame timing in accordance with the timing update message.

A wireless communication device for wireless communications is described. The wireless communication device may include one or more memories storing processor executable code, and one or more processors coupled with the one or more memories. The one or more processors may individually or collectively be operable to execute the code to cause the wireless communication device to transmit a timing information report indicative of a transmission time of a data frame transmitted by the wireless communication device and respective reception times of a set of multiple data frames received by the wireless communication device, where the data frame and the set of multiple data frames are associated with holographic communications between a set of multiple wireless communication devices including the wireless communication device, receive a timing update message including an indication to modify an uplink frame timing associated with the holographic communications, where the indication to modify the uplink frame timing is based on the timing information report, and modify the uplink frame timing in accordance with the timing update message.

Another wireless communication device for wireless communications is described. The wireless communication device may include means for transmitting a timing information report indicative of a transmission time of a data frame transmitted by the wireless communication device and respective reception times of a set of multiple data frames received by the wireless communication device, where the data frame and the set of multiple data frames are associated with holographic communications between a set of multiple wireless communication devices including the wireless communication device, means for receiving a timing update message including an indication to modify an uplink frame timing associated with the holographic communications, where the indication to modify the uplink frame timing is based on the timing information report, and means for modifying the uplink frame timing in accordance with the timing update message.

A non-transitory computer-readable medium storing code for wireless communications is described. The code may include instructions executable by one or more processors to transmit a timing information report indicative of a transmission time of a data frame transmitted by the wireless communication device and respective reception times of a set of multiple data frames received by the wireless communication device, where the data frame and the set of multiple data frames are associated with holographic communications between a set of multiple wireless communication devices including the wireless communication device, receive a timing update message including an indication to modify an uplink frame timing associated with the holographic communications, where the indication to modify the uplink frame timing is based on the timing information report, and modify the uplink frame timing in accordance with the timing update message.

Some examples of the method, wireless communication devices, and non-transitory computer-readable medium described herein may further include operations, features, means, or instructions for receiving one or more control messages including a configuration of the timing information report, where transmitting the timing information report includes and transmitting the timing information report in accordance with the configuration.

In some examples of the method, wireless communication devices, and non-transitory computer-readable medium described herein, the configuration includes a periodicity associated with transmitting the timing information report, one or more reporting conditions associated with transmitting the timing information report, one or more timing thresholds associated with receiving the set of multiple data frames, one or more time windows associated with timing measurements, or any combination thereof.

In some examples of the method, wireless communication devices, and non-transitory computer-readable medium described herein, modifying the uplink frame timing may include operations, features, means, or instructions for modifying the uplink frame timing in accordance with one or more timing offsets indicated via the timing update message, the method further including and transmitting one or more data frames in accordance with the modified uplink frame timing.

In some examples of the method, wireless communication devices, and non-transitory computer-readable medium described herein, the timing update message includes one or more data frames that may be associated with the holographic communications.

Some examples of the method, wireless communication devices, and non-transitory computer-readable medium described herein may further include operations, features, means, or instructions for transmitting, based on modifying the uplink frame timing, one or more messages including an indication of the modified uplink frame timing.

In some examples of the method, wireless communication devices, and non-transitory computer-readable medium described herein, the one or more messages include a radio resource control message, a medium access control-control element, uplink control information, or any combination thereof.

In some examples of the method, wireless communication devices, and non-transitory computer-readable medium described herein, the transmission time of the data frame and the respective reception times of the set of multiple data frames may be based on a reference time.

In some examples of the method, wireless communication devices, and non-transitory computer-readable medium described herein, the reference time may be associated with a global positioning system (GPS) time.

In some examples of the method, wireless communication devices, and non-transitory computer-readable medium described herein, the timing information report indicates the transmission time of the data frame and the respective reception times of the set of multiple data frames based on indicating a difference between the transmission time of the data frame and a reception time of a last data frame of the set of multiple data frames.

A method for wireless communications by a network entity is described. The method may include outputting a first control message indicating a first communication mode associated with holographic communications between a set of multiple wireless communication devices, the set of multiple wireless communication devices including a first wireless communication device, obtaining a message including a request to exit the first communication mode, where obtaining the message occurs after modification of an uplink frame timing of the first wireless communication device in accordance with round trip time and a set of multiple data frames associated with the first communication mode, and outputting a second control message indicating a configuration of a power-saving mode associated with the holographic communications, where outputting the second control message is in accordance with the request to exit the first communication mode.

A network entity for wireless communications is described. The network entity may include one or more memories storing processor executable code, and one or more processors coupled with the one or more memories. The one or more processors may individually or collectively be operable to execute the code to cause the network entity to output a first control message indicating a first communication mode associated with holographic communications between a set of multiple wireless communication devices, the set of multiple wireless communication devices including a first wireless communication device, obtain a message including a request to exit the first communication mode, where obtaining the message occurs after modification of an uplink frame timing of the first wireless communication device in accordance with round trip time and a set of multiple data frames associated with the first communication mode, and output a second control message indicating a configuration of a power-saving mode associated with the holographic communications, where outputting the second control message is in accordance with the request to exit the first communication mode.

Another network entity for wireless communications is described. The network entity may include means for outputting a first control message indicating a first communication mode associated with holographic communications between a set of multiple wireless communication devices, the set of multiple wireless communication devices including a first wireless communication device, means for obtaining a message including a request to exit the first communication mode, where obtaining the message occurs after modification of an uplink frame timing of the first wireless communication device in accordance with round trip time and a set of multiple data frames associated with the first communication mode, and means for outputting a second control message indicating a configuration of a power-saving mode associated with the holographic communications, where outputting the second control message is in accordance with the request to exit the first communication mode.

A non-transitory computer-readable medium storing code for wireless communications is described. The code may include instructions executable by one or more processors to output a first control message indicating a first communication mode associated with holographic communications between a set of multiple wireless communication devices, the set of multiple wireless communication devices including a first wireless communication device, obtain a message including a request to exit the first communication mode, where obtaining the message occurs after modification of an uplink frame timing of the first wireless communication device in accordance with round trip time and a set of multiple data frames associated with the first communication mode, and output a second control message indicating a configuration of a power-saving mode associated with the holographic communications, where outputting the second control message is in accordance with the request to exit the first communication mode.

Some examples of the method, network entities, and non-transitory computer-readable medium described herein may further include operations, features, means, or instructions for obtaining one or more messages including a request for the first communication mode based on the round trip time changing from a first round trip time to a second round trip time different from the first round trip time, outputting a third control message indicating the first communication mode, obtaining a second message after the uplink frame timing may be further modified in accordance with the second round trip time, the second message including the request to exit the first communication mode, and outputting a fourth control message indicating a second configuration of the power-saving mode associated with the holographic communications, where outputting the fourth control message may be in accordance with the request to exit the first communication mode.

Some examples of the method, network entities, and non-transitory computer-readable medium described herein may further include operations, features, means, or instructions for outputting one or more messages including an indication of a set of parameters associated with modifying the uplink frame timing, where the set of parameters includes an activation parameter, a round trip time parameter, one or more evaluation period parameters, one or more uplink offset steps, a threshold quantity of evaluation periods, a target reception window size, or any combination thereof.

In some examples of the method, network entities, and non-transitory computer-readable medium described herein, the message includes an indication of one or more parameters associated with the power-saving mode and the configuration of the power-saving mode may be based on the indication of the one or more parameters.

In some examples of the method, network entities, and non-transitory computer-readable medium described herein, the first communication mode may be based on a service associated with the holographic communications being established with the network entity and the first communication mode may be associated with a quantity of PDCCH monitoring occasions that satisfies a threshold quantity of PDCCH monitoring occasions, or a quantity of scheduled uplink resource grants that satisfies a threshold quantity of scheduled uplink resource grants, or any combination thereof.

Some examples of the method, network entities, and non-transitory computer-readable medium described herein may further include operations, features, means, or instructions for obtaining the message including the request to exit the first communication mode may be via radio resource control signaling, via one or more medium access control-control elements, via uplink control information, or any combination thereof.

A method for wireless communications by an application server is described. The method may include obtaining a respective timing information report from each wireless communication device of a set of multiple wireless communication devices, where the respective timing information reports are each indicative of a transmission time of a data frame transmitted by a respective wireless communication device and respective reception times of a set of multiple data frames received by the respective wireless communication device, the data frame and the set of multiple data frames associated with holographic communications between the set of multiple wireless communication devices and outputting, to each wireless communication device of the set of multiple wireless communication devices, a respective timing update message including an indication to modify an uplink frame timing associated with the holographic communications, where the indication to modify the uplink frame timing is based on the respective timing information reports.

An application server for wireless communications is described. The application server may include one or more memories storing processor executable code, and one or more processors coupled with the one or more memories. The one or more processors may individually or collectively be operable to execute the code to cause the application server to obtain a respective timing information report from each wireless communication device of a set of multiple wireless communication devices, where the respective timing information reports are each indicative of a transmission time of a data frame transmitted by a respective wireless communication device and respective reception times of a set of multiple data frames received by the respective wireless communication device, the data frame and the set of multiple data frames associated with holographic communications between the set of multiple wireless communication devices and output, to each wireless communication device of the set of multiple wireless communication devices, a respective timing update message including an indication to modify an uplink frame timing associated with the holographic communications, where the indication to modify the uplink frame timing is based on the respective timing information reports.

Another application server for wireless communications is described. The application server may include means for obtaining a respective timing information report from each wireless communication device of a set of multiple wireless communication devices, where the respective timing information reports are each indicative of a transmission time of a data frame transmitted by a respective wireless communication device and respective reception times of a set of multiple data frames received by the respective wireless communication device, the data frame and the set of multiple data frames associated with holographic communications between the set of multiple wireless communication devices and means for outputting, to each wireless communication device of the set of multiple wireless communication devices, a respective timing update message including an indication to modify an uplink frame timing associated with the holographic communications, where the indication to modify the uplink frame timing is based on the respective timing information reports.

A non-transitory computer-readable medium storing code for wireless communications is described. The code may include instructions executable by one or more processors to obtain a respective timing information report from each wireless communication device of a set of multiple wireless communication devices, where the respective timing information reports are each indicative of a transmission time of a data frame transmitted by a respective wireless communication device and respective reception times of a set of multiple data frames received by the respective wireless communication device, the data frame and the set of multiple data frames associated with holographic communications between the set of multiple wireless communication devices and output, to each wireless communication device of the set of multiple wireless communication devices, a respective timing update message including an indication to modify an uplink frame timing associated with the holographic communications, where the indication to modify the uplink frame timing is based on the respective timing information reports.

Some examples of the method, application servers, and non-transitory computer-readable medium described herein may further include operations, features, means, or instructions for outputting one or more control messages including a configuration of the respective timing information reports, where obtaining the respective timing information report includes and obtaining the respective timing information report in accordance with the configuration.

In some examples of the method, application servers, and non-transitory computer-readable medium described herein, the configuration includes a periodicity associated with transmitting the respective timing information reports, one or more reporting conditions associated with transmitting the respective timing information reports, one or more timing thresholds associated with receiving the set of multiple data frames, one or more time windows associated with timing measurements, or any combination thereof.

In some examples of the method, application servers, and non-transitory computer-readable medium described herein, the respective timing update messages indicate one or more timing offsets associated with modifying the uplink frame timing.

In some examples of the method, application servers, and non-transitory computer-readable medium described herein, the transmission time of the data frame and the respective reception times of the set of multiple data frames may be based on a reference time.

In some examples of the method, application servers, and non-transitory computer-readable medium described herein, the reference time may be associated with a GPS time.

In some examples of the method, application servers, and non-transitory computer-readable medium described herein, the respective timing information report indicates the transmission time of the data frame and the respective reception times of the set of multiple data frames based on indicating a difference between the transmission time of the data frame a reception time of a last data frame of the set of multiple data frames.

Details of one or more implementations of the subject matter described in this disclosure are set forth in the accompanying drawings and the description below. Other features, aspects, and advantages will become apparent from the description, the drawings, and the claims. Note that the relative dimensions of the following figures may not be drawn to scale.

### BRIEF DESCRIPTION OF THE DRAWINGS

FIG. 1 shows an example of a wireless communications system that supports device coordination for holographic communications in accordance with one or more aspects of the present disclosure.

FIG. 2 shows an example of a wireless communications system that supports device coordination for holographic communications in accordance with one or more aspects of the present disclosure.

FIGS. 3A, 3B, 3C, and 3D show examples of signaling diagrams that support device coordination for holographic communications in accordance with one or more aspects of the present disclosure.

FIGS. 4A, 4B, and 4C show examples of signaling diagrams that support device coordination for holographic communications in accordance with one or more aspects of the present disclosure.

FIGS. 5A, 5B, 5C, and 5D show examples of signaling diagrams that support device coordination for holographic communications in accordance with one or more aspects of the present disclosure.

FIGS. 6 through 9 show examples of process flows that supports device coordination for holographic communications in accordance with one or more aspects of the present disclosure.

FIGS. 10 and 11 show examples of signaling diagrams that supports device coordination for holographic communications in accordance with one or more aspects of the present disclosure.

FIGS. 12 and 13 show block diagrams of devices that support device coordination for holographic communications in accordance with one or more aspects of the present disclosure.

FIG. 14 shows a block diagram of a communications manager that supports device coordination for holographic communications in accordance with one or more aspects of the present disclosure.

FIG. 15 shows a diagram of a system including a device that supports device coordination for holographic communications in accordance with one or more aspects of the present disclosure.

FIGS. 16 and 17 show block diagrams of devices that support device coordination for holographic communications in accordance with one or more aspects of the present disclosure.

FIG. 18 shows a block diagram of a communications manager that supports device coordination for holographic communications in accordance with one or more aspects of the present disclosure.

FIG. 19 shows a diagram of a system including a device that supports device coordination for holographic communications in accordance with one or more aspects of the present disclosure.

FIGS. 20 and 21 show block diagrams of devices that support device coordination for holographic communications in accordance with one or more aspects of the present disclosure.

FIG. 22 shows a block diagram of a communications manager that supports device coordination for holographic communications in accordance with one or more aspects of the present disclosure.

FIG. 23 shows a diagram of a system including a device that supports device coordination for holographic communications in accordance with one or more aspects of the present disclosure.

FIGS. 24 through 27 show flowcharts illustrating methods that support device coordination for holographic communications in accordance with one or more aspects of the present disclosure.

### DETAILED DESCRIPTION

Some wireless communications systems may support holographic communications between two or more users. Holographic communications may refer to technologies that support the transmission of three-dimensional (3D) images by one user to one or more other users (and their corresponding devices), enabling the reproduction of the 3D images as a realistic representation of an individual and/or objects, which may enable interactions with such individuals and objects as if they were physically present. For example, holographic communications may include video capture via a user equipment (UE) (and/or one or more peripheral devices), where corresponding video frames may be transmitted to an application server via one or more radio access technologies (RATs) (such as via a fifth generation (5G) new radio (NR) system, among other examples). The video frames may be received by other UEs (and/or peripheral devices) included in the holographic communications session, which may be rendered and presented to a user.

In some cases, wireless communications systems supporting holographic communications may implement a selective forwarding unit (SFU) architecture. An SFU may be an example of a media server or other type of server that may be configured to support, for example, group calls, videoconferencing (e.g., multi-party conferencing), and live broadcasts, among other examples. In accordance with the SFU architecture, an application server may forward (e.g., immediately forward) frames associated with the holographic communications (e.g., audio and video streams) to each of one or more other UEs. In such examples, each UE may receive the frames of all other UEs, and the frames may be used for scene rendering and display (e.g., via a headset or one or more other peripheral devices). As an example, for each time interval (e.g., for each 1/frame per second (fps)) of a holographic communications session including N users (e.g., UEs, devices), each user may transmit one video frame (e.g., a data frame) to the application server, and each user may also receive N−1 video frames from the application server.

In some cases, however, various wireless communication devices performing holographic communications may be uncoordinated, and respective frames from some devices may arrive at different times, which may affect rendering and performance of the holographic communications. As an example, a video frame may be rendered by a UE when the frame is received, and a UE may therefore have to perform multiple scene rendering operations when frames from one or more other UEs are received in a disjoint or uncoordinated manner (e.g., separated in time). Multiple rendering operations may accordingly affect UE power consumption and, in some cases, may require a relatively high degree of processing capability. Additionally, such rendering operations may result in relatively “old” video frames (e.g., frames as old as 1/fps) being rendered by a device, thereby affecting the quality of the holographic communications, the user experience associated with the holographic communications, or both. Moreover, when a UE implements one or more power savings modes or techniques (such as connected mode discontinuous reception (C-DRX)), end-to-end latencies of the holographic communications may be affected, which may likewise affect the quality and performance of the holographic communications.

As described herein, techniques may enable the coordination of frames transmitted and received by wireless communication devices (e.g., UEs and/or peripheral devices). As an example, an uplink frame timing may be adjusted by respective wireless communication devices (e.g., the devices included in a holographic communications session) to enable reception of holographic communications frames (such as video frames, data frames) in a coordinated manner, such that frames are approximately aligned in time (e.g., frames from other devices are received by a device within some threshold duration). The described techniques may include, for example, coordination techniques performed by the UEs included in a holographic communications session (which may be referred to as UE-based UE coordination) and/or coordination techniques performed by one or more application servers associated with the holographic communications (which may be referred to as application server-based UE coordination).

In the example of UE-based UE coordination, one or more UEs of a set of multiple UEs may, after establishing a holographic communications session, receive one or more control messages configuring the one or more UEs with a first communication mode. The first communication mode may be referred to as an always-on communication mode via which each UE is provided with relatively frequent uplink resources for uplink transmissions (e.g., frequent uplink scheduling). The always-on mode may accordingly be associated with relatively frequent communications by each of the one or more UEs, and the UEs may, in some cases, refrain from utilizing power savings techniques while in the always-on communication mode. When operating in accordance with the first communication mode, the set of UEs may exchange signaling for the holographic communications, which may include the transmission and reception of frames (e.g., video frames, data frames). In such cases, each UE of the set of multiple UEs may adjust its uplink frame timing based on a round trip time (RTT) of that UE and respective time instances during which the UE receives holographic communications frames from other UEs. As an example, a first UE may determine a difference between its own RTT and a time instance at which a frame from a second UE is received. The first UE may determine respective differences for frames received from each of the other UEs in the set, and the first UE may calculate a mean difference based on the respective differences. The mean difference may be used to adjust an uplink frame timing of the first UE. For example, if a time instance corresponding to the mean difference (e.g., relative to the RTT of the first UE) is outside of a threshold time window, then the first UE may modify its uplink frame timing (e.g., adding or subtracting a time offset or step value to adjust the frame timing).

Such techniques performed by the set of UEs included in a holographic communications session may enable each UE to coordinate its own uplink transmissions relative to the reception of frames from other UEs so that the frames are received by the other UEs in as short of a duration as possible (e.g., so that frames received from other UEs arrive within some time window). After each UE has adjusted its uplink frame timing and/or determined that its uplink frame timing is relatively stable and coordinated with other UEs, each UE may transmit an indication requesting that the always-on communication mode be ended (e.g., a request to exit the first communication mode). In response, each UE may receive another control message that indicates a configuration of a power saving mode (such as C-DRX) having relatively less frequent uplink scheduling (such as in accordance with an uplink configured grant scheme), and each UE may utilize the power saving mode during the holographic communications session.

In the example of the application server-based UE coordination techniques, an application server may determine an optimal uplink frame timing for each UE, and the application server may signal (e.g., to respective application clients of each UE) an indication to modify a frame timing. As an example, a timing information report may be provided from each application client to the application server, where the respective timing information reports may each indicate time instances corresponding to when an application client of a UE issued one or more frames and when the application client received frames from other UEs (e.g., from other users). The application server may calculate one or more frame timing adjustments based on the content of the timing information report, and the application server may respond with information indicative of a frame timing adjustment to be applied when a subsequent frame is issued by the application client. In some examples, the radio access network (RAN) via which messages are transmitted between the application clients and the application server may be notified of the frame timing adjustment for each application client. As such, the application server may coordinate the frame timing of multiple UEs included in a holographic communications session to enable each UE to receive frames from other UEs in a coordinated manner.

Particular aspects of the subject matter described in this disclosure may be implemented to realize one or more of the following potential advantages. For example, the coordination of holographic communications frames between wireless communication devices may enable improved rendering of video and other frames. For instance, when frames from other users are received at approximately the same time (or within some time range), a device rendering holographic communications may perform relatively fewer rendering operations (as compared to when frames are received at different times or in a disjoint manner). Relatively fewer rendering operations may accordingly result in power savings at one or more devices (which may extend battery life) and may also improve the quality of the communications. Moreover, when holographic communications frames are received in a coordinated manner, a rendered scene may include relatively recent frames received from other devices (e.g., video frames may be rendered with relatively reduced latency), which may enhance performance and improve user experience. In some aspects, the coordination of frames exchanged by wireless communications devices may enable the efficient use of power saving modes (such as C-DRX). For example, a wireless communication device may enable C-DRX procedures to save power, while also receiving coordinated frames from other wireless communication devices during an awake period, which may limit or reduce latency associated with the reception of holographic communications frames when a device is also operating in the power saving mode. Such techniques may thus promote efficient communications when power saving techniques are used, which may enhance battery life.

Aspects of the disclosure are initially described in the context of wireless communications systems and described with reference to signaling diagrams and process flows. Aspects of the disclosure are further illustrated by and described with reference to apparatus diagrams, system diagrams, and flowcharts that relate to device coordination for holographic communications.

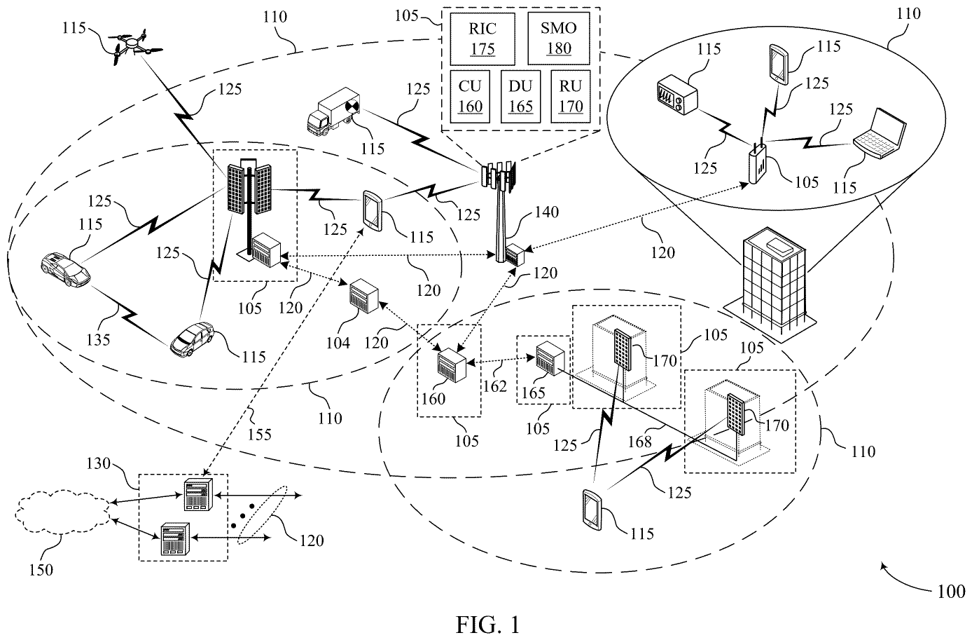

FIG. 1 shows an example of a wireless communications system 100 that supports device coordination for holographic communications in accordance with one or more aspects of the present disclosure. The wireless communications system 100 may include one or more devices, such as one or more network devices (e.g., network entities 105), one or more UEs 115, and a core network 130. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a RAN node, or network equipment, among other nomenclature. In some examples, network entities 105 and UEs 115 may wirelessly communicate via communication link(s) 125 (e.g., a radio frequency (RF) access link). For example, a network entity 105 may support a coverage area 110 (e.g., a geographic coverage area) over which the UEs 115 and the network entity 105 may establish the communication link(s) 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be capable of supporting communications with various types of devices in the wireless communications system 100 (e.g., other wireless communication devices, including UEs 115 or network entities 105), as shown in FIG. 1.

As described herein, a node of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

In some examples, network entities 105 may communicate with a core network 130, or with one another, or both. For example, network entities 105 may communicate with the core network 130 via backhaul communication link(s) 120 (e.g., in accordance with an S1, N2, N3, or other interface protocol). In some examples, network entities 105 may communicate with one another via backhaul communication link(s) 120 (e.g., in accordance with an X2, Xn, or other interface protocol) either directly (e.g., directly between network entities 105) or indirectly (e.g., via the core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication link(s) 120, midhaul communication links 162, or fronthaul communication links 168 may be or include one or more wired links (e.g., an electrical link, an optical fiber link) or one or more wireless links (e.g., a radio link, a wireless optical link), among other examples or various combinations thereof. A UE 115 may communicate with the core network 130 via a communication link 155.

One or more of the network entities 105 or network equipment described herein may include or may be referred to as a base station 140 (e.g., a base transceiver station, a radio base station, an NR base station, an access point, a radio transceiver, a NodeB, an eNodeB (eNB), a next-generation NodeB or giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within one network entity (e.g., a network entity 105 or a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among multiple network entities (e.g., network entities 105), such as an integrated access and backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU), such as a CU 160, a distributed unit (DU), such as a DU 165, a radio unit (RU), such as an RU 170, a RAN Intelligent Controller (RIC), such as an RIC 175 (e.g., a Near-Real Time RIC (Near-RT RIC), a Non-Real Time RIC (Non-RT RIC)), a Service Management and Orchestration (SMO) system, such as an SMO system 180, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some examples, one or more of the network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending on which functions (e.g., network layer functions, protocol layer functions, baseband functions, RF functions, or any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3 (L3), layer 2 (L2)) functionality and signaling (e.g., Radio Resource Control (RRC), service data adaptation protocol (SDAP), Packet Data Convergence Protocol (PDCP)). The CU 160 (e.g., one or more CUs) may be connected to a DU 165 (e.g., one or more DUs) or an RU 170 (e.g., one or more RUs), or some combination thereof, and the DUs 165, RUs 170, or both may host lower protocol layers, such as layer 1 (L1) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or multiple different RUs, such as an RU 170). In some cases, a functional split between a CU 160 and a DU 165 or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to a DU 165 via a midhaul communication link 162 (e.g., F1, F1-c, F1-u), and a DU 165 may be connected to an RU 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities (e.g., one or more of the network entities 105) that are in communication via such communication links.

In some wireless communications systems (e.g., the wireless communications system 100), infrastructure and spectral resources for radio access may support wireless backhaul link capabilities to supplement wired backhaul connections, providing an IAB network architecture (e.g., to a core network 130). In some cases, in an IAB network, one or more of the network entities 105 (e.g., network entities 105 or IAB node(s) 104) may be partially controlled by each other. The IAB node(s) 104 may be referred to as a donor entity or an IAB donor. A DU 165 or an RU 170 may be partially controlled by a CU 160 associated with a network entity 105 or base station 140 (such as a donor network entity or a donor base station). The one or more donor entities (e.g., IAB donors) may be in communication with one or more additional devices (e.g., IAB node(s) 104) via supported access and backhaul links (e.g., backhaul communication link(s) 120). IAB node(s) 104 may include an IAB mobile termination (IAB-MT) controlled (e.g., scheduled) by one or more DUs (e.g., DUs 165) of a coupled IAB donor. An IAB-MT may be equipped with an independent set of antennas for relay of communications with UEs 115 or may share the same antennas (e.g., of an RU 170) of IAB node(s) 104 used for access via the DU 165 of the IAB node(s) 104 (e.g., referred to as virtual IAB-MT (vIAB-MT)). In some examples, the IAB node(s) 104 may include one or more DUs (e.g., DUs 165) that support communication links with additional entities (e.g., IAB node(s) 104, UEs 115) within the relay chain or configuration of the access network (e.g., downstream). In such cases, one or more components of the disaggregated RAN architecture (e.g., the IAB node(s) 104 or components of the IAB node(s) 104) may be configured to operate according to the techniques described herein.

For instance, an access network (AN) or RAN may include communications between access nodes (e.g., an IAB donor), IAB node(s) 104, and one or more UEs 115. The IAB donor may facilitate connection between the core network 130 and the AN (e.g., via a wired or wireless connection to the core network 130). That is, an IAB donor may refer to a RAN node with a wired or wireless connection to the core network 130. The IAB donor may include one or more of a CU 160, a DU 165, and an RU 170, in which case the CU 160 may communicate with the core network 130 via an interface (e.g., a backhaul link). The IAB donor and IAB node(s) 104 may communicate via an F1 interface according to a protocol that defines signaling messages (e.g., an F1 AP protocol). Additionally, or alternatively, the CU 160 may communicate with the core network 130 via an interface, which may be an example of a portion of a backhaul link, and may communicate with other CUs (e.g., including a CU 160 associated with an alternative IAB donor) via an Xn-C interface, which may be an example of another portion of a backhaul link.

IAB node(s) 104 may refer to RAN nodes that provide IAB functionality (e.g., access for UEs 115, wireless self-backhauling capabilities). A DU 165 may act as a distributed scheduling node towards child nodes associated with the IAB node(s) 104, and the IAB-MT may act as a scheduled node towards parent nodes associated with IAB node(s) 104. That is, an IAB donor may be referred to as a parent node in communication with one or more child nodes (e.g., an IAB donor may relay transmissions for UEs through other IAB node(s) 104). Additionally, or alternatively, IAB node(s) 104 may also be referred to as parent nodes or child nodes to other IAB node(s) 104, depending on the relay chain or configuration of the AN. The IAB-MT entity of IAB node(s) 104 may provide a Uu interface for a child IAB node (e.g., the IAB node(s) 104) to receive signaling from a parent IAB node (e.g., the IAB node(s) 104), and a DU interface (e.g., a DU 165) may provide a Uu interface for a parent IAB node to signal to a child IAB node or UE 115.

For example, IAB node(s) 104 may be referred to as parent nodes that support communications for child IAB nodes, or may be referred to as child IAB nodes associated with IAB donors, or both. An IAB donor may include a CU 160 with a wired or wireless connection (e.g., backhaul communication link(s) 120) to the core network 130 and may act as a parent node to IAB node(s) 104. For example, the DU 165 of an IAB donor may relay transmissions to UEs 115 through IAB node(s) 104, or may directly signal transmissions to a UE 115, or both. The CU 160 of the IAB donor may signal communication link establishment via an F1 interface to IAB node(s) 104, and the IAB node(s) 104 may schedule transmissions (e.g., transmissions to the UEs 115 relayed from the IAB donor) through one or more DUs (e.g., DUs 165). That is, data may be relayed to and from IAB node(s) 104 via signaling via an NR Uu interface to MT of IAB node(s) 104 (e.g., other IAB node(s)). Communications with IAB node(s) 104 may be scheduled by a DU 165 of the IAB donor or of IAB node(s) 104.

In the case of the techniques described herein applied in the context of a disaggregated RAN architecture, one or more components of the disaggregated RAN architecture may be configured to support device coordination for holographic communications as described herein. For example, some operations described as being performed by a UE 115 or a network entity 105 (e.g., a base station 140) may additionally, or alternatively, be performed by one or more components of the disaggregated RAN architecture (e.g., components such as an IAB node, a DU 165, a CU 160, an RU 170, an RIC 175, an SMO system 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, vehicles, or meters, among other examples.

The UEs 115 described herein may be able to communicate with various types of devices, such as UEs 115 that may sometimes operate as relays, as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via the communication link(s) 125 (e.g., one or more access links) using resources associated with one or more carriers. The term “carrier” may refer to a set of RF spectrum resources having a defined PHY layer structure for supporting the communication link(s) 125. For example, a carrier used for the communication link(s) 125 may include a portion of an RF spectrum band (e.g., a bandwidth part (BWP)) that is operated according to one or more PHY layer channels for a given RAT (e.g., LTE, LTE-A, LTE-A Pro, NR). Each PHY layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities, such as one or more of the network entities 105).

In some examples, such as in a carrier aggregation configuration, a carrier may have acquisition signaling or control signaling that coordinates operations for other carriers. A carrier may be associated with a frequency channel (e.g., an evolved universal mobile telecommunication system terrestrial radio access (E-UTRA) absolute RF channel number (EARFCN)) and may be identified according to a channel raster for discovery by the UEs 115. A carrier may be operated in a standalone mode, in which case initial acquisition and connection may be conducted by the UEs 115 via the carrier, or the carrier may be operated in a non-standalone mode, in which case a connection is anchored using a different carrier (e.g., of the same or a different RAT).

The communication link(s) 125 of the wireless communications system 100 may include downlink transmissions (e.g., forward link transmissions) from a network entity 105 to a UE 115, uplink transmissions (e.g., return link transmissions) from a UE 115 to a network entity 105, or both, among other configurations of transmissions. Carriers may carry downlink or uplink communications (e.g., in an FDD mode) or may be configured to carry downlink and uplink communications (e.g., in a TDD mode).

In some cases, a UE 115 may monitor a wireless link 125 continuously for an indication that the UE 115 may receive data. In other cases (e.g., to conserve power and extend battery life) a UE 115 may be configured with a discontinuous reception (DRX) cycle. As an example, C-DRX may be used to reduce battery consumption of the UE 115 while the UE 115 is in a connected state, and C-DRX may further balance a trade-off between power efficiency and network responsiveness. A DRX configuration may be associated with a DRX cycle that consists of an “On Duration” when the UE 115 may monitor for control information (e.g., via PDCCH) and a “DRX period” when the UE 115 may power down one or more radio components. As such, the DRX configuration may be associated with one or more timers that are used by the UE 115 to wake and monitor for signaling and to power down components and refrain from monitoring. In some cases, a UE 115 may be configured with a short DRX cycle and a long DRX cycle. In some cases, a UE 115 may enter a long DRX cycle if it is inactive for one or more short DRX cycles. The transition between the short DRX cycle, the long DRX cycle and continuous reception may be controlled by an internal timer or by messaging from a network entity 105. A UE 115 may receive scheduling messages on PDCCH during the On Duration. While monitoring PDCCH for a scheduling message, the UE 115 may initiate a “DRX Inactivity Timer.” If a scheduling message is successfully received, the UE 115 may prepare to receive data and the DRX Inactivity Timer may be reset. When the DRX Inactivity Timer expires without receiving a scheduling message, the UE 115 may move into a short DRX cycle and may start a “DRX Short Cycle Timer.” When the DRX Short Cycle Timer expires, the UE 115 may resume a long DRX cycle. In any case, DRX (e.g., C-DRX) may include techniques used to enhance battery life of a UE 115 while ensuring that the UE 115 efficiently receives data.

A carrier may be associated with a particular bandwidth of the RF spectrum and, in some examples, the carrier bandwidth may be referred to as a “system bandwidth” of the carrier or the wireless communications system 100. For example, the carrier bandwidth may be one of a set of bandwidths for carriers of a particular RAT (e.g., 1.4, 3, 5, 10, 15, 20, 40, or 80 megahertz (MHz)). Devices of the wireless communications system 100 (e.g., the network entities 105, the UEs 115, or both) may have hardware configurations that support communications using a particular carrier bandwidth or may be configurable to support communications using one of a set of carrier bandwidths. In some examples, the wireless communications system 100 may include network entities 105 or UEs 115 that support concurrent communications using carriers associated with multiple carrier bandwidths. In some examples, each served UE 115 may be configured for operating using portions (e.g., a sub-band, a BWP) or all of a carrier bandwidth.

Signal waveforms transmitted via a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both), such that a relatively higher quantity of resource elements (e.g., in a transmission duration) and a relatively higher order of a modulation scheme may correspond to a relatively higher rate of communication. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

The time intervals for the network entities 105 or the UEs 115 may be expressed in multiples of a basic time unit which may, for example, refer to a sampling period of Tₛ=1/(Δ_{fmax}·N_{f}) seconds, for which Δ_{fmax} may represent a supported subcarrier spacing, and N_{f} may represent a supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively-numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems, such as the wireless communications system 100, a slot may further be divided into multiple mini-slots associated with one or more symbols. Excluding the cyclic prefix, each symbol period may be associated with one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (sTTIs)).

Physical channels may be multiplexed for communication using a carrier according to various techniques. A physical control channel and a physical data channel may be multiplexed for signaling via a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to UEs 115 (e.g., one or more UEs) or may include UE-specific search space sets for sending control information to a UE 115 (e.g., a specific UE).

A network entity 105 may provide communication coverage via one or more cells, for example, a macro cell, a small cell, a hot spot, or other types of cells, or any combination thereof. The term “cell” may refer to a logical communication entity used for communication with a network entity 105 (e.g., using a carrier) and may be associated with an identifier for distinguishing neighboring cells (e.g., a physical cell identifier (PCID), a virtual cell identifier (VCID)). In some examples, a cell also may refer to a coverage area 110 or a portion of a coverage area 110 (e.g., a sector) over which the logical communication entity operates. Such cells may range from smaller areas (e.g., a structure, a subset of structure) to larger areas depending on various factors such as the capabilities of the network entity 105. For example, a cell may be or include a building, a subset of a building, or exterior spaces between or overlapping with coverage areas 110, among other examples.

A macro cell generally covers a relatively large geographic area (e.g., several kilometers in radius) and may allow unrestricted access by the UEs 115 with service subscriptions with the network provider supporting the macro cell. A small cell may be associated with a network entity 105 operating with lower power (e.g., a base station 140 operating with lower power) relative to a macro cell, and a small cell may operate using the same or different (e.g., licensed, unlicensed) frequency bands as macro cells. Small cells may provide unrestricted access to the UEs 115 with service subscriptions with the network provider or may provide restricted access to the UEs 115 having an association with the small cell (e.g., the UEs 115 in a closed subscriber group (CSG), the UEs 115 associated with users in a home or office). A network entity 105 may support one or more cells and may also support communications via the one or more cells using one or multiple component carriers. In some examples, a carrier may support multiple cells, and different cells may be configured according to different protocol types (e.g., MTC, narrowband IoT (NB-IoT), enhanced mobile broadband (eMBB)) that may provide access for different types of devices.

In some examples, a network entity 105 (e.g., a base station 140, an RU 170) may be movable and therefore provide communication coverage for a moving coverage area, such as the coverage area 110. In some examples, coverage areas 110 (e.g., different coverage areas) associated with different technologies may overlap, but the coverage areas 110 (e.g., different coverage areas) may be supported by the same network entity (e.g., a network entity 105). In some other examples, overlapping coverage areas, such as a coverage area 110, associated with different technologies may be supported by different network entities (e.g., the network entities 105). The wireless communications system 100 may include, for example, a heterogeneous network in which different types of the network entities 105 support communications for coverage areas 110 (e.g., different coverage areas) using the same or different RATs.

Some UEs 115 may be configured to employ operating modes that reduce power consumption, such as half-duplex communications (e.g., a mode that supports one-way communication via transmission or reception, but not transmission and reception concurrently). In some examples, half-duplex communications may be performed at a reduced peak rate. Other power conservation techniques for the UEs 115 may include entering a power saving deep sleep mode when not engaging in active communications, operating using a limited bandwidth (e.g., according to narrowband communications), or a combination of these techniques. For example, some UEs 115 may be configured for operation using a narrowband protocol type that is associated with a defined portion or range (e.g., set of subcarriers or resource blocks (RBs)) within a carrier, within a guard-band of a carrier, or outside of a carrier.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be configured to support communicating directly with other UEs (e.g., one or more of the UEs 115) via a device-to-device (D2D) communication link, such as a D2D communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by (e.g., scheduled by) the network entity 105. In some examples, one or more UEs 115 of such a group may be outside the coverage area 110 of a network entity 105 or may be otherwise unable to or not configured to receive transmissions from a network entity 105. In some examples, groups of the UEs 115 communicating via D2D communications may support a one-to-many (1:M) system in which each UE 115 transmits to one or more of the UEs 115 in the group. In some examples, a network entity 105 may facilitate the scheduling of resources for D2D communications. In some other examples, D2D communications may be carried out between the UEs 115 without an involvement of a network entity 105.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. UHF waves may be blocked or redirected by buildings and environmental features, which may be referred to as clusters, but the waves may penetrate structures sufficiently for a macro cell to provide service to the UEs 115 located indoors. Communications using UHF waves may be associated with smaller antennas and shorter ranges (e.g., less than one hundred kilometers) compared to communications using the smaller frequencies and longer waves of the high frequency (HF) or very high frequency (VHF) portion of the spectrum below 300 MHz.

The wireless communications system 100 may utilize both licensed and unlicensed RF spectrum bands. For example, the wireless communications system 100 may employ License Assisted Access (LAA), LTE-Unlicensed (LTE-U) RAT, or NR technology using an unlicensed band such as the 5 GHz industrial, scientific, and medical (ISM) band. While operating using unlicensed RF spectrum bands, devices such as the network entities 105 and the UEs 115 may employ carrier sensing for collision detection and avoidance. In some examples, operations using unlicensed bands may be based on a carrier aggregation configuration in conjunction with component carriers operating using a licensed band (e.g., LAA). Operations using unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located at diverse geographic locations. A network entity 105 may include an antenna array with a set of rows and columns of antenna ports that the network entity 105 may use to support beamforming of communications with a UE 115. Likewise, a UE 115 may include one or more antenna arrays that may support various MIMO or beamforming operations. Additionally, or alternatively, an antenna panel may support RF beamforming for a signal transmitted via an antenna port.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating along particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

A network entity 105 or a UE 115 may use beam sweeping techniques as part of beamforming operations. For example, a network entity 105 (e.g., a base station 140, an RU 170) may use multiple antennas or antenna arrays (e.g., antenna panels) to conduct beamforming operations for directional communications with a UE 115. Some signals (e.g., synchronization signals, reference signals, beam selection signals, or other control signals) may be transmitted by a network entity 105 multiple times along different directions. For example, the network entity 105 may transmit a signal according to different beamforming weight sets associated with different directions of transmission. Transmissions along different beam directions may be used to identify (e.g., by a transmitting device, such as a network entity 105, or by a receiving device, such as a UE 115) a beam direction for later transmission or reception by the network entity 105.

Some signals, such as data signals associated with a particular receiving device, may be transmitted by a transmitting device (e.g., a network entity 105 or a UE 115) along a single beam direction (e.g., a direction associated with the receiving device, such as another network entity 105 or UE 115). In some examples, the beam direction associated with transmissions along a single beam direction may be determined based on a signal that was transmitted along one or more beam directions. For example, a UE 115 may receive one or more of the signals transmitted by the network entity 105 along different directions and may report to the network entity 105 an indication of the signal that the UE 115 received with a highest signal quality or an otherwise acceptable signal quality.

In some examples, transmissions by a device (e.g., by a network entity 105 or a UE 115) may be performed using multiple beam directions, and the device may use a combination of digital precoding or beamforming to generate a combined beam for transmission (e.g., from a network entity 105 to a UE 115). The UE 115 may report feedback that indicates precoding weights for one or more beam directions, and the feedback may correspond to a configured set of beams across a system bandwidth or one or more sub-bands. The network entity 105 may transmit a reference signal (e.g., a cell-specific reference signal (CRS), a channel state information reference signal (CSI-RS)), which may be precoded or unprecoded. The UE 115 may provide feedback for beam selection, which may be a precoding matrix indicator (PMI) or codebook-based feedback (e.g., a multi-panel type codebook, a linear combination type codebook, a port selection type codebook). Although these techniques are described with reference to signals transmitted along one or more directions by a network entity 105 (e.g., a base station 140, an RU 170), a UE 115 may employ similar techniques for transmitting signals multiple times along different directions (e.g., for identifying a beam direction for subsequent transmission or reception by the UE 115) or for transmitting a signal along a single direction (e.g., for transmitting data to a receiving device).

A receiving device (e.g., a UE 115) may perform reception operations in accordance with multiple receive configurations (e.g., directional listening) when receiving various signals from a transmitting device (e.g., a network entity 105), such as synchronization signals, reference signals, beam selection signals, or other control signals. For example, a receiving device may perform reception in accordance with multiple receive directions by receiving via different antenna subarrays, by processing received signals according to different antenna subarrays, by receiving according to different receive beamforming weight sets (e.g., different directional listening weight sets) applied to signals received at multiple antenna elements of an antenna array, or by processing received signals according to different receive beamforming weight sets applied to signals received at multiple antenna elements of an antenna array, any of which may be referred to as “listening” according to different receive configurations or receive directions. In some examples, a receiving device may use a single receive configuration to receive along a single beam direction (e.g., when receiving a data signal). The single receive configuration may be aligned along a beam direction determined based on listening according to different receive configuration directions (e.g., a beam direction determined to have a highest signal strength, highest signal-to-noise ratio (SNR), or otherwise acceptable signal quality based on listening according to multiple beam directions).

The wireless communications system 100 may be a packet-based network that operates according to a layered protocol stack. In the user plane, communications at the bearer or PDCP layer may be IP-based. An RLC layer may perform packet segmentation and reassembly to communicate via logical channels. A MAC layer may perform priority handling and multiplexing of logical channels into transport channels. The MAC layer also may implement error detection techniques, error correction techniques, or both to support retransmissions to improve link efficiency. In the control plane, an RRC layer may provide establishment, configuration, and maintenance of an RRC connection between a UE 115 and a network entity 105 or a core network 130 supporting radio bearers for user plane data. A PHY layer may map transport channels to physical channels.

The UEs 115 and the network entities 105 may support retransmissions of data to increase the likelihood that data is received successfully. Hybrid automatic repeat request (HARQ) feedback is one technique for increasing the likelihood that data is received correctly via a communication link (e.g., the communication link(s) 125, a D2D communication link 135). HARQ may include a combination of error detection (e.g., using a cyclic redundancy check (CRC)), forward error correction (FEC), and retransmission (e.g., automatic repeat request (ARQ)). HARQ may improve throughput at the MAC layer in relatively poor radio conditions (e.g., low signal-to-noise conditions). In some examples, a device may support same-slot HARQ feedback, in which case the device may provide HARQ feedback in a specific slot for data received via a previous symbol in the slot. In some other examples, the device may provide HARQ feedback in a subsequent slot, or according to some other time interval.

The wireless communications system 100 may support techniques for the coordination of holographic communications. For example, respective devices (e.g., UEs 115) may modify a frame timing for transmitting frames associated with holographic communications, such that each device may receive frames from other devices in a relatively coordinated manner based on each device modifying its respective frame timing. In some examples, after establishing a holographic communications session, the devices included in the holographic communications session may be configured to operate in accordance with a first communication mode (e.g., an always-on communication mode), which may be used for communicating frames (e.g., transmitting and receiving frames) and modifying the frame timing. As an example, a wireless communication device may calculate one or more timing offsets based on an RTT associated with frames by an application client and respective instances when frames are received from other wireless communication devices. Using sets of frames exchanged during one or more evaluation periods, a wireless communication device may determine whether an average time offset (or a mean time offset) is within a threshold time window, and the wireless communication device may adjust (e.g., by increments, by steps) its frame timing until the time offset satisfies the threshold time window.

After the frame timing is aligned among the devices, a request to exit the first communication mode may be transmitted, and one or more of the devices may be configured with a power saving mode that may be used during the holographic communications session. Additionally, or alternatively, an application server may receive timing information from each device, and the application server may provide respective indications for frame timing adjustments.

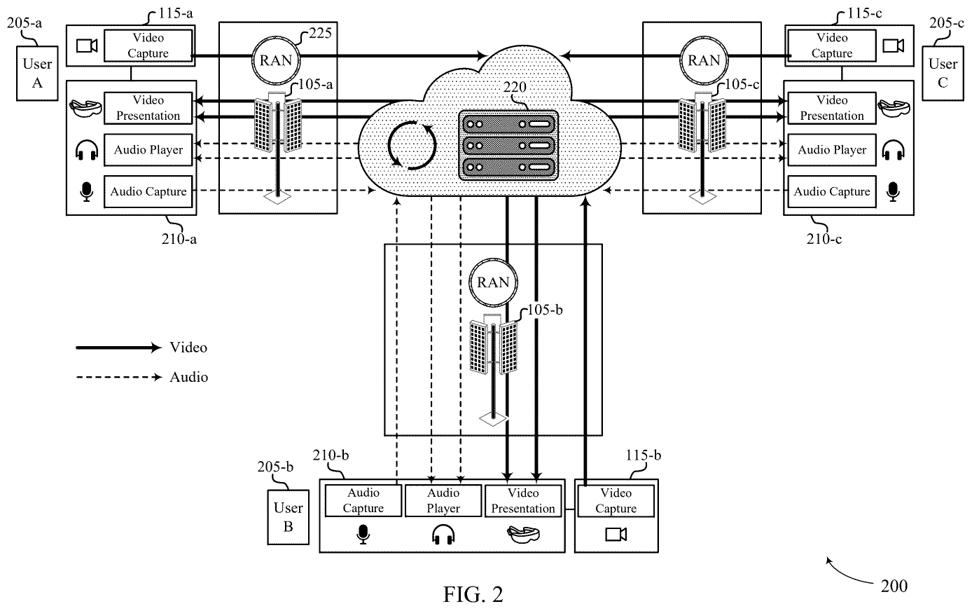

FIG. 2 shows an example of a wireless communications system 200 that supports device coordination for holographic communications in accordance with one or more aspects of the present disclosure. The wireless communications system 200 may implement, or be implemented by, one or more aspects of the wireless communications system 100. In some aspects, the wireless communications system 200 may support techniques for the coordination of holographic communications between wireless communication devices.

Holographic communications may refer technologies that enable the transmission of 3D images between users 205, allowing for the realistic representation and interaction with individuals or objects as if they were physically present. Such technology may leverage aspects of holography in which 3D images are created by recording light patterns and reconstructing the light patterns. Some holographic communications techniques may include, for example, processes for 3D image capture and reconstruction, where cameras and/or sensors are used to capture 3D information of a subject, including depth, texture, and color. Data associated with the 3D information may be transmitted and reconstructed using holographic displays and/or projectors at one or more receiving devices. Based on the rendered information, holographic communications may provide a sense of physical presence for users. As such, holographic communications may be beneficial in various applications and industries. For instance, holographic communications may be utilized for virtual meetings, teleconferences, and collaborative environments where spatial awareness and the ability to perceive gestures and expressions in 3D are important. Moreover, holographic communications may provide enhancements to various fields, including, for example, business and telepresence (e.g., for immersive and effective remote meetings, presentations, and conferences), entertainment and media (e.g., providing enhanced forms of viewer engagement and interactive experiences), education and training (e.g., providing engaging and interactive learning experiences, such as virtual classrooms and simulations), healthcare (e.g., telemedicine and remote consultations with a more realistic representation of patients and/or medical data), and technology development (e.g., development of computational power, bandwidth, and display technologies), to name a few. In some examples, holographic communications may involve two or more users 205, and the data associated with the holographic communications may be represented as holograms in extended reality (XR) scenes (where XR may include or be associated with virtual reality (VR), augmented reality (AR), mixed reality (MR), and/or similar technologies).

The wireless communications system 200 illustrates a system that supports holographic communications between multiple users 205, where each user 205 may be associated with one or more wireless communication devices, such as a UE 115 and/or one or more peripheral devices 210. As an example, a first user 205-a (e.g., user A) may be associated with a first UE 115-a and/or one or more devices 210-a (e.g., peripheral devices), where the UE 115-a and/or the devices 210-a may be an example of a UE 115 described with reference to FIG. 1. Similarly, a second user 205-b (e.g., user B) may be associated with a second UE 115-b and one or more devices 210-b (e.g., peripheral devices), and a third user 205-c (e.g., user C) may be associated with a third UE 115-c and one or more devices 210-c (e.g., peripheral devices). Some aspects of the present disclosure may be described with reference to a user transmitting/receiving frames or performing some operations, and it will be clear to a person having ordinary skill in the art that such descriptions refer to the devices and/or UEs 115 associated with a user that transmit/receive frames or perform some operations in association with one or more network entities 105 and RATs. For example, a user transmitting one or more frames is understood to mean that a UE 115 and/or one or more devices associated with the user transmit the one or more frames, which may be signaled via one or more network entities 105 that operate in accordance with one or more RATs.

The one or more devices 210 associated with each user 205 may include, for example, one or more headsets, booths, tables, projectors, displays, speakers, and/or other types of devices and components that support and/or are configured for rendering of audio and video associated with holographic communications. Such devices may be portable or unportable. As an illustrative example, the one or more devices 210-a may include a headset display that supports video presentation, speakers that support audio presentation, and a microphone that supports audio capture. Further, the UE 115-a may support video capture associated with the holographic communications. In some cases, the UE 115-a may be coupled with (e.g., via a wireless connection, via a wired connection, or both) the one or more device 210-a. In some cases, a UE 115-a may be capable of performing the operations associated with the holographic communications. For example, the UE 115-a may be capable of video capture, video rendering and presentation, audio playback, and/or audio capture. As such, the techniques, functions, and capabilities described herein with reference to a UE 115 may similarly apply to the one or more devices 210, and vice versa. In some examples, one or more UEs 115 and/or the one or more devices 210 may be associated with an application client for the holographic communications, where the application client may communicate sets of frames with the application server.

In some examples, data associated with the UEs 115 and the one or more devices 210 may be communicated via one or more network entities 105 (e.g., a network entity 105-a, a network entity 105-b, a network entity 105-c), which may each be an example of a network entity 105 described with reference to FIG. 1. As an example, the UE 115-a may utilize one or more application to capture video associated with the holographic communications (e.g., using one or more cameras), and the UE 115-a may transmit a set of frames (e.g., video frames, data frames) to an application server 220 via a network entity 105-a. Similarly, the one or more devices 210-a may exchange signaling with the application server 220 via the network entity 105-a. For example, a headset that supports video presentation may receive a set of frames (e.g., video frames, which may be referred to as data frames) from the application server 220 that may be rendered for the holographic communications, and an audio player may receive a set of frames (e.g., audio frames) from the application server 220 that may provide corresponding audio for the holographic communications. In any case, the network entity 105-a may be associated with a RAN 225 (such as a 5G NR network) and may operate in accordance with one or more RATs associated with the RAN 225. In some examples, a UE 115 may receive the frames from the application server 220, and the UE 115 may provide the frames to the one or more devices 210, or the UE 115 may be configured to render audio and video using the received frames.

In some aspects, the wireless communications system 200 may implement an SFU architecture. An SFU may be an example of a media server or other type of server that may be configured to support group calls, videoconferencing (e.g., multi-party conferencing), and live broadcasts, among other examples. In the SFU architecture, every connected device may transmit a set of outgoing media streams to a server (e.g., an application server 220), and the set of streams is forwarded to every other device by the SFU. As an example, an application server 220 (e.g., associated with the SFU architecture) may forward (e.g., immediately forward) frames associated with the holographic communications to each UE 115 (e.g., UE 115-a, UE 115-b, UE 115-c) and/or the one or more devices 210 (e.g., devices 210-a, devices 210-b, devices 210-c). In such examples, each UE 115 may receive the frames of all other UEs 115, and the frames may be used for scene rendering and display by the UE 115 and/or the one or more devices 210 (e.g., via a headset or one or more other peripheral devices). Here, for each time interval (e.g., each 1/fps, where fps may be, for example, 60 fps) of a holographic communications session including N users 205, each UE 115 may transmit one frame (e.g., video frame, data frame) to the application server, and each UE 115 (and/or one or more devices 210) may receive N−1 frames (e.g., N−1 video frames) from the application server 220. Put differently, frames may be transmitted periodically to the application server 220, and the application server 220 may forward the frames to all other users 205 (e.g., UEs 115 and/or devices 210) immediately.

In some cases, however, the various devices performing holographic communications may be uncoordinated (e.g., frame transmission and reception may be uncoordinated), and respective frames from the UEs 115 and/or devices 210 may arrive at different times, which may affect rendering and performance of the holographic communications. As an example, a video frame may be rendered by a UE 115 when the frame is received, and the UE 115 may have to perform multiple scene rendering operations when frames from one or more other users are received in a disjoint or uncoordinated manner. Multiple rendering operations may accordingly affect UE power consumption and may require a relatively high degree of processing capability. Additionally, such rendering operations may result in relatively “old” video frames (e.g., frames as old as 1/fps) being rendered by a device, thereby affecting the quality of the holographic communications. Moreover, when a UE 115 implements one or more power savings modes or techniques (such as C-DRX), end-to-end latencies of the holographic communications may be affected, which may likewise affect the quality of the communications.

As described herein, techniques may enable the coordination of frames transmitted and received by wireless communication devices (e.g., UEs 115 and/or peripheral devices 210). As an example, an uplink frame timing may be adjusted by respective wireless communication devices (e.g., the devices included in a holographic communications session) to enable reception of holographic communications frames (such as video frames) in a coordinated manner, such that frames are approximately aligned in time (e.g., frames from other devices are received by a device within some threshold duration). The described techniques may include, for example, coordination techniques performed by the UEs 115 included in a holographic communications session (which may be referred to as UE-based UE coordination) and/or coordination techniques performed by one or more application servers associated with the holographic communications (which may be referred to as application server-based UE coordination).

In the example of UE-based UE coordination, one or more UEs 115 of a set of multiple UEs 115 may, after establishing a holographic communications session, receive one or more control messages configuring the one or more UEs 115 with a first communication mode. The first communication mode may be referred to as an always-on communication mode via which each UE 115 is provided with relatively frequent uplink resources for uplink transmissions (e.g., frequent uplink scheduling). The always-on mode may accordingly be associated with relatively frequent communications by each of the one or more UEs 115, and the UEs 115 may, in some cases, not be configured with power savings techniques while in the always-on communication mode (e.g., a network entity 105 may not configure the UEs 115 with power savings techniques). When operating in accordance with the first communication mode, the set of UEs 115 may exchange signaling for the holographic communications, which may include the transmission and reception of frames (e.g., video frames, data frames). In such cases, each UE 115 of the set of multiple UEs 115 may adjust its uplink frame timing based on an RTT of that UE 115 and respective time instances during which the UE 115 receives holographic communications frames from other UEs 115. As an example, the first UE 115-a may determine a difference between its own RTT and a time instance at which a frame from the second UE 115-b is received. The first UE 115-a may determine respective differences for frames received from each of the other UEs 115 in the set (e.g., the second UE 115-b and the third UE 115-c, in this example), and the first UE 115-a may calculate a mean difference based on the respective differences. The mean difference may be used to adjust an uplink frame timing of the first UE 115-a. For example, if a time instance corresponding to the mean difference (e.g., relative to the RTT of the first UE 115-a) is outside of a threshold time window, then the first UE 115-a may modify its uplink frame timing (e.g., adding or subtracting a time offset or step value to adjust the frame timing).

Such techniques performed by the set of UEs 115 included in a holographic communications session may enable each UE 115 to coordinate its own uplink transmissions relative to the reception of frames from other UEs 115 so that the frames are received by the other UEs 115 as close in the time domain as possible (e.g., so that frames received from other UEs 115 arrive within some time window). After each UE 115 has adjusted its uplink frame timing and/or determined that its uplink frame timing is relatively stable and coordinated with other UEs 115, each UE 115 may transmit an indication requesting that the always-on communication mode be ended (e.g., a request to exit the first communication mode). In response, each UE 115 may receive another control message that indicates a configuration of a power saving mode (such as C-DRX) having relatively less frequent uplink scheduling (such as in accordance with an uplink configured grant scheme), and each UE 115 may accordingly be configured with the power saving mode for use during the holographic communications session.

In the example of the application server-based UE coordination techniques, an application server may determine an optimal uplink frame timing for each UE 115, and the application server may indicate (e.g., to respective application clients of each UE 115) an indication to modify a frame timing. As an example, a timing information report may be provided from each application client to the application server, where the respective timing information reports may each indicate time instances corresponding to when an application client of a UE 115 issued one or more frames and when the application client received frames from other UEs 115 (e.g., from other users). The application server may calculate one or more frame timing adjustments based on the content of the timing information report, and the application server may respond with information indicative of a frame timing adjustment to be applied when a subsequent frame is issued by the application client. In some examples, the RAN 225 via which messages are transmitted between the application clients and the application server may be notified of the frame timing adjustment for each application client. As such, the application server may coordinate the frame timing of multiple UEs 115 included in a holographic communications session to enable each UE 115 to receive frames from other UEs 115 in a coordinated manner and with reduced or minimized delay.

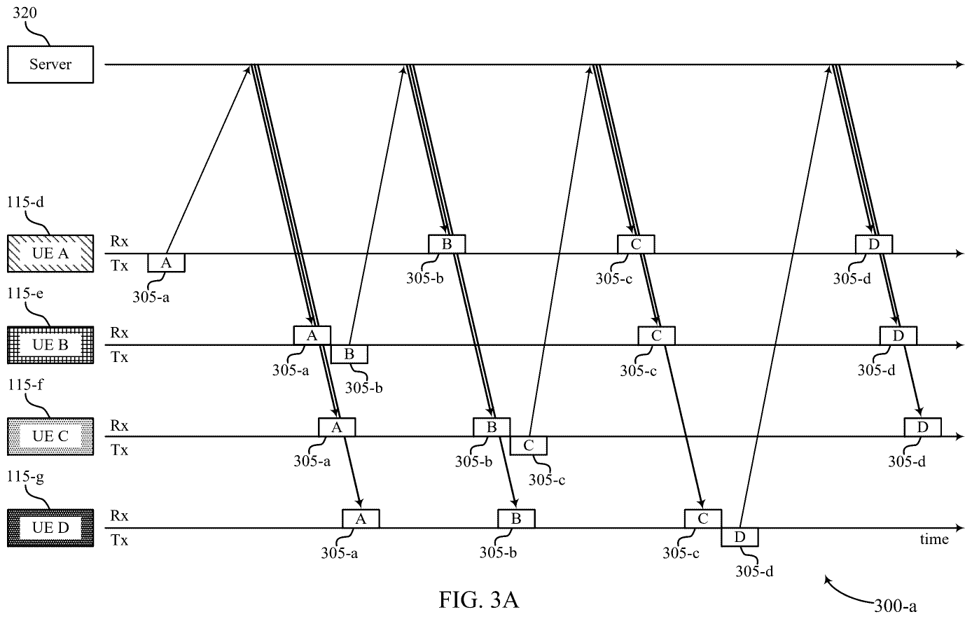

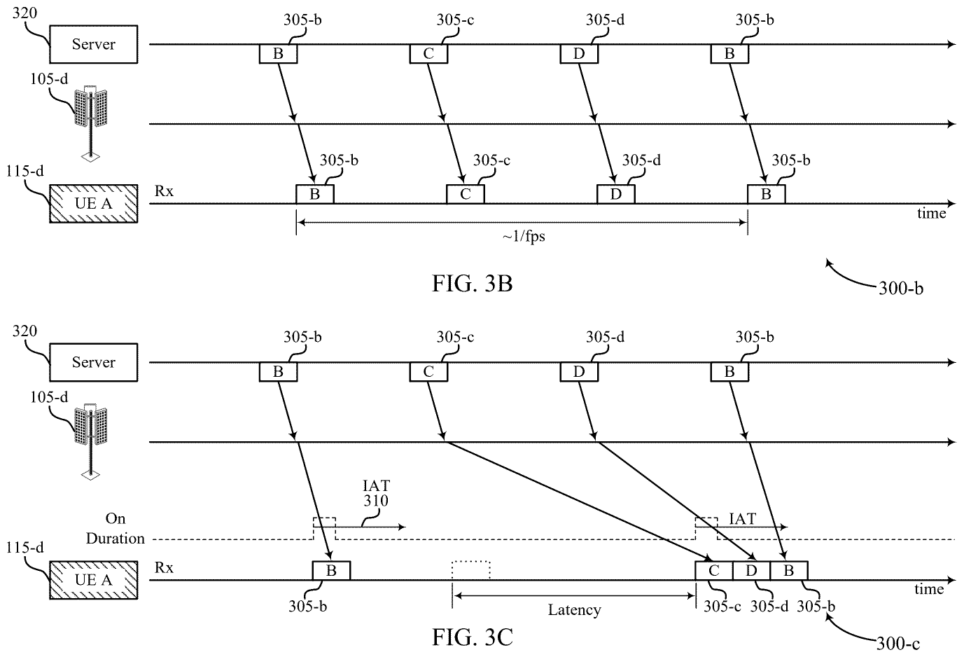

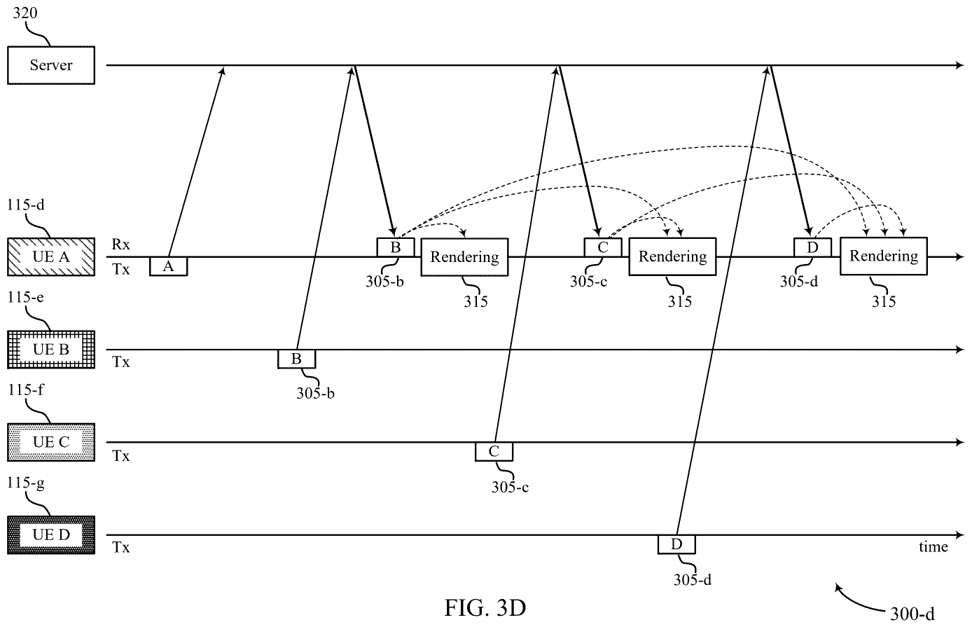

FIGS. 3A, 3B, 3C, and 3D show example of signaling diagrams 300-a, 300-b, 300-c, and 300-d, respectively, that support device coordination for holographic communications in accordance with one or more aspects of the present disclosure. The signaling diagrams 300-a, 300-b, 300-c, and 300-d may each implement or be implemented by aspects of the wireless communications system 100 and the wireless communications system 200. For example, the signaling diagrams 300-a, 300-b, 300-c, and 300-d may illustrate the transmission and reception of one or more frames 305 by one or more wireless communication devices associated with respective users (e.g., a first UE 115-d, a second UE 115-e, a third UE 115-f, and a fourth UE 115-g).

The frames 305 communicated by each UE 115 may, additionally, or alternatively, be transmitted and/or received by one or more peripheral devices, which may be examples of the corresponding devices described with reference to FIGS. 1 and 2. As an example, the first UE 115-d may be coupled with (e.g., via a wired link or a wireless link, or both) or more peripheral devices that may each support techniques and functions associated with holographic communications (such as video capture, video presentation, audio capture, audio playback, among other examples). Although sometimes not shown, each UE 115 may communicate (e.g., transmit and receive) signaling with the application server 320 via one or more network entities (such as a network entity 105 described with reference to FIGS. 1 and 2). That is, each UE 115 depicted in the signaling diagrams 300-a, 300-b, 300-c, and 300-d may transmit and receive frames 305 via at least one network entity 105, where the at least one network entity 105 may be used for communicating the frames 305 between the application server 320 and each UE 115 of a set of multiple UEs 115 (e.g., UE 115-d, UE 115-e, UE 115-f, UE 115-g, and so forth). In some aspects, the application server 320 may be an example of the application server 220 described with reference to FIG. 2.

The signaling diagrams 300-a, 300-b, 300-c, and 300-d may each show signaling exchanged between the UEs 115 (e.g., corresponding to respective users) as part of a holographic communication session (e.g., a holographic communications call). For example, the signaling diagrams 300-a, 300-b, 300-c, and 300-d may represent signaling in a wireless communications system that supports holographic communications (such as the wireless communications system 100 and the wireless communications system 200 described with reference to FIGS. 1 and 2, respectively), which may implement an SFU architecture. Accordingly, after reception of a frame 305 from a UE 115 (e.g., user i), the application server 320 may send the received frame to all other UEs 115 (e.g., users j). In some aspects, the application server 320 may send the frames to the other UEs 115 immediately (e.g., without delay, with minimal delay, within a threshold duration). Further, in a holographic communications session that includes N users (e.g., N UEs 115), each user may receive N−1 frames 305 from other users every 1/fps.

For example, and as shown in the signaling diagram 300-a of FIG. 3A, a first UE 115-d (e.g., UE A) may transmit a first frame 305-a to the application server 320, which may forward the first frame 305-a to the second UE 115-e (e.g., UE B), the third UE 115-f (e.g., UE C), and the fourth UE 115-g (e.g., UE D). Similarly, the second UE 115-e may transmit a second frame 305-b to the application server 320, which may forward the second frame 305-b to the first UE 115-d, the third UE 115-f, and to the fourth UE 115-g. The third frame 305-c sent by the third UE 115-f and the fourth frame 305-d sent by the fourth UE 115-g may be similarly forwarded by the application server 320 to each other UE 115. Additional UEs 115 (not shown) may likewise exchange frames 305 via the application server 320, as a holographic communications session may include multiple users, and the quantity of UEs 115 (and users) shown in the examples provided herein should not be considered limiting to the scope of the claims or the disclosure.

An instant in time when a UE 115 transmits a frame 305 may determine the instant when the application server 320 receives the frame 305, and the respective instants when other UEs 115 receive the frame 305 from the application server 320. That is, the timing of a frame transmission may affect when both when the application server 320 receives a frame and when other wireless communication devices associated with holographic communications receive the frame 305. However, as illustrated in the signaling diagram 300-a, the UEs 115 may be uncoordinated in the transmission of the respective frames 305. For instance, the first UE 115-d may receive the second frame 305-b, the third frame 305-c, and the fourth frame 305-d from the application server 320 at respective instances that are separated in the time domain, which may be based on when the second UE 115-e, the third UE 115-f, and the fourth UE 115-g, respectively, transmitted the frames 305. In such cases, the respective instants when each UE 115 transmits a frame of a holographic communication session may be independent of each other (e.g., uncoordinated).

In some examples, the UEs 115 may operate (e.g., the wireless communication devices associated with a user may operate) in accordance with one or more communication modes. For instance, a first communication mode may correspond to an always-on communication mode in which a network entity does not configure the UE 115 with power savings techniques or features. As illustrated by the signaling diagram 300-b of FIG. 3B, the first UE 115-d may operate in accordance with the first communication mode, where the first UE 115-d monitors for a physical downlink control channel (PDCCH) that may be sent when a network entity 105-d is ready to transmit one or more frames 305 from other users. The application server 320 may forward the second frame 305-b, the third frame 305-c and the fourth frame 305-d to the first UE 115-d via the network entity 105-d each 1/fps, and the network entity 105-d may provide resources to the UE 115-d via PDCCH signaling sent when the frames 305 are ready to be transmitted to the UE 115-d (e.g., when the frames are forward by the application server 320). In such cases, the UE 115-d may remain in an always-on state (e.g., the first communication mode), which may reduce or minimize latencies associated with communicating the frames 305.

Additionally, or alternatively, the UEs 115 may operate in a second communication mode that corresponds to a power saving mode. As an example, and as illustrated by the signaling diagram 300-c of FIG. 3C, the UE 115-d may operate in accordance with a DRX configuration (e.g., a C-DRX configuration), where the UE 115-d may wake up (e.g., prove power to) one or more radio components from a sleep state to monitor for PDCCH transmissions from the network entity 105-d. In some cases, low-latency services (such as holographic communications services) may be associated with a C-DRX configuration from one of a set of downlink flows. In such cases, a periodicity of the C-DRX configuration may be set to the traffic period of the holographic communications (e.g., 1/fps), and a starting offset (e.g., for an On Duration) may be aligned to an expected arrival time of one of the flows (such as for frames 305-b from the second UE 115-e (e.g., UE B)). For example, C-DRX may be configured such that the UE 115-d may wake up to receive the second frame 305-b (e.g., from the second UE 115-e, forwarded by the application server 320) based on receiving a PDCCH transmission within an On Duration, and the UE 115-d may start an inactivity timer (IAT) 310 after reception of the PDCCH. The IAT 310 may correspond to a quantity of consecutive time intervals (e.g., subframes) that pass after successfully decoding the PDCCH indicating the transmission of the second frame 305-b. After the IAT expires, the UE 115-d may return to a sleep state (e.g., power down the one or more radio components).

However, because the UE 115-d may not be awake to receive signaling associated with the third frame 305-c and/or the fourth frame 305-d (from the third UE 115-f and the fourth UE 115-g, respectively, and forwarded by the application server 320), the reception of such frames may be delayed until the next On Duration of the UE 115-d. For example, when the UE 115-d awakes from the power saving mode to monitor for PDCCH, the UE 115-d may receive the third frame 305-c, the fourth frame 305-d, and the second frame 305-b based on receiving a PDCCH transmission from the network entity 105-d. Thus, when operating in accordance with the second communication mode (e.g., a power saving mode), the UE 115-d may not be awake to monitor for PDCCH when the network entity 105-d is ready to transmit a frame 305 forwarded by the application server 320. As a result, the reception of at least the third frame 305-c may be associated with some latency (e.g., compared to when the third frame 305-c may have been received when operating in accordance with the first communication mode, such as described with reference to FIG. 3B). Power savings features associated with holographic communications may accordingly be associated with relatively increased latencies, which may affect the quality of the holographic communications. Put another way, power savings with holographic communications may not be achieved without impacting end-to-end latencies or affecting other aspects of the communications.

Further, the independent and uncoordinated communication of frames 305 by the UEs 115 may be associated with other performance impacts on holographic communications. For example, as shown in the signaling diagram of FIG. 3D, an application client of the UE 115-d may render a holographic communications scene when a frame 305 (e.g., a video frame) is received from another UE 115 (e.g., as soon as the frame 305 is received). In such examples, when the UE 115-d receives the second frame 305-b from the application server 320, the application client of the UE 115-d may perform a rendering operation 315 for the second frame 305-b. However, when the third frame 305-c and the fourth frame 305-d are received at later times (e.g., in an uncoordinated manner), the application client of the UE 115-d may perform multiple additional rendering operations 315 for the received frames 305 (e.g., an additional rendering operation 315 for the second frame 305-b and the third frame 305-c, an additional rendering operation 315 for the second frame 305-b, the third frame 305-c, and the fourth frame 305-d). Accordingly, for a holographic communications session with N users, the application client of the UE 115-d (and the application client of other UEs 115) may render (N−1) scenes every 1/fps.

The multiple rendering operations 315 performed by the application client may impact the performance and power consumption of the UE 115-d. That is, reception of the frames 305 in an uncoordinated manner may result in the multiple rendering operations 315 and decrease the battery life of the UE 115-d. Additionally, some rendering operation 315 may use relatively “old” frames 305, whose age may be up to, for example, 1/fps. Further, the multiple rendering operations 315 may, in some cases, be associated with relatively increased processing requirements for the UE 115, and some UEs 115 may not be capable of supporting such requirements, thereby impacting the quality and performance of the holographic communications. Moreover, as the quantity of users (and their corresponding devices) involved in a holographic communications session increases, latencies, power expenditure, and other issues associated with uncoordinated frame exchanges may also increase.

As described herein, one or more wireless communication devices (such as the UE 115-d, the UE 115-e, the UE 115-f, the UE 115-g, and/or one or more other devices) may utilize techniques to coordinate the transmission of frames associated with holographic communications. For example, respective UEs 115 may modify a frame timing for transmitting frames 305 associated with the holographic communications, such that each UE 115 may receive frames from other UE 115 in a relatively coordinated manner (e.g., within some threshold duration). In some examples, the UE 115 may be configured to use the first communication mode (e.g., an always-on communication mode) for communicating the frames 305 and modifying the frame timing. After the frame timing is aligned among the UEs 115, each UE 115 may transmit a request to exit the first communication mode, and the UEs 115 may be subsequently configured with a power saving mode (e.g., C-DRX) for the holographic communications. Additionally, or alternatively, an application server may receive timing information from each UE 115, and the application server may provide respective indications for frame timing adjustments. In any case, with coordinated frame transmissions among the UEs 115, each UE 115 may be configured with a power savings mode that may not be affected by latency (such as described with reference to FIG. 3C). Additionally, each UE 115 may receive frames 305 from other devices within a relatively short amount of time, which may reduce or minimize the quantity of rendering operations 315 performed by a corresponding application client, which may improve power consumption and battery life of the UE 115.

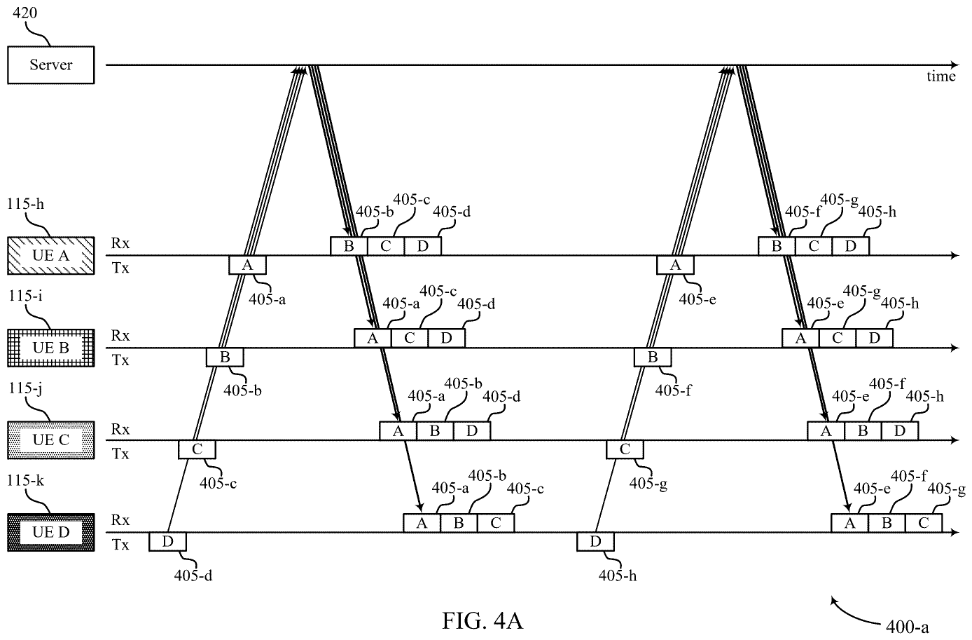

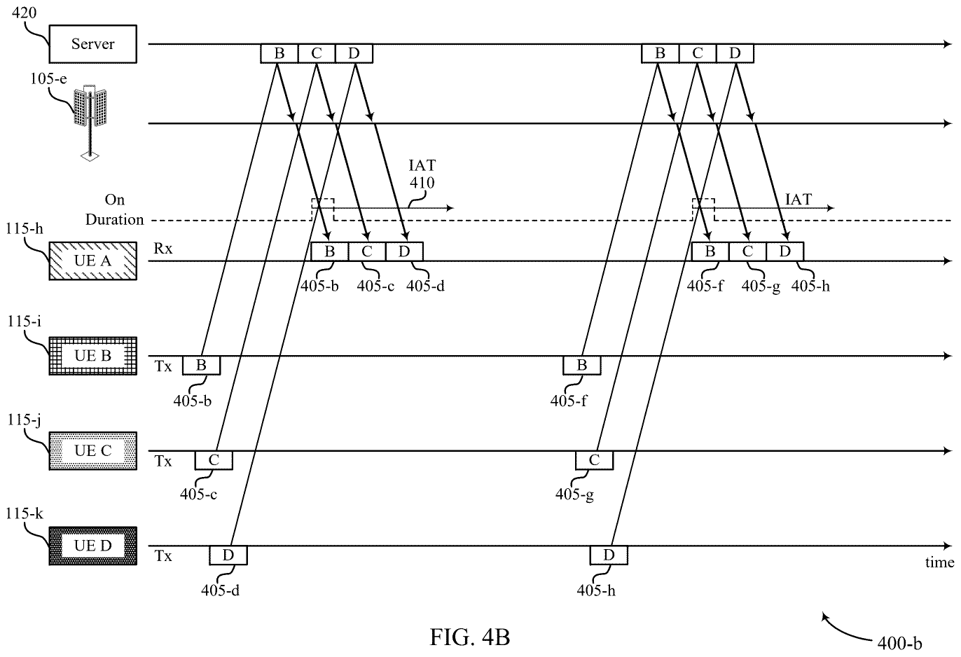

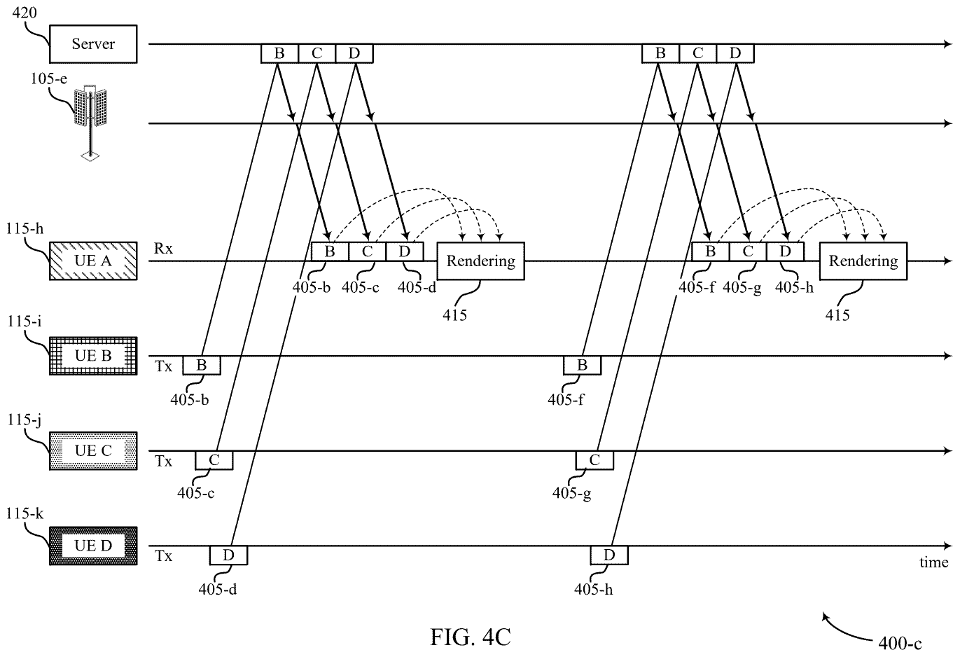

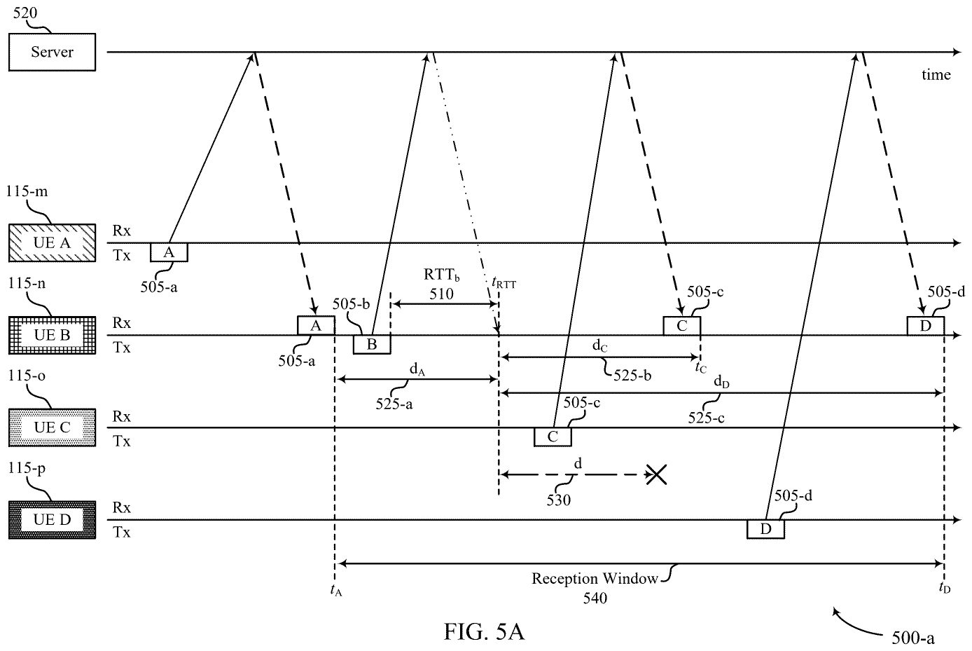

FIGS. 4A, 4B, and 4C show examples of signaling diagrams 400-a, 400-b, and 400-c, respectively, that supports device coordination for holographic communications in accordance with one or more aspects of the present disclosure. The signaling diagrams 400-a, 400-b, and 400-c may each implement or be implemented by aspects of the wireless communications system 100 and the wireless communications system 200. For example, the signaling diagrams 400-a, 400-b, and 400-c may illustrate the transmission and reception of one or more frames 405 by one or more wireless communication devices associated with respective users (e.g., a first UE 115-h, a second UE 115-i, a third UE 115-j, and a fourth UE 115-k).

The frames 405 communicated by each UE 115 may, additionally, or alternatively, be transmitted and/or received by one or more peripheral devices, which may be examples of the corresponding devices described with reference to FIGS. 1 and 2. As an example, the first UE 115-d may be coupled with (e.g., via a wired link or a wireless link, or both) or more peripheral devices that may each support techniques and functions associated with holographic communications (such as video capture, video presentation, audio capture, audio playback, among other examples). Although sometimes not shown, each UE 115 may communicate (e.g., transmit and receive) signaling with the application server 420 via one or more network entities (such as a network entity 105 described with reference to FIGS. 1 and 2). That is, each UE 115 depicted in the signaling diagrams 400-a, 400-b, and 400-c may transmit and receive frames 405 via at least one network entity 105, where the at least one network entity 105 may be used for communicating the frames 405 between the application server 420 and each UE 115 of a set of multiple UEs 115 (e.g., UE 115-h, UE 115-i, UE 115-j, UE 115-k, and so forth). In some aspects, the application server 420 may be an example of the application server 220 described with reference to FIG. 2 or the application server 320 described with reference to FIGS. 3A, 3B, 3C, and 3D.

As described herein, the respective UEs 115 (e.g., UE 115-h, UE 115-i, UE 115-j, UE 115-k, and so forth) may support techniques for coordinating with each other for the transmission of the frames 405. Specifically, the transmission timing (e.g., frame timing, uplink frame timing) of the UEs 115 may be adjusted so that each UE 115 receives frames 405 from other users within some window or duration (e.g., in the smallest possible window). In some aspects, and as described in further detail herein, the coordination of the UEs 115 may be achieved via one or more coordination techniques performed by the UEs included in a holographic communications session (which may be referred to as UE-based UE coordination) and/or coordination techniques performed by one or more application servers 420 associated with the holographic communications (which may be referred to as application server-based UE coordination).

For example, as shown in the signaling diagram 400-a of FIG. 4A, the UE 115-h, the UE 115-i, the UE 115-j, and the UE 115-k may each transmit respective frames 405 (e.g., frames 405-a, 405-b, 405-c, and 405-d) with coordinated timing such that each UE 115 receives all other frames 405 from the application server 420 at approximately the same time (e.g., within a threshold duration). As one example, the UE 115-h may receive the frame 405-b, the frame 405-c, and the frame 405-d from the application server 420 within some time window (e.g., every 1/fps), which may enhance the processing of the received frames 405. Subsequent frames 405 of the holographic communications session (e.g., a frame 405-e, a frame 405-f, a frame 405-g, a frame 405-h, and so forth) from each UE 115 may be transmitted and received in a coordinated manner (e.g., relatively aligned in the time domain) based on adjusted uplink frame timings.

The coordinated timing of the frame transmissions by each UE 115 may enable the configuration of power savings operations associated with minimal (or with no) effect on the latency associated with receiving the frames 405. For example, as shown in the signaling diagram 400-b of FIG. 4B, the UE 115-h may operate in accordance with a power savings mode (e.g., a second communication mode, DRX), and the UE 115-h may receive a PDCCH associated with the transmission of the frames 405-b, 405-c, and 405-d from a network entity 105-e (e.g., forwarded by the application server 420 and from the UE 115-i, the UE 115-j, and the UE 115-k, respectively). In such cases, the UE 115-h may receive each of the frames 405-b, 405-c, and 405-d within the duration of the IAT 410, and the UE 115-h may subsequently go to sleep (e.g., power down one or more radio components). The UE 115-h may wake to monitor for PDCCH during a subsequent On Duration to receive a next set of frames 405 from the network entity 105-e. As such, the frames 405 may be received in a way that enables power saving by the UE 115-h without affecting the latency of the received frames 405 (as the network entity 105-e may not have to wait until a next On Duration to transmit frames 405 that are ready for transmission to the UE 115-h). That is, the network entity 105-e may transmit all frames 405 immediately (e.g., with minimal delay, within a threshold duration) without waiting for the next On Duration of the DRX cycle implemented by the UE 115-h.

Further, the coordinated timing of the frame transmission by each UE 115 may result in relatively fewer rendering operations 415 performed by an application client of each UE 115. For example, the signaling diagram 400-c illustrates the coordinated transmission of the frame 405-b, the frame 405-c, and the frame 405-d, which may be transmitted via the network entity 105-e and forwarded (e.g., immediately) by the application server 420 to all other UEs 115. In this example, the UE 115-h may receive the frames 405-b, 405-c, and 405-d at about the same time (e.g., within a threshold duration) and an application client of the UE 115-h may perform a single rendering operation 415 for all of the received frames 405 (e.g., a single rendering operation each 1/fps). Such techniques may result in relatively fewer scene rendering operations 415 (compared to when frames 405 are transmitted without coordination (such as described with reference to FIG. 3D). Additionally, relatively recent frames 405 (e.g., video frames) may be used for such rendering operations, thereby preventing rendering of relatively aged frames 405. Accordingly, one scene may be rendered from all frames 405 that have been received (e.g., using a single rendering operation 415).

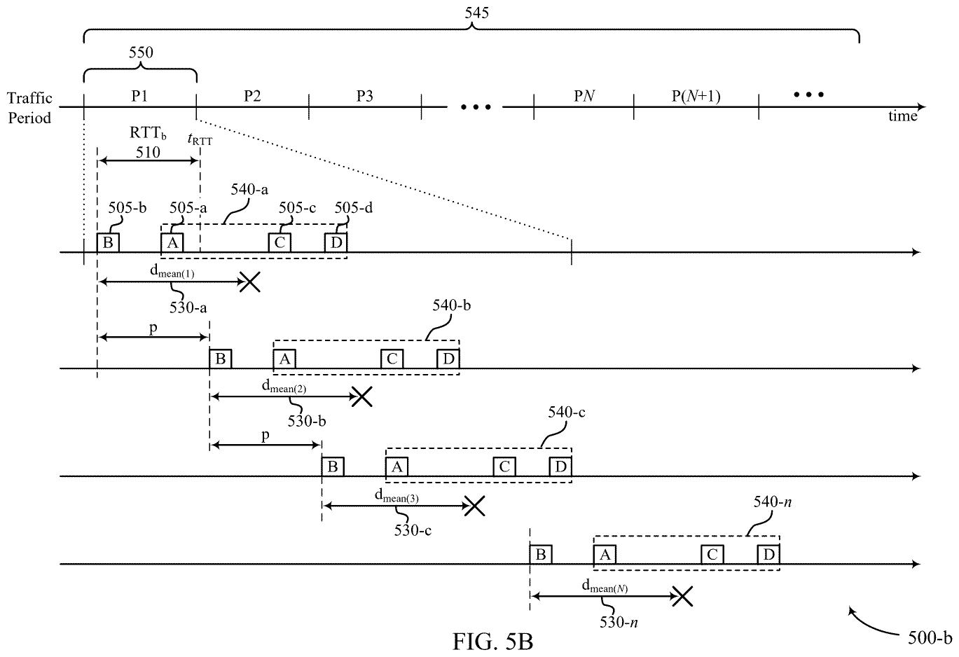

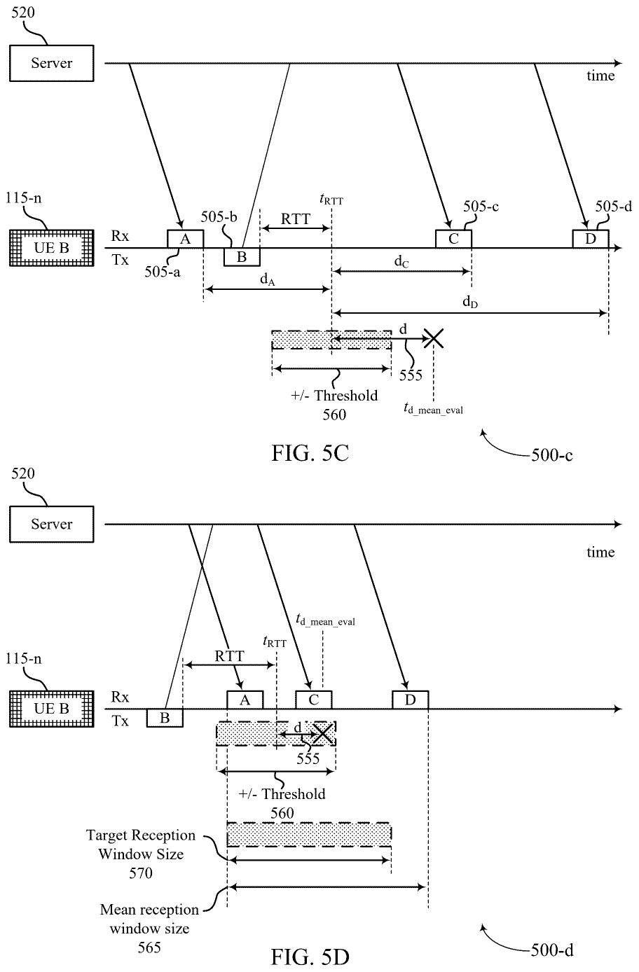

FIGS. 5A, 5B, 5C, and 5D show examples of signaling diagrams 500-a, 500-b, 500-c, and 500-d, respectively, that support device coordination for holographic communications in accordance with one or more aspects of the present disclosure. The signaling diagrams 500-a, 500-b, 500-c, and 500-d may each implement or be implemented by aspects of the wireless communications system 100, the wireless communications system 200, and the signaling diagrams 400-a, 400-b, and 400-c. For example, the signaling diagrams 500-a, 500-b, 500-c, and 500-d may illustrate the transmission and reception of one or more frames 505 by one or more wireless communication devices associated with respective users (e.g., a first UE 115-m, a second UE 115-n, a third UE 115-o, and a fourth UE 115-p). The signaling diagrams 500-a, 500-b, 500-c, and 500-d may illustrate one or more algorithms (e.g., coordination algorithms) used by respective wireless communications devices (e.g., respective UEs 115 and/or respective peripheral devices, which may be examples of the corresponding devices described herein) to modify an uplink frame timing to achieve coordination with multiple other wireless communications devices for the transmission of data frames 505 (e.g., video frames, data frames).

The frames 505 communicated by each UE 115 may, additionally, or alternatively, be transmitted and/or received by one or more peripheral devices, which may be examples of the corresponding devices described with reference to FIGS. 1 and 2. As an example, the first UE 115-d may be coupled with (e.g., via a wired link or a wireless link, or both) or more peripheral devices that may each support techniques and functions associated with holographic communications (such as video capture, video presentation, audio capture, audio playback, among other examples). Although sometimes not shown, each UE 115 may communicate (e.g., transmit and receive) signaling with the application server 520 via one or more network entities (such as a network entity 105 described with reference to FIGS. 1 and 2). That is, each UE 115 depicted in the signaling diagrams 500-a, 500-b, 500-c, and 500-d may transmit and receive frames 505 via at least one network entity 105, where the at least one network entity 105 may be used for communicating the frames 505 between the application server 520 and each UE 115 of a set of multiple UEs 115 (e.g., UE 115-m, UE 115-n, UE 115-o, UE 115-p, and so forth). In some aspects, the application server 520 may be an example of the application server 220 described with reference to FIG. 2, the application server 320 described with reference to the FIGS. 3A, 3B, 3C, and 3D, or the application server 420 described with reference to FIGS. 4A, 4B, and 4C. The application server 520 may be associated with an SFU architecture.

In some aspects, one or more of the UEs 115 may be capable of determining its own RTT 510. The RTT 510 may correspond to a quantity of time it takes for a frame 505 transmitted by an application client of a UE 115 to travel to the application server 520 and for the frame 505 to be received back at the application client. For example, an RTT of the UE 115-n (e.g., UE B) may be equivalent to a quantity of time it takes for the frame 505-b (e.g., issued from an application client of the UE 115-n) to go from the UE 115-n to the application server 520 and back to the UE 115-n. In some cases, the RTT 510 may indicate a first instance (e.g., t_{RTT}) after the transmission of the frame 505, where the first instance may be used to calculate one or more time offsets associated with the reception of other frames 505 from different devices, and the one or more time offsets may be used to adjust an uplink frame timing of the UE 115-n.

In cases where UEs 115 have information about their own RTT 510 with the application server 520, each UE 115 may autonomously modify (e.g., move, adjust) its uplink frame timing such that respective frames 505 are received from other UEs 115 as close as possible to the first instance (e.g., t_{RTT}) that is based on each UE's RTT 510. Such techniques may be referred to herein as UE-based UE coordination.

As an example of the techniques the UE 115-n may utilize to modify its uplink frame timing, and as illustrated in the signaling diagram 500-a of FIG. 5A, the UE 115-n may receive a frame 505-a from the UE 115-m (e.g., forwarded via the application server 520 and via one or more network entities (not shown)). Similarly, the UE 115-n may receive a frame 505-c and a frame 505-d from the UE 115-o and the UE 115-p, respectively. Each frame 505 may be received by the UE 115-n every 1/fps of a holographic communications session involving the UE 115-m, the UE 115-n, the UE 115-o, and the UE 115-p.

Based on the received frames 505, the UE 115-n (e.g., a modem of the UE 115-n) may determine respective time offsets 525, dⱼ, from the first time instance, t_{RTT}, to respective time instances when the frames 505 are received from the other UEs 115. Here, j corresponds to one other UE 115 of a set of multiple UEs 115 (e.g., the one other UE 115 being different from the UE 115-n), and the first time instance, t_{RTT}, may correspond to the RTT 510 of the UE 115-n, denoted as RTT_{b}. As an illustrative example, the UE 115-n may calculate a first time offset 525-a (e.g., d_{A}) based on a difference between the first time instance, t_{RTT}, and a second time instance, t_{A}, at which the frame 505-a is received at the UE 115-n (e.g., received by the application client of the UE 115-n). The UE 115-n may further calculate a second time offset 525-b (e.g., d_{B}) based on a difference between the first time instance, t_{RTT}, and a third time instance, t_{C}, when the frame 505-c is received at the UE 115-n. Additionally, the UE 115-n may calculate a third time offset 525-c (e.g., d_{D}) based on a difference between the first time instance, t_{RTT}, and a fourth time instance, t_{D}, when the frame 505-d is received at the UE 115-n.

Using the first time offset 525-a, the second time offset 525-b, and the third time offset 525-c, the UE 115-n may calculate a mean time offset 530 (e.g., a mean distance in the time domain), which may correspond to a mean time offset from its RTT (e.g., from the first time instance, t_{RTT}) to the reception of frames from other users. In this example, the UE 115-n may calculate the mean time offset 530 in accordance with the equation d=(d_{A}+d_{C}+d_{D})/3. In such cases, the UE 115-n may compare the mean time offset 530, d, to the RTT 510 (e.g., with reference to the first time instance t_{RTT}). In cases where d>0 (such as illustrated in the example of FIG. 5A), the UE 115-n may modify its uplink frame timing forward in time (e.g., advancing the frame timing by one or more offset or step values). Alternatively, if d<0, the UE 115-n may modify its uplink timing backward in time (e.g., delaying the frame timing by one or more offset or step values). In some cases, a modem of the UE 115-n may utilize one or more uplink alignment application programming interface (API) or another interface to signal the updated frame timing to the application client of the UE 115-n. In some examples, the UE 115-n may utilize a size of a reception window 540 for modifying the frame timing, where the reception window may correspond to a time difference from an earliest received frame in the time domain (e.g., the frame 505-a) to a latest received frame in the time domain (e.g., the frame 505-d).

One or more of the other UEs 115 (e.g., the UE 115-m, the UE 115-o, the UE 115-p) may perform a similar algorithm as the UE 115-n to modify their uplink frame timing and achieve frame transmission coordination with the other UEs 115, which may enable power savings for holographic communications with reduced latency, among other improvements. That is, each respective UE 115 included in a holographic communications session (a holographic communication call) may calculate the multiple time offsets (e.g., dⱼ) based on its own RTT and instants when packets are received from other UEs 115, and each respective UE 115 may further calculate a mean time offset (e.g., d) that is used (e.g., via comparison to an instant corresponding to the RTT after that UEs own packet transmission instance) to determine whether to adjust the uplink frame timing forward or backward in the time domain. In other examples, a UE 115 may determine that its uplink frame timing is already aligned (e.g., already coordinated with the other UEs 115), and that UE 115 may refrain from performing the algorithm to modify the uplink frame timing.

In some aspects, and as illustrated by the signaling diagram 500-b of FIG. 5B, a UE 115 may calculate the respective mean time offsets 530 based on one or more evaluation periods 545. The evaluation period 545 may be defined as a set of consecutive traffic periods 550 (e.g., traffic period P1, traffic period P2, traffic period P3, . . . , traffic period PN, traffic period P(N+1), and so forth). One traffic period 550 may be equal to 1/fps, where fps may be, for example, 60 fps or some other value associated with the holographic communications. In some examples, one evaluation period 545 may include some quantity of evaluation periods 550 (e.g., 1 evaluation period 545 includes 100 traffic periods 550).

At each traffic period 550, a UE 115 may calculate a mean time offset 530 and a size of a corresponding reception window 540 (e.g., a reception window size, RxWin). For example, within a first traffic period (e.g., traffic period P1) that has some periodicity, p, the UE 115-n may transmit a frame 505-b and receive frames 505 from the other UEs 115 (e.g., receive frame 505-a, frame 505-c, and frame 505-c from the UE 115-m, the UE 115-o, and the UE 115-p, respectively, which may be forwarded by the application server 520). A reception window 540-a corresponding to the first period may be based on a difference in time between the earliest received frame (e.g., the frame 505-a) and the latest received frame (e.g., the frame 505-d). Here, the UE 115-n may calculate the mean time offset 530-a from a time instance when the UE 115-n transmits the frame 505-b (e.g., when an application client of the UE 115-n outputs the frame 505-b) plus the RTT 510 of the UE 115-n, to the respective time instances when the UE 115-n receives the frames 505-a, 505-c, and 505-d (e.g., when the application client of the UE 115-n obtains the frames 505-a, 505-c, and 505-d). The UE 115-n may further calculate (or measure) a size of the reception window 540-a, RxWin, as the time difference from the earliest received frame 505 to the latest received frame 505 of the first traffic period 550.

The UE 115-n may repeat these calculations for each traffic period 550 of the evaluation period 545. For example, the UE 115-n may calculate a mean time offset 530-b corresponding to a second traffic period 550 (e.g., dₘₑₐₙ₍₂₎ for traffic period P2), a mean time offset 530-c corresponding to a third traffic period 550 (e.g., dₘₑₐₙ₍₃₎ for traffic period P3), and so forth, through the calculation of a mean time offset 530-n corresponding to an Nth traffic period 550 (e.g., d_{mean(N)} for traffic period PN) of the evaluation period 545. The UE 115-n may additionally calculate the size of each reception window 540, RxWin, for each traffic period 550 (e.g., a size of a reception window 540-b associated with the second traffic period 550, a size of a reception window 540-c associated with the third traffic period 550, and so forth, through a size of a reception window 540-n associated with the Nth traffic period 550).

For each evaluation period 545, the UE 115-n may calculate an evaluation time offset 555, d_{mean_eval} (e.g., a mean time offset for the evaluation period 545), which may be calculated as an average (or mean) of the set of mean time offsets 530 (e.g., the mean time offsets 530-a, 530-b, 530-c, . . . , 530-n). For example, the evaluation time offset 555 may be calculated using d_{mean_eval}(q)=Σdₘₑₐₙ(p)/N, where N is the quantity of traffic periods 550 and dₘₑₐₙ(p) is the mean time offset 530 for each traffic period 550. That is, the evaluation time offset, d_{mean_eval}, may be calculated as the average of all distances in the time domain (e.g., all mean time offsets 530) over all traffic period 550 of an evaluation period 545. The UE 115-n may further calculate a mean reception window size, RxWin_{mean_eval} as the average of the sizes of the set of reception windows 540 (e.g., the reception windows 540-a, 540-b, 540-c, . . . , 540-n) over all traffic periods 550 of that evaluation period 545. For example, the mean reception window size may be calculated using RxWin_{mean_eval}(q)=ΣRxWin(p)/N, where N is the quantity of traffic periods 550 and RxWin(p) is the size of a reception window 540 for each traffic period 550.

Each other UE 115 (e.g., the UE 115-m, the UE 115-o, the UE 115-p) may similarly calculate respective evaluation time offsets (e.g., d_{mean_eval}) and mean reception window sizes (e.g., RxWin_{mean_eval}) for every evaluation period 545, which may be used for modifying their uplink frame timing and achieve frame transmission coordination with the other UEs 115. For example, each respective UE 115 included in a holographic communications session may, for respective traffic periods 550 of the evaluation period 545, calculate respective mean time offsets 530 (e.g., dₘₑₐₙ) and sizes of a reception window 540 based on its own RTT and based on frames 505 received within the reception window 540. Each respective UE 115 may then calculate the evaluation time offset 555, d_{mean_eval}, and calculate the mean reception window size, RxWin_{mean_eval}, for the evaluation period.

One or both of the evaluation time offset 555, d_{mean_eval}, and the mean reception window size 565, RxWin_{mean_eval}, may be used to modify the uplink frame timing of a UE 115. For example, at each evaluation period 545, the UE 115-n may update its uplink frame timing (e.g., UL_Offset) from the evaluation time offset 555, d_{mean_eval}, and the mean reception window size 565, RxWin_{mean_eval}, as shown in the signaling diagrams 500-c and 500-d of FIGS. 5C and 5D, respectively. In such examples, the evaluation time offset 555 may be compared to a threshold timing window 560 (e.g., a window having time-domain boundaries that may be configured or used to align the uplink frame timing). For instance, if the evaluation time offset 555, d_{mean_eval}, does not satisfy the threshold timing window 560 (e.g., a time instance, t_{d_mean_eval}, corresponding to d_{mean_eval} is outside the upper and lower (+/−) boundaries of the threshold timing window 560), the uplink frame timing may be modified (e.g., adjusted) based on the evaluation time offset 555.

For example, some time step (or offset value) may be added or subtracted from the uplink frame timing of the UE 115-n to move the time instance corresponding to the evaluation time offset 555 to be closer to, or to be within, the threshold timing window, where such an adjustment of the uplink frame timing by the UE 115-n may modify the transmission timing of the frame 505-b and further achieve coordination with the other UEs 115 so that the frames 505-a, 505-c, and 505-d are received in a relatively coordinated manner (e.g., as closely as possible in the time domain, within some threshold duration). In one example, when the time instance corresponding to the evaluation time offset 555 (e.g., t_{d_mean_eval}) is greater than the upper boundary of the threshold timing window 560, then the uplink frame timing may be modified in accordance with UL_Offset=(UL_Offset+Step) % period, where the period may correspond to the traffic period 550 and Step may correspond to some value or increment, which may be configured via one or more parameters, as described below. Alternatively, when the time instance corresponding to the evaluation time offset 555 (e.g., t_{d_mean_eval}) is less than the lower boundary of the threshold timing window 560, the uplink frame timing may be modified in accordance with UL_Offset=(UL_Offset−Step) % period. When the time instance corresponding to the evaluation time offset 555 (e.g., t_{d_mean_eval}) is within and satisfies the threshold timing window 560, there may be no change to the uplink frame timing (e.g., UL_Offset).

In some aspects, when the time instance corresponding to the evaluation time offset 555 (e.g., t_{d_mean_eval}) is within the threshold timing window 560, such as illustrated in the signaling diagram 500-d, the uplink frame timing (e.g., UL_Offset) may be updated (e.g., modified) based on the mean reception window size 565. For example, the mean reception window size may be compared to a target reception window size 570 to determine how to modify the uplink frame timing. For example, in cases where the mean reception window size 565 is greater than the target reception window size 570, the uplink frame timing may be updated based on the first time instance corresponding to the RTT (e.g., t_{RTT}) and a second time instance corresponding to the evaluation time offset 555 (e.g., t_{d_mean_eval}). That is, the uplink frame timing (e.g., UL_Offset) may be modified based on a difference in the time domain between first time instance and the second time instance. As an example, in cases where the difference (or delay) between the first time instance corresponding to the RTT (e.g., t_{RTT}) and the second time instance corresponding to the evaluation time offset 555 (e.g., t_{d_mean_eval}) is greater than zero (e.g., when the second time instance is after the first time instance in the time domain), the uplink frame timing may be updated using UL_Offset=(UL_Offset+Step) % period. Alternatively, when the difference (or delay) between the first time instance corresponding to the RTT (e.g., t_{RTT}) and the second time instance corresponding to the evaluation time offset 555 (e.g., t_{d_mean_eval}) is less than zero (e.g., when the second time instance is before the first time instance in the time domain), the frame timing may be updated using UL_Offset=(UL_Offset−Step) % period. In some aspects, the threshold timing window 560 and the target reception window size 570 may be used to address jitter and to avoid ping-pong situations (e.g., adjusting the uplink frame timing forward in time, then backward in time, then forward in time, endlessly).

Otherwise, when the threshold timing window 560 satisfies the target reception window size 570, then the UE 115-n may determine that the uplink timing is coordinated, and no further updates to the uplink frame timing may be made. For instance, when the time instance, t_{d_mean_eval}, corresponding to the evaluation time offset 555, d_{mean_eval}, is within the threshold timing window 560, and when the mean reception window size 565, RxWin_{mean_eval}, is within the target reception window size 570 (e.g., for some quantity of consecutive evaluation periods 545), there may be no further updates to the uplink frame timing, and the algorithm for modifying the uplink frame timing may end. In such cases, and as described herein, the UE 115-n may transmit a message to the network entity requesting that the UE 115-n exit the first communication mode (e.g., notify the network that relatively frequent PDCCH monitoring and relatively frequent uplink grants are no longer needed). Each other UE 115 (e.g., the UE 115-m, the UE 115-o, the UE 115-p) may similarly use one or both of their own evaluation time offset 555, d_{mean_eval}, and the mean reception window size 565, RxWin_{mean_eval}, to modify the uplink frame timing of that UE 115. In such cases, the respective UEs 115 may each transmit a message to the network entity requesting that the UE 115 exit the first communication mode (e.g., because the uplink frame timing of the multiple UEs 115 of the holographic communications session is coordinated and stable).

In some examples, the algorithm for modifying the uplink frame timing (e.g., a UE coordination algorithm) described herein may make use of one or more parameters. For example, the one or more parameters may include an activation parameter, an RTT parameter, one or more evaluation period parameters, one or more uplink offset steps, a threshold quantity of evaluation periods, a target reception window size, or any combination thereof.

The activation parameter (e.g., algorithm activation) may be used to enable the algorithm for modifying the uplink frame timing for multi-user communications (such as the holographic communications), such as when the application server 520 applies immediate forwarding (e.g., in accordance with an SFU architecture). In some examples, the activation parameter may be configured by the application server 520 or one or more application clients (e.g., of a UE 115), or any combination thereof.

The RTT parameter may correspond to an RTT (e.g., a value of an RTT) of one or more UEs 115, which may be estimated by the application server 520 and/or the one or more application clients (e.g., of a UE 115). As such, the RTT parameter may be configured by the application server 520 or one or more application clients (e.g., of a UE 115), or any combination thereof.

The one or more evaluation period parameters may be used to configure a duration of the evaluation period 545 used by each UE 115 for modifying the uplink frame timing (and performing other aspects described herein). Here, a relatively long evaluation period 545 may be used to enable relatively reliable evaluation samples by a UE 115, but may result in a relatively longer runtime of the algorithm (e.g., the algorithm may last longer). Alternatively, a relatively shorter evaluation period 545 may correspond to a shorter runtime of the algorithm, but may result in relatively less accurate evaluation samples. The one or more evaluation period parameters may be configured by the application server 520 or one or more application clients (e.g., of a UE 115), or any combination thereof.

The one or more uplink offset steps parameter may be used to configure a step size or value used to modify the uplink frame timing (UL_Offset). In some aspects, an uplink offset step may be consistent with a frame pattern (e.g., DDDSU as one example, where D corresponds to a downlink subframe, U corresponds to an uplink subframe, S corresponds to a special subframe). In some cases, relatively short steps may enable fine tuning of the uplink frame timing but may result in relatively longer runtimes of the algorithm. Conversely, relatively longer steps may enable less granular adjustment of the uplink frame timing, but may enable a relatively shorter runtime of the algorithm. In any case, one or more modem components of the UE 115 may provide one or more preferred or suggested values of the uplink offset step(s). As such, the one or more uplink offset steps parameter may be configured by the application client or the one or more modem components (e.g., of a UE 115), or any combination thereof.

The threshold quantity of evaluation periods parameter may correspond to a quantity of evaluation periods (e.g., consecutive evaluation periods 545) having metrics (e.g., the evaluation time offset 555 and the mean reception window size 565) that satisfy their respective thresholds/target (e.g., boundaries of the threshold timing window 560 and the reception window target size 570), and which may be used to stop the algorithm. Here, a relatively greater quantity of evaluation periods 545 may ensure that no additional uplink frame timing updates may be needed, but may result in a relatively longer runtime of the algorithm last longer (e.g., the UE 115 may perform frequent PDCCH monitoring for a longer amount of time, the UE 115 may remain in the first communication mode for longer). Relatively less evaluation periods 545, however, may shorten the amount of time the UE 115 is in the first communication mode (e.g., may shorten the length of time the algorithm is running), but may result the need to perform the algorithm again (e.g., in the case of changes in an RTT or other conditions that may affect the uplink frame timing). In some examples, the threshold quantity of evaluation periods parameter may be configured by the application server 520 or one or more application clients (e.g., of a UE 115), or any combination thereof.

The target reception window size parameter may configure the reception window target size 570. In some cases, a relatively small target reception window size 570 may result in improved coordination for the transmission of frames 505 by respective UEs 115 (and, consequentially, improved UE power savings), but may makes the algorithm last longer. In other cases, a relatively large target reception window size 570 may result in a shorter runtime of the algorithm with potentially decreased coordination for the transmission of frames 505 by respective UEs 115. In some cases, target reception window size parameter may correspond to (e.g., may be consistent with) any jitter experienced by the UEs 115 when adjusting the uplink frame timing. The one or more modem components may indicate preferred or suggested values for the target reception window size parameter. As such, the target reception window size parameter may be configured by the application client or the one or more modem components (e.g., of a UE 115), or any combination thereof.

In accordance with the one or more parameters used for the algorithm for modifying the uplink frame timing, various signaling may be used to indicate the one or more parameters. For example, the application server 520 may signal the application client to enable or disable the algorithm. Such signaling may be transmitted via in-band signaling (e.g., using a same channel as the holographic communications signaling exchanged between the wireless communication devices). Further, the application server 520 may provide the application client of a UE 115 with the one or more parameters (e.g., via in-band signaling), including, for example, the algorithm activation parameter, the RTT parameter, the evaluation period parameter, or the threshold quantity of evaluation period parameter, or any combination thereof. In some aspects, an application client of a UE 115 may provide the one or more modem components of the UE 115 with the one or more parameters (e.g., via an X-Layer API), including, for example, the algorithm activation parameter, the RTT parameter, the evaluation period parameter, the uplink offset step parameter, the threshold quantity of evaluation period parameter, or the target reception window size parameter, or any combination thereof. In some aspects, the modem of the UE 115 may suggest, to the application client of the UE 115, some values for the one or more parameters including, for example, the uplink offset step parameter or the reception window target size parameter, or both.

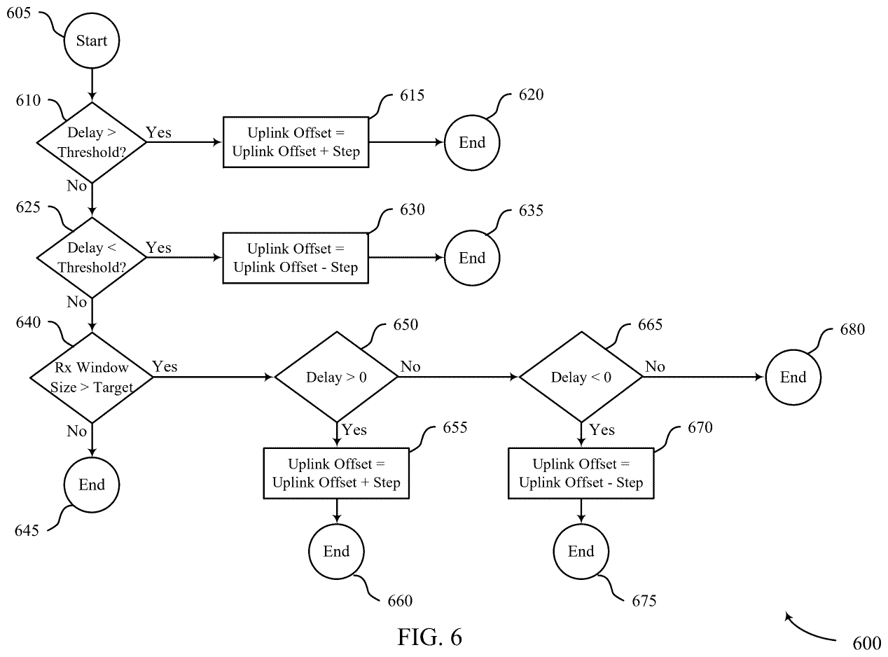

FIG. 6 shows an example of a process flow 600 that supports device coordination for holographic communications in accordance with one or more aspects of the present disclosure. The process flow 600 may implement or be implemented by aspects of the wireless communications system 100, the wireless communications system 200, the signaling diagrams 400-a, 400-b, and 400-c, and the signaling diagrams 500-a, 500-b, 500-c, and 500-d. The process flow 600 may illustrate an algorithm (e.g., coordination algorithm), such as the algorithm described with reference to the signaling diagrams 500-a, 500-b, 500-c, and 500-d, used by respective wireless communications devices (e.g., respective UEs 115 and/or respective peripheral devices, which may be examples of the corresponding devices described herein) to modify an uplink frame timing to achieve coordination with other wireless communications devices for the transmission of data frames. As an example, the process flow 600 may illustrate various decisions used to update an uplink frame timing using one or both of a time offset (e.g., an evaluation time offset, d_{mean_eval}) or a mean reception window size (e.g., RxWin_{mean_eval}), such as described with reference to FIGS. 5A, 5B, 5C, and 5D.

At 605, the wireless communication device may start the algorithm (e.g., for an evaluation period), which may be started when the wireless communication device is operating in accordance with a first communication mode (e.g., an always-on mode with relatively frequent scheduling and PDCCH monitoring

At 610, the wireless communication device may compare a delay between a first time instance (corresponding to an RTT) and a second time instance (corresponding to a time offset, such as a mean time offset or an evaluation time offset 555, d_{mean_eval}, as described herein) to a threshold value (e.g., a threshold timing window). That is, the delay may correspond to a difference in the time domain from the RTT to an average reception time for one or more frames (e.g., data frames, video frames) received by the wireless communication device. For example, at 610, the wireless communication device may determine whether the delay is greater than the threshold. If the delay is greater than the threshold, at 615, the wireless communication device may modify an uplink frame timing (e.g., UL_Offset) in accordance with a step value (e.g., using UL_Offset=UL_Offset+Step), which may advance the uplink frame timing (e.g., move the uplink frame timing forward in time). After the uplink frame timing is modified at 615, the algorithm may end at 620 (but may be started again for another evaluation period).

If the wireless communication device determines that the delay is not greater than the threshold at 610, the wireless communication device may, at 625, determine whether the delay is less than the threshold. If so, at 630, the wireless communication device may modify the uplink frame timing (e.g., UL_Offset) in accordance with a step value (e.g., using UL_Offset=UL_Offset−Step), which may delay the uplink frame timing (e.g., move the uplink frame timing backward in time). After the uplink frame timing is modified at 630, the algorithm may end at 635 (but may be started again for another evaluation period).

Alternatively, if it is determined at 625 that the delay is not less than the threshold (e.g., if the delay satisfies the threshold, is within the threshold timing window), the wireless communication device may, at 640, compare a reception window size (e.g., a mean reception window size, RxWin_{mean_eval}) to a target reception window size. For example, if the reception window size is within the target reception window size, then the wireless communication device may not modify (e.g., refrain from modifying) the uplink frame timing (as the uplink timing offset may be coordinated) and the algorithm may end at 645 (but may start again for another evaluation period). In other cases, if the reception window size is greater than the target reception window size, then at 650 the wireless communication device may determine whether the delay between the first time instance (corresponding to the RTT) and the second time instance (corresponding to the time offset, such as the mean time offset or the evaluation time offset 555, d_{mean_eval}, as described herein) is greater than some value (e.g., zero).

If the delay is greater than the value, the wireless communication device may modify the uplink frame timing (e.g., UL_Offset) at 655 in accordance with a step value (e.g., using UL_Offset=UL_Offset+Step), which may advance the uplink frame timing (e.g., move the uplink frame timing forward in time). After the uplink frame timing is modified at 655, the algorithm may end at 660 (but may be started again for another evaluation period).

If the delay is not greater than the value, the wireless communication device may, at 665, determine whether the delay is less than the value. If the delay is less than the value at 665, the wireless communication device may modify the uplink frame timing (e.g., UL_Offset) at 670 (e.g., using UL_Offset=UL_Offset−Step), which may delay the uplink frame timing (e.g., move the uplink frame timing backward in time). After the uplink frame timing is modified at 670, the algorithm may end at 675 (but may be started again for another evaluation period). If, at 665, the wireless communication device determines that the delay is not less than the value (e.g., the delay is equal to the value), then the uplink timing may not be modified (as the uplink timing offset may be coordinated), and the algorithm may end at 680 (but may be started again for another evaluation period).

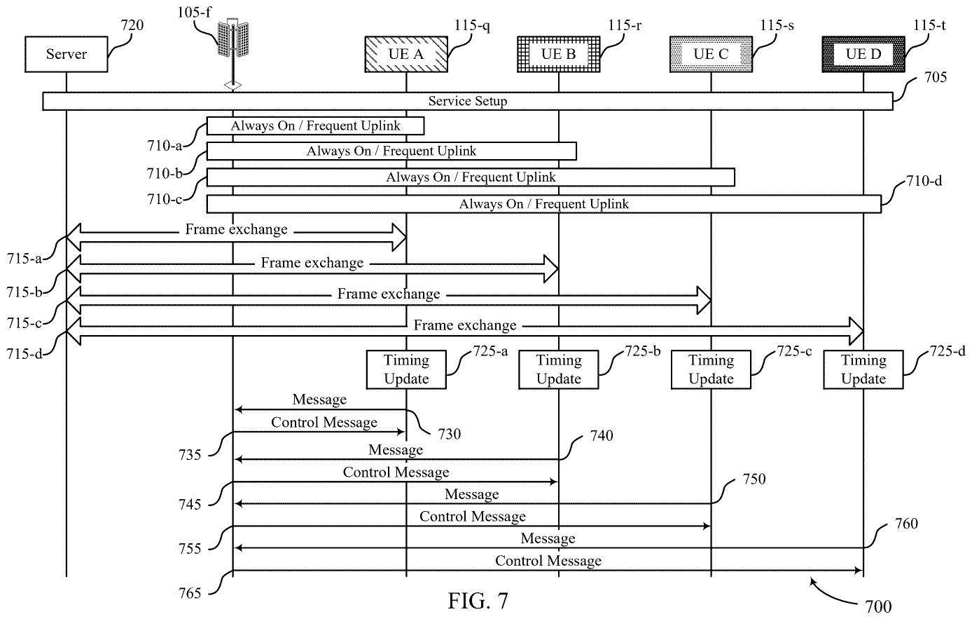

FIG. 7 shows an example of a process flow 700 that supports device coordination for holographic communications in accordance with one or more aspects of the present disclosure. In some examples, the process flow 700 may implement or be implemented by aspects of the wireless communications system 100, the wireless communications system 200, the signaling diagrams 300-a, 300-b, 300-c, 300-d, 400-a, 400-b, 400-c, 500-a, 500-b, 500-c, 500-d, the process flow 600, or any combination thereof. For example, the process flow 700 may include one or more UEs 115 (e.g., a UE 115-q, a UE 115-r, a UE 115-s, a UE 115-t) and one or more network entities 105 (e.g., a network entity 105-f), which may be examples of the corresponding devices as described herein. The process flow 700 may additionally include one or more application servers, such as the application server 720, which may be an example of the application server 220, the application server 320, the application server 420, and/or the application server 520, as described herein. In some examples, the process flow 700 may be implemented in a system that support UE-based UE coordination, where one or more UEs 115 of a set of multiple UEs 115 may modify an uplink frame timing (e.g., while operating in a first communication mode) to achieve coordination of respective frames transmitted by each UE 115.

In the following description of the process flow 700, the operations between the UEs 115, the network entity 105-f, and the application server 720 may be communicated in a different order than the example order shown, or the operations performed by one or more of the UEs 115, the network entity 105-f, and the application server 720 may be performed in different orders or at different times. Some operations may also be omitted from the process flow 700, and other operations may be added to the process flow 700. Further, as described herein, aspects of the functions performed by one or more of the UEs 115 may additionally, or alternatively, be performed by one or more other wireless communication devices (e.g., one or more peripheral devices). The process flow 700 may illustrate techniques for coordinating frame timings across multiple wireless communication devices for holographic communications, which may enhance system efficiency and enable power saving modes at respective wireless communication devices.

In some cases, to enable the coordination of the UEs 115 for the holographic communications, the network entity 105-f (and/or a RAN associated with the network entity 105-f) may be notified that one or more UEs 115 may be initially configured with a first communication mode (e.g., an always-on communication mode with relatively frequent uplink scheduling). Additionally, one or more of the UEs 115 may be capable of estimating an RTT (e.g., an application client of each UE 115 may be capable of estimating an RTT), which may further support the coordination of the uplink frame timing among the UEs 115.

At 705, a holographic communication session may be established between the application server 720, the network entity 105-f, and a set of UEs 115 including at least the UE 115-q, the UE 115-r, the UE 115-s, and the UE 115-t. For example, one or more of the UEs 115 may establish a holographic communications session in which a service is set up between at least the UE 115-q, the UE 115-r, the UE 115-s, the UE 115-t, and the application server 720 via the network entity 105-d. In some examples, when an application function requests a setup of the holographic communications service (e.g., to the network), the application function may provide an indication that one or more UEs 115 associated with the service (e.g., at least the UE 115-q, the UE 115-r, the UE 115-s, the UE 115-t) may be configured with relatively frequent PDCCH monitoring and relatively frequent uplink grants).

As such, at 710-a, the network entity 105-f may output, and the UE 115-q may receive, a first control message indicating a first communication mode associated with the holographic communications between the UEs 115. In such cases, the UE 115-q may operate in accordance with the first communication mode, which may be referred to as an always-on communication mode that corresponds to relatively frequent communications (e.g., frequent scheduling). Similarly, at 710-b, 710-c, and 710-d, the network entity 105-f may output the first control message indicating the first communication mode to the UE 115-r, the UE 115-s, and the UE 115-t, respectively. The UE 115-r, the UE 115-s, and the UE 115-t may, after receiving the first control message, operate in accordance with the first communication mode. Here, the first communication mode may be configured to enable each UE 115 to exchange frames (e.g., video frames, holographic communications frames) to modify an uplink frame timing at each UE 115 and achieve frame timing coordination across the set of UEs 115.

For example, at 715-a, the UE 115-q may receive multiple frames while operating in accordance with the first communication mode, where the frames may be forwarded by the application server 720 and received via the network entity 105-f. Likewise, at 715-b, 715-c, and 715-d, the UE 115-r, the UE 115-s, and the UE 115-t may exchange multiple frames with the other UEs 115 as part of the holographic communications session, which may enable each UE 115 to modify its uplink frame timing.

At 725-a, the UE 115-q may modify (e.g., update, adjust) its uplink frame timing based on an RTT of the UE 115-q (or an application client associated with the UE 115-q) and the data frames received from the other UEs 115 during the frame exchange at 715-a, 715-b, 715-c, and 715-d (e.g., while operating in accordance with the first communication mode). As an example, the UE 115-q may calculate respective time offsets (e.g., d) based on the RTT and the received frames, where each time offset may be based on a respective difference between a first time (e.g., a first instance corresponding to the RTT after a transmission of a first frame by the UE 115-q) and a second time (e.g., a second instance corresponding to a reception time of a data frame from a respective UE 115 (such as a frame received from one of the UE 115-r, the UE 115-s, or the UE 115-t)). The UE 115-q may further calculate a mean time offset (e.g., dₘₑₐₙ) based on the respective time offsets (such as described with reference to FIG. 5A) and modify the frame timing based on the mean time offset.

At 725-b, 725-c, and 725-d, the UE 115-r, the UE 115-s, and the UE 115-t, respectively, may modify a respective uplink frame timing, for example, based on the data frames received from the other UEs 115 during the frame exchange at 715-a, 715-b, 715-c, and 715-d (e.g., while operating in accordance with the first communication mode). Each of the UE 115-r, the UE 115-s, and the UE 115-t may update the frame timing in accordance with one or more aspects of the techniques described herein (such as with reference to FIGS. 5A, 5B, and/or 5C).

In some cases, the UE 115-q, the UE 115-r, the UE 115-s, and the UE 115-t, may continue to operate in the first communication mode (e.g., the always-on communication mode with relatively frequent scheduling and absence of power saving) to continue to receive multiple frames from the other UEs 115. As such, each UE 115 may further update the uplink frame timing based on the frames exchanged with the other UEs 115, for example, until each UE 115 determines that the frame timing is relatively stable and coordinated with the remaining UEs 115. As an example, the UE 115-q may, after updating the uplink frame timing one or more times, determine that its uplink frame timing results in a mean time offset being within a threshold timing window or is associated with a target reception window size, which may indicate that the uplink frame timing is coordinated with the remaining UEs 115.

As such, at 730, the UE 115-q may transmit, based on modifying the uplink frame timing, a message including a request to exit the first communication mode. For example, the message may include an indication, to the network entity 105-f, that the first communication mode (e.g., always on with frequent uplink scheduling) is no longer needed, as the uplink frame timing of the UE 115-q may be coordinated. The message may be transmitted, for example, via RRC signaling (e.g., via UE assistance information signaling), via MAC-CE signaling, via UCI, or any combination thereof, to the network entity 105-f. In some examples, the message may include one or more additional indications of parameters and/or preferences associated with a power-saving mode (e.g., C-DRX). For instance, the UE 115-q may indicate, via the message at 730, one or more parameters including a C-DRX starting offset, an uplink configured grant offset, among other examples.

In response, at 735, the network entity 105-f may output, and the UE 115-q may receive, a control message indicating a configuration of the power-saving mode associated with the holographic communications. In some examples, the control message may be received in accordance with the request to exit the first communication mode, and the UE 115-q may continue to exchange frames with other UEs 115 for the holographic communications session, which may include the use of the power-saving mode (e.g., corresponding to less frequent communications than the first communication mode), as needed. As described herein, by coordinating the uplink frame timing, the UE 115-q may efficiently operate in the power-saving mode without being affected by latency, and the UE 115-q may additionally receive frames from the other UEs 115 (e.g., the UE 115-r, the UE 115-s, and the UE 115-t, among others) without multiple rendering operations, which may improve performance of the UE 115-q, support increased power use, and promote battery longevity.

At 740, 750, and 760, the UE 115-r, the UE 115-s, and the UE 115-t, respectively, may transmit respective messages to the network entity 105-f with a request to exit the first communication mode. The respective messages from the UE 115-r, the UE 115-s, and the UE 115-t may include one or more parameters or indication of a preference associated with the power-savings mode. Accordingly, each of the UEs 115 may receive a control message at 745, 755, and 765 from the network entity 105-f indicating the configuration of the power-saving mode. In some aspects, the power-saving mode configured for each of the UE 115-q, UE 115-r, the UE 115-s, and the UE 115-t, may be similar to or different from the power-saving mode configured for the other UEs 115. That is, a power-saving mode configured for one UE 115 may be specific to that UE 115 for use during the holographic communications (e.g., based on that UE's preferences and/or parameters indicated in the message). In any case, each UE 115 may utilize the power-saving mode while communicating frames with the other devices with minimal or no latency based on the coordination of the uplink frame timing across the UEs 115.

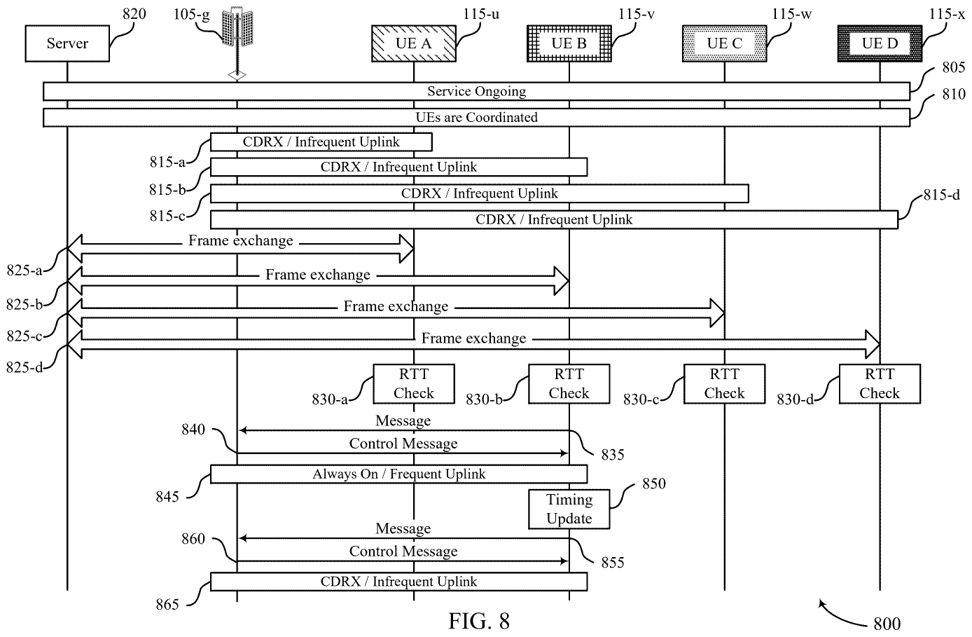

FIG. 8 shows an example of a process flow 800 that supports device coordination for holographic communications in accordance with one or more aspects of the present disclosure. In some cases, the process flow 800 may implement or be implemented by aspects of the wireless communications system 100, the wireless communications system 200, the signaling diagrams 300-a, 300-b, 300-c, 300-d, 400-a, 400-b, 400-c, 500-a, 500-b, 500-c, 500-d, the process flow 600, the process flow 700, or any combination thereof. For example, the process flow 800 may include one or more UEs 115 (e.g., a UE 115-u, a UE 115-v, a UE 115-w, a UE 115-x) and one or more network entities 105 (e.g., a network entity 105-g), which may be examples of the corresponding devices as described herein. The process flow 800 may additionally include one or more application servers, such as the application server 820, which may be an example of the application server 220, the application server 320, the application server 420, the application server 520, and/or the application server 720, as described herein. In some examples, the process flow 800 may support UE-based UE coordination, where one or more UEs 115 of a set of multiple UEs 115 may modify an uplink frame timing (e.g., while operating in a first communication mode) to achieve coordination of respective frames transmitted by each UE 115.

In the following description of the process flow 800, the operations between the UEs 115, the network entity 105-g, and the application server 820 may be communicated in a different order than the example order shown, or the operations performed by one or more of the UEs 115, the network entity 105-g, and the application server 820 may be performed in different orders or at different times. Some operations may also be omitted from the process flow 800, and other operations may be added to the process flow 800. Further, as described herein, aspects of the functions performed by one or more of the UEs 115 may additionally, or alternatively, be performed by one or more other wireless communication devices (e.g., one or more peripheral devices). The process flow 800 may illustrate techniques for coordinating frame timings across multiple wireless communication devices for holographic communications, which may enhance system efficiency and enable power saving modes at respective wireless communication devices.

At 805, a holographic communication session may be ongoing between the application server 820, the network entity 105-g, and the multiple UEs 115 (e.g., the UE 115-u, the UE 115-v, the UE 115-w, the UE 115-x, among others). In some aspects, at 810, the uplink frame timing of the UEs 115 may be coordinated, for example, as described with reference to FIGS. 4A, 4B, 4C, 5A, 5B, 5C, 5D, 6, and 7. Here, each UE 115 may have modified its respective uplink frame timing one or more times to achieve the coordination among all the UEs 115 (such as when operating in accordance with a first communication mode). As such, each UE 115 may receive (e.g., at 815-a, 815-b, 815-c, and/or 815-d), from the network entity 105-g, a respective control message indicating a configuration of the power-saving mode associated with the holographic communications. In some examples, the respective control messages may be received in accordance with a request to exit the first communication mode sent by each UE 115.

In any case, at 825-a, 825-b, 825-c, and 825-d, each UE 115 may exchange multiple frames with each other UE 115 for the holographic communications, and one or more of the UEs 115 may be configured with a power-saving mode (e.g., C-DRX) and may use relatively infrequent uplink scheduling (such as in accordance with one or more uplink configured grant configurations) for the transmission of the frames. That is, the coordination of the frame timing by the UEs 115 may enable the power-saving mode to be utilized (e.g., as needed) during the frame exchange associated with holographic communication, where the server 820 may forward (e.g., immediately forward) frames to each UE 115 included in the service.

In some cases, a latency (e.g., a one-way latency) for one or more of the UEs 115 may change, which may be based on, for example, a cell load, radio conditions, or other factors. As such, the one or more UEs 115 may no longer be coordinated with the other UEs 115, and the UEs 115 may perform techniques to re-coordinate with the other UEs 115 (e.g., re-adjust the uplink frame timing based on a changes RTT). For instance, at 830-a, 830-b, 830-c, and 830-d, the UE 115-u, the UE 115-v, the UE 115-w, and the UE 115-x may estimate (e.g., an application client of the UE 115 may estimate) the RTT associated with the transmission of frames by that UE 115. In some cases, the RTT may be estimated (or checked) in accordance with some periodicity, or based on some other triggers or factors (e.g., event-based triggers, or the like). When a UE 115 (e.g., the application client of the UE 115) detects that the RTT has changed, the UE 115 may request that the network entity 105-g configure the UE 115 with the first communication mode.

As an example, after estimating the RTT at 830-b, an application client of the UE 115-v may determine that the RTT has changes for frames associated with the application client. In such cases, the application client may provide signaling to one or more modem components of the UE 115-v and, at 835, the UE 115-v may transmit, to the network entity 105-g, a message including a request to enter the first communication mode based on the RTT changing from a first RTT to a second RTT different from the first RTT. In some aspects, the message sent at 835 may include a request for the network entity 105-g to configure frequent PDCCH monitoring and frequent uplink grants for the UE 115-v. Here, the message may be transmitted, for example, via MAC-CE signaling, via UCI, or any combination thereof, to the network entity 105-g.

At 840, the network entity 105-g may output, and the UE 115-v may receive, another control message indicating the first communication mode (e.g., an always-on mode with relatively frequent uplink scheduling). That is, the network entity 105-g may signal a configured for relatively frequent PDCCH monitoring and relatively frequent uplink grants, which may be used by the UE 115-v for communicating data frames and modifying the uplink frame timing. The control message indicating the return to the first communication mode may be sent via a MAC-CE, via DCI, or any combination thereof. In such examples, the power saving mode (e.g., C-DRX) may be deactivated, and one or more uplink configured grant configurations having relatively frequent scheduling may be configured. Further, the UE 115-v (e.g., a modem of the UE 115-v) may re-start one or more uplink coordination algorithms, such as those described with reference to FIGS. 5A, 5B, 5C, and 5D, among other examples.

For example, at 845, the UE 115-v may operate in accordance with the first communication mode, and may continue to exchange data frames with the other UEs 115 (e.g., the UE 115-u. the UE 115-w, the UE 115-x). For example, the UE 115-v may receive multiple frames while operating in accordance with the first communication mode, where the frames may be forwarded by the application server 820 and received via the network entity 105-f. The frame exchange as part of the holographic communications session may enable the UE 115-v to modify its uplink frame timing.

For example, at 850, the UE 115-v may modify (e.g., update) its uplink frame timing based on an RTT of the UE 115-v (or an application client associated with the UE 115-v) and the data frames received from the other UEs 115 during the frame exchange (e.g., while operating in accordance with the first communication mode). As an example, the UE 115-v may calculate respective time offsets (e.g., d) based on the RTT and the received frames, where each time offset may be based on a respective difference between a first time (e.g., a first instance corresponding to the RTT after a transmission of a first frame by the UE 115-v) and a second time (e.g., a second instance corresponding to a reception time of a data frame from a respective UE 115 (such as a frame received from one of the UE 115-u, the UE 115-w, or the UE 115-x)). The UE 115-v may further calculate a mean time offset (e.g., dₘₑₐₙ) based on the respective time offsets (such as described with reference to FIG. 5A) and modify the frame timing based on the mean time offset. In some aspects, the UE 115-v may modify its uplink frame timing one or more times until the frame timing is coordinated (e.g., aligned) with the frame timing of the other UEs 115.

The UE 115-v may determine that its uplink frame timing is coordinated, and, at 855, the UE 115-v may transmit, based on modifying the uplink frame timing, a message including a request to exit the first communication mode. That is, when the uplink coordination is complete, the UE 115-v (e.g., the modem of the UE 115-v) may notify the network entity 105-g that frequent PDCCH monitoring and frequent uplink grants are no longer needed. For example, the message at 855 may include an indication, to the network entity 105-g, that the first communication mode (e.g., always on with frequent uplink scheduling) is no longer needed, as the uplink frame timing of the UE 115-v may be coordinated. In some examples, the message may include one or more additional indications of parameters and/or preferences associated with a power-saving mode (e.g., C-DRX). For instance, the UE 115-v may indicate, via the message at 855, one or more parameters including a C-DRX starting offset, an uplink configured grant offset, among other examples. The message at 855 may be transmitted, for example, via MAC-CE signaling, via UCI, or any combination thereof, to the network entity 105-g.

In response, at 860, the network entity 105-g may output, and the UE 115-v may receive, a control message indicating a configuration of the power-saving mode associated with the holographic communications. As such, the UE 115-v (and the network entity 105-g) may operate in accordance with relatively less frequent PDCCH monitoring and less frequent uplink grants again. The control message indicating the return to the power-saving mode may be output from the network entity 105-g via a MAC-CE, via DCI, or any combination thereof. Here, the power-saving mode (e.g., C-DRX) may be activated, and one or more uplink configured grant configurations associated with relatively less frequent scheduling may be configured for the UE 115-v. In some examples, the control message may be received in accordance with the request to exit the first communication mode, and the UE 115-v may continue to exchange frames with other UEs 115 for the holographic communications session, which may include the use of the power-saving mode (e.g., corresponding to less frequent communications than the first communication mode), as needed. For instance, the UE 115-v may operate in accordance with the power-saving mode at 865, and may continue to exchange frames with the other UEs 115 as part of the holographic communications session.

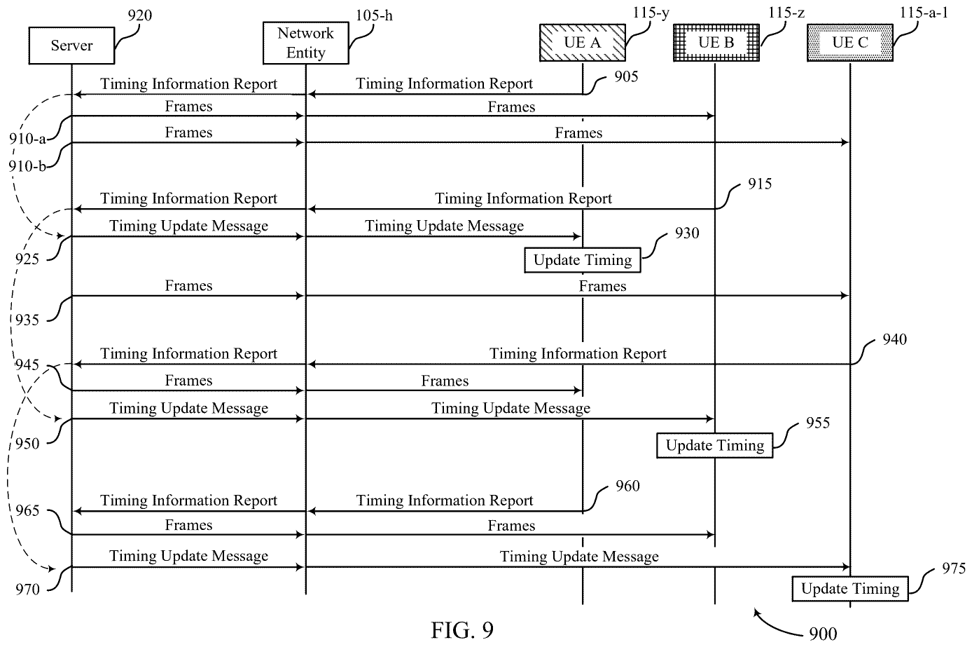

FIG. 9 shows an example of a process flow 900 that supports device coordination for holographic communications in accordance with one or more aspects of the present disclosure. In some examples, the process flow 900 may implement or be implemented by aspects of the wireless communications system 100 and the wireless communications system 200. For example, the process flow 900 may include one or more UEs 115 (e.g., a UE 115-y, a UE 115-z, a UE 115-a-1) and one or more network entities 105 (e.g., a network entity 105-h), which may be examples of the corresponding devices as described herein. The process flow 900 may additionally include one or more application servers, such as the application server 920, which may be an example of the application server 220, as described with reference to FIG. 2.

In some aspects, the process flow 900 may be utilized in a system that supports application server-based UE coordination techniques (e.g., for holographic communications), where the application server 920 may determine an uplink frame timing (e.g., an optimal uplink frame transmission timing) for each UE 115, and the application server 920 may output (e.g., to respective application clients of each UE 115) an indication to modify a frame timing in accordance with the determined uplink frame timing. In such cases, each application client of a respective UE 115 may report timing information to the application server 920 via in-band signaling, and the application server 920 may signal, to each application client and via the in-band signaling, how the application client may modify the uplink frame timing.

For example, at 905, the UE 115-y may transmit (e.g., an application client of the UE 115-y may output) a timing information report that indicates timing information associated with data frames transmitted by the UE 115-y. The timing information report may be transmitted to the application server 920 via the network entity 105-h. That is, the network entity 105-h may obtain the timing information report from the UE 115-y, and the network entity 105-h may output the timing information report to the application server 920

The timing information report may indicate a transmission time of a data frame (e.g., a video frame) transmitted by the UE 115-y (e.g., output by the application client). The timing information report may further indicate respective reception times of one or more data frames (e.g., video frames) received by the UE 115-y (e.g., frames obtained by the application client of the UE 115-y). In some aspects, the timing information report may be signaled to the application server 920 via in-band signaling (e.g., via the same signaling as is used for other holographic communication frames). For instance, the timing information report may be transmitted to the application server with one or more data frames (e.g., video frames) for holographic communications.

At 910-a and 910-b, the application server 920 may output data frames to the UE 115-z and the UE 115-a-1, respectively, as part of the holographic communications. That is, the application server 920 may forward (e.g., immediately forward) frames received from the UE 115-y to the other UEs 115 in the system (e.g., to UE 115-z and UE 115-a-1, among others included in the holographic communications session).

At 915, the UE 115-z may transmit (e.g., an application client of the UE 115-z may output) a timing information report that indicates timing information associated with data frames transmitted by the UE 115-z, where the timing information report may be transmitted to the application server 920 via the network entity 105-h and using in-band signaling. The timing information report from the UE 115-z may be transmitted as part of the holographic communications session, and may be sent with one or more data frames. The timing information report may further include, for example, information about respective reception times of data frames (e.g., video frames) received by the UE 115-z (e.g., time instances for frames obtained by the application client of the UE 115-z).

At 925, the application server 920 may output, and the UE 115-y may receive, a timing update message that includes an indication to modify an uplink frame timing associated with the holographic communications. The timing update report may be received by the UE 115-y via the network entity 105-h, where the network entity 105-h may obtain the signaling including the timing update message (and one or more frames), and the network entity 105-h may output the timing update message to the UE 115-y.

The timing update message may be based on the timing information report provided by the UE 115-y (e.g., at 905). For example, the application server 920 may use the information included in the timing information report at 905 (e.g., the transmission time of a data frame transmitted by the UE 115-y and the respective reception times of one or more data frames received by the UE 115-y) to determine what timing adjustments (if any) may be implemented by the UE 115-y for transmitting uplink frames.

Thus, in some examples, the UE 115-y may modify an uplink frame timing at 930 based on the received timing update message from the application server 920. In some aspects, the timing update message may indicate one or more timing offsets that may be used by the UE 115-y for modifying the uplink frame timing (e.g., updating the uplink frame timing).

At 935, the application server 920 may output data frames to the UE 115-a-1 as part of the holographic communications. That is, the application server 920 may forward (e.g., immediately forward) frames received from the UE 115-z to the other UEs 115 in the system (e.g., to UE 115-y and UE 115-a-1, and so forth).

In some examples, each UE 115 may receive a respective timing update message from the application server 920, where each timing update message may be received in accordance with a previously-provided timing information report from a corresponding UE 115. For example, at 940, the application server may receive (e.g., via the network entity 105-h and using in-band signaling) a timing information report from the UE 115-a-1, which may be included with data frames for holographic communications from the UE 115-a-1. At 945, the application server 920 may output the data frames to the UE 115-y and, at 950, the application server 920 may also output a timing update message (e.g., with the data frames received from the UE 115-a-1) to the UE 115-z. The timing update message received by the UE 115-z at 950 may include an indication to update an uplink frame timing, which may be based on the information included in the timing information report the UE 115-z provided at 915. That is, an indication to update the frame timing may be based on respective transmission and reception times indicated by the UE 115-z to the application server 920. At 955, the UE 115-z may accordingly modify (e.g., update, adjust) its uplink frame timing for transmission of holographic communication frames using the timing update message.

In some cases, the UEs 115 may transmit one or more additional timing information reports (e.g., until the uplink frame timing is coordinated among the UEs 115). For example, at 960, the UE 115-y may transmit (e.g., an application client of the UE 115-y may output) a second timing information report to the application server 920, where the timing information report may indicate timing information for a transmission time of an additional data frame transmitted by the UE 115-y (e.g., transmitted in accordance with the frame timing update at 930). The second timing information report may further indicate respective reception times of one or more additional data frames received by the UE 115-y (e.g., data frames transmitted by other UEs 115 after those UEs 115 have updated the uplink frame timing). The application server 920 may use the second timing information report to further adjust the uplink frame timing of the UE 115-y. Alternatively, the application server 920 may determine, based on the contents of the timing information, that the UE 115-y may refrain from further uplink frame timing adjustments.

At 965, the application server 920 may output (e.g., via the network entity 105-h and using in-band signaling) data frames to the UE 115-z and the UE 115-a-1, where the signaling sent to the UE 115-a-1 may include a timing update message that indicates whether the UE 115-a-1 may update its uplink frame timing. At 975, the UE 115-a-1 may update the uplink frame timing based on the timing update message received from the application server 920 (e.g., at 970).

In accordance with the described techniques, the timing update information determined by the application server 920 (e.g., optimal uplink timing values) may enable each UE 115 (e.g., the UE 115-y, the UE 115-z, the UE 115-a-1) to coordinate their uplink frame timing, which may result in coordinated frame transmissions (e.g., for holographic communications) and support enhanced power savings techniques with reduced latency.

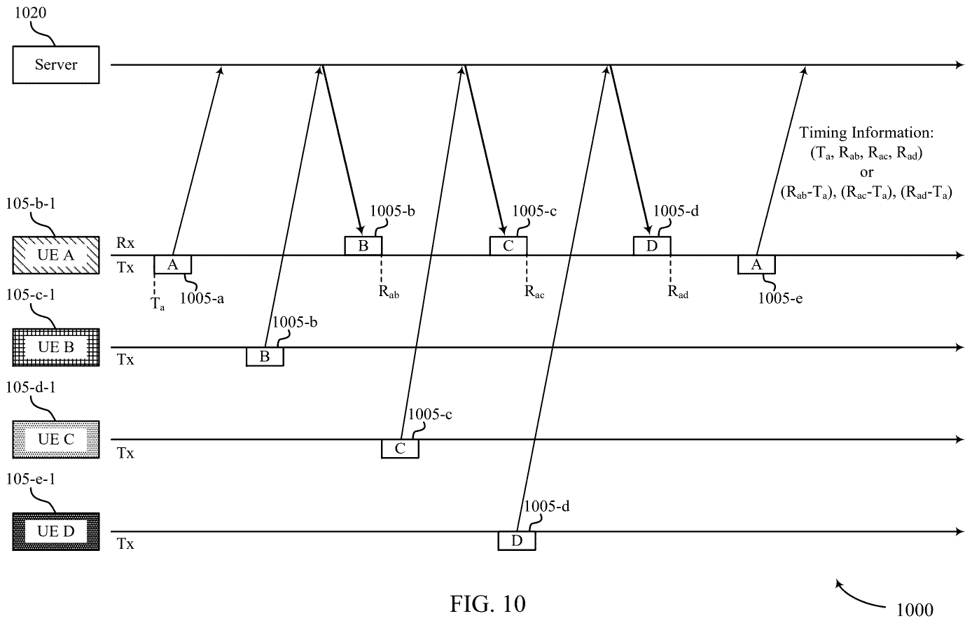

FIG. 10 shows an example of a signaling diagram 1000 that supports device coordination for holographic communications in accordance with one or more aspects of the present disclosure. The signaling diagram 1000 may implement or be implemented by aspects of the wireless communications system 100, the wireless communications system 200, and the process flows 400-a, 400-b, 400-c, and 900. For example, the signaling diagram 1000 may illustrate the transmission and reception of one or more frames 1005 by one or more wireless communication devices associated with respective users (e.g., a first UE 115-b-1, a second UE 115-c-1, a third UE 115-d-1, and a fourth UE 115-e-1). In some aspects, the signaling diagram 1000 may be utilized in a system that supports application server-based UE coordination techniques (e.g., for holographic communications), where an application server 1020 may determine an uplink frame timing (e.g., an optimal uplink frame transmission timing) for each UE 115, and the application server 1020 may output (e.g., to respective application clients of each UE 115) an indication to modify a frame timing in accordance with the determined uplink frame timing. In such cases, each application client of a respective UE 115 may report timing information to the application server 1020 via in-band signaling, and the application server 1020 may signal, to each application client and via the in-band signaling, how the application client may modify the uplink frame timing.

The frames 1005 communicated by each UE 115 may, additionally, or alternatively, be transmitted and/or received by one or more peripheral devices, which may be examples of the corresponding devices described with reference to FIGS. 1 and 2. As an example, the first UE 115-b-1 may be coupled with (e.g., via a wired link or a wireless link, or both) or more peripheral devices that may each support techniques and functions associated with holographic communications (such as video capture, video presentation, audio capture, audio playback, among other examples). Each UE 115 may exchange (e.g., transmit and receive) signaling with the application server 1020 via one or more network entities (such as a network entity 105 described with reference to FIGS. 1 and 2). That is, each UE 115 depicted in the signaling diagram 1000 may transmit and receive frames 1005 via at least one network entity 105, where the at least one network entity 105 may be used for communicating the frames 1005 between the application server 1020 and each UE 115 of a set of multiple UEs 115 (e.g., the UE 115-b-1, the UE 115-c-1, the UE 115-d-1, the UE 115-e-1, and so forth). In some aspects, the application server 1020 may be an example of the corresponding application servers described herein.

To determine an updated uplink frame timing (e.g., an optimized uplink frame timing), the application server 1020 may obtain, from the application clients of the respective UEs 115, when each application client outputs a frame and when each application client receives the frames from other UEs 115. In some cases, a time instance when a frame is output (e.g., transmitted) may be denoted as Tᵢ, which may correspond to an Instant when a stream including at least one frame is issued by an application client of the UE “i.” Additionally, a time instance corresponding to the reception of a frame may be denoted as Rᵢⱼ, and may be an instant when a stream (e.g., one or more frames) of the UE “j” has been fully received by the UE “i.”

As an illustrative example, the UE 115-b-1 (e.g., UE A) may transmit (e.g., an application client of the UE 115-b-1 may output) a first frame 1005-a to the application server 1020 (which may be immediately forwarded to each other UE 115). The time instance at which the first frame 1005-a is transmitted may be Tₐ. Additionally, the UE 115-b-1 may receive (e.g., the application client of the UE 115-b-1 may obtain) a second frame 1005-b that is forwarded by the application server 1020 from the UE 115-c-1 (e.g., UE B). The time instance at which the second frame is received by the UE 115-b-1 from the UE 115-c-1 (e.g., via the application server 1020) may be R_{ab}. The UE 115-b-1 may further receive a third frame 1005-c (e.g., from the UE 115-d-1 via the application server 1020) and a fourth frame 1005-d (e.g., from the UE 115-e-1 via the application server 1020), where the reception time associated with the third frame may be R_{ac} and the reception time for the fourth frame may be R_{ad}. As described herein, the UE 115-b-1 may receive the second frame 1005-b, the third frame 1005-c, and the fourth frame 1005-d every 1/fps of a communications session (e.g., a holographic communications session).

When the UE 115-b-1 transmits (e.g., when the application client of the UE 115-b-1 outputs) a next frame 1005-e (e.g., via in-band signaling), the transmission may include a timing information report that indicates timing information associated with the first frame 1005-a, the second frame 1005-b, the third frame 1005-c, and the fourth frame 1005-d. For example, the timing information report may indicate Tₐ, R_{ab}, R_{ac}, R_{ad}, or any combination thereof. The application server 1020 may receive the timing information report via the in-band signaling, and the application server 1020 may use the information indicated by the timing information report (e.g.,) to calculate a timing offset that the UE 115-b-1 may use to modify an uplink frame timing. The timing offset may be configured such that the frames transmitted by the UE 115-b-1 are coordinated with the frames of the other UEs 115 (e.g., the UE 115-c-1, the UE 115-d-1, the UE 115-e-1, and so forth). Further, each UE 115 may transmit (the application client of each UE 115 may output) its own timing information report, the information of which may also be used by the application server 1020 to determine an uplink frame timing (e.g., an optimal uplink frame timing) for each UE 115 of the set of UEs 115. Here, the optimal uplink frame timing determined by the application server 1020 may be one that enables coordination of frames transmitted by each UE 115, such as illustrated in FIGS. 4A, 4B, and 4C.

In some aspects, an application client of each UE “i” may report (e.g., via a timing information report) a reference time of an instant when a frame is issued (such as Tᵢ) and respective instants when the latest frames from other UEs (j≠i) were received (such as Rᵢⱼ). Here, the reference time that is indicated in a timing information report (and/or a timing update message) between the application server 1020 and an application client may be, for example, a time elapsed since the start of a global positioning system (GPS) time (e.g., 00:00:00 on Jan. 6, 1980 of the Gregorian calendar). In some examples, the timing information may be indicated using some quantity of days, seconds, milliseconds, nanoseconds, or any combination thereof, from the reference time. In any case, both the application server 1020 and the application clients of the respective UEs 115 may have access to the reference time (e.g., the GPS time), which may be used to identify timing values and calculate timing updates for uplink frame timing. In some examples, other reference times may be used for indicating the timing information (e.g., Tᵢ, Rᵢⱼ) by the application clients (e.g., by the UEs 115).

Additionally, or alternatively, instead of a reference time for the timing information included in a timing information report, the UE 115-b-1 (e.g., the application client of the UE 115-b-1) may report a time difference between the instant when the first frame 1005-a is transmitted (e.g., Tₐ) and the respective instants when the most recent frames from other UEs 115 are received (e.g., R_{ab}, R_{ac}, R_{ad}). For example, the timing information report that is sent by the UE 115-b-1 may include the time differences: R_{ab}−Tₐ, R_{ac}−Tₐ, and R_{ad}−Tₐ. In some cases, a UE 115 may report as many time differences as the number of other UEs 115.

In some examples, the application server 1020 may configure the application client of the UE “i” with one or more timing information reporting configurations. As an example, the timing information report sent by one or more UEs 115 may be periodic, aperiodic, conditional, or any combination thereof. In some cases, periodic timing information reporting may be transmitted in accordance with a periodicity that may be provided by the application server 1020. In the case of aperiodic timing information reporting, a timing information report may be transmitted based on a request (e.g., triggered by a request) from the application server 1020. In some aspects, the request for the timing information report may be received by a UE 115 as in-band signaling. In examples of conditional timing information reporting, when a specific condition, event, or trigger occurs, the UE 115 (e.g., the application client of the UE 115) may transmit the timing information report. As an example of the condition, event, or trigger for the conditional reporting, a time difference between the reception of two consecutive frames from the same UE 115 exceeds a configured threshold may trigger the transmission of the timing information report. Additionally, or alternatively, the application server 1020 may configure each application client with one or more averaging windows, which may be a time window over which timing measurements are averaged by each UE 115.

In some aspects, the application server 1020 may be aware of an RTT associated with one or more UEs 115. In such cases, the application server 1020 may run one or more algorithms to determine an uplink frame timing adjustment. For example, the application server 1020 may run an algorithm similar to the coordination algorithms described with reference to FIGS. 5A, 5B, 5C, 5D, and 6, by which one or more uplink frame timing values (e.g., UL_Offset) may be determined using an RTT, one or more evaluation periods (including traffic periods), one or more reception windows, and/or the respective time instances at which frames are received from UEs 115.

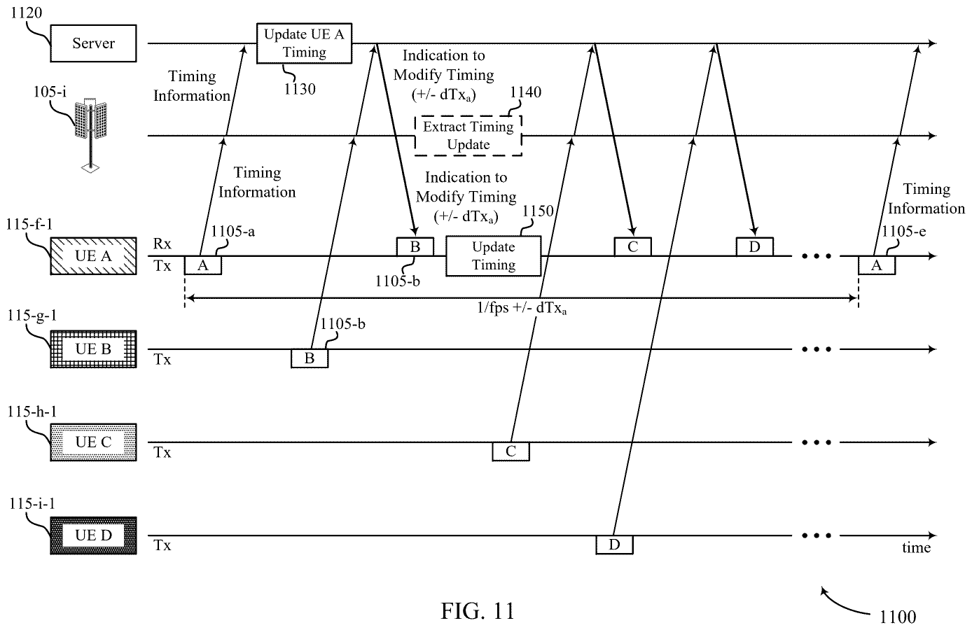

FIG. 11 shows an example of a signaling diagram 1100 that supports device coordination for holographic communications in accordance with one or more aspects of the present disclosure. The signaling diagram 1100 may implement or be implemented by aspects of the wireless communications system 100, the wireless communications system 200, the process flows 400-a, 400-b, 400-c, and 900, and the signaling diagram 1000. For example, the signaling diagram 1100 may illustrate the transmission and reception of one or more frames 1105 by one or more wireless communication devices associated with respective users (e.g., a first UE 115-f-1, a second UE 115-g-1, a third UE 115-g-1, and a fourth UE 115-i-1). In some aspects, the signaling diagram 1100 may be utilized in a system that supports application server-based UE coordination techniques (e.g., for holographic communications), where an application server 1120 may determine an uplink frame timing (e.g., an optimal uplink frame transmission timing) for each UE 115, and the application server 1120 may output (e.g., to respective application clients of each UE 115) an indication to modify a frame timing in accordance with the determined uplink frame timing. In such cases, each application client of a respective UE 115 may report timing information to the application server 1120 via in-band signaling, and the application server 1120 may signal, to each application client and via the in-band signaling, how the application client may modify the uplink frame timing.

The frames 1105 communicated by each UE 115 may, additionally, or alternatively, be transmitted and/or received by one or more peripheral devices, which may be examples of the corresponding devices described with reference to FIGS. 1 and 2. As an example, the first UE 115-f-1 may be coupled with (e.g., via a wired link or a wireless link, or both) or more peripheral devices that may each support techniques and functions associated with holographic communications (such as video capture, video presentation, audio capture, audio playback, among other examples). Each UE 115 may exchange (e.g., transmit and receive) signaling with the application server 1120 via one or more network entities (such as a network entity 105-i, which may be an example of the corresponding devices described with reference to FIGS. 1 and 2). That is, each UE 115 depicted in the signaling diagram 1100 may transmit and receive frames 1105 via at least one network entity 105, where the at least one network entity 105 may be used for communicating the frames 1105 between the application server 1120 and each UE 115 of a set of multiple UEs 115 (e.g., the UE 115-f-1, the UE 115-g-1, the UE 115-h-1, the UE 115-i-1, and so forth). In some aspects, the application server 1120 may be an example of the corresponding application servers described herein.

As described herein, the application server 1120 may use timing information received from the UEs 115 (from the respective application clients associated with each UE 115) to determine how the uplink frame timing of respective UEs 115 may be modified (e.g., changed). In such cases, the application server 1120 may request each application client to update an instant when a next frame may be issued. Further, the network (e.g., RAN) associated with the network entity 105-i may be notified (e.g., made aware) of the modification of the uplink frame timing for each UE 115, which may enable the network entity 105-i to allocate corresponding uplink resources accordingly (e.g., using one or more uplink configured grant configurations).

As an example, the UE 115-f-1 may transmit, to the application server 1120 and via the network entity 105-i, a frame 1105-a along with a timing information report via in-band signaling. As described herein, the timing information report may indicate timing information associated with data frames transmitted by the UE 115-f-1 and timing information associated with respective reception times of data frames received by the UE 115-f-1. The application server 1120 may perform one or more calculations at 1130 to determine an updated uplink frame timing for the UE 115-f-1 based on the timing information included in the timing information report.

Based on the uplink frame timing (e.g., optimal uplink frame timing) determined at 1130, the application server 1120 may signal a timing offset (e.g., dTxᵢ) to the application client of the UE “i.” For instance, a timing update message including an indication to update an uplink frame timing, and further indicating a timing offset, dTxₐ (and which may also indicate whether dTxₐ may be added or subtracted to a current uplink frame timing), may be signaled to the UE 115-f-1 (e.g., UE A). In some examples, the timing update message may be included in signaling transmitted in-band when the application server 1120 forwards a frame 1105-b received from the UE 115-g-1. That is, the offset (dTxᵢ) may be transmitted as in-band signaling in a frame 1105 that is transmitted to a UE “i.”

In some aspects, when the network entity 105-i obtains signaling from the application server 1120 that includes the timing update message, at 1140, the network entity 105-i may extract (e.g., decode, obtain) the information included in the timing update message. In some cases, the network entity 105-i may utilize the offset (dTxᵢ) for one or more algorithms (such as radio resource management (RRM) algorithms) for the UE “i.”

In some examples, however, the network entity 105-i may be unable to extract the timing information (e.g., including the timing offset, dTxₐ) from one or more packets (e.g., received from a UPF). In such cases, the UE 115-f-1 may transmit an indication of the offset to the network entity 105-i. For example, the UE 115-f-1 may transmit RRC signaling (e.g., UE assistance information), MAC-CE signaling, UCI, or any combination thereof, to indicate the timing offset indicated in the timing update message from the application server 1120.

At 1150, the application client of the UE “i” (e.g., the application client of the UE 115-f-1) may update an instant when a next frame 1105-e is to be issued in accordance with the indicated offset (e.g., dTxₐ). In such cases, the frame timing of the UE 115-f-1 may be coordinated with the frame timing of the other UEs 115, where each UE 115 may receive a timing update message from the application server 1120 using similar techniques described herein.

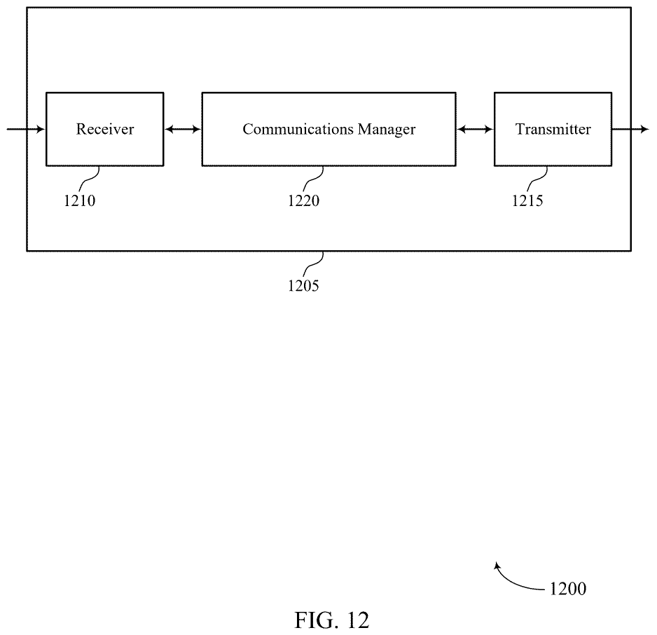

FIG. 12 shows a block diagram 1200 of a device 1205 that supports device coordination for holographic communications in accordance with one or more aspects of the present disclosure. The device 1205 may be an example of aspects of a UE 115 as described herein. The device 1205 may include a receiver 1210, a transmitter 1215, and a communications manager 1220. The device 1205, or one or more components of the device 1205 (e.g., the receiver 1210, the transmitter 1215, the communications manager 1220), may include at least one processor, which may be coupled with at least one memory, to, individually or collectively, support or enable the described techniques. Each of these components may be in communication with one another (e.g., via one or more buses).

The receiver 1210 may provide a means for receiving information such as packets, user data, control information, or any combination thereof associated with various information channels (e.g., control channels, data channels, information channels related to device coordination for holographic communications). Information may be passed on to other components of the device 1205. The receiver 1210 may utilize a single antenna or a set of multiple antennas.

The transmitter 1215 may provide a means for transmitting signals generated by other components of the device 1205. For example, the transmitter 1215 may transmit information such as packets, user data, control information, or any combination thereof associated with various information channels (e.g., control channels, data channels, information channels related to device coordination for holographic communications). In some examples, the transmitter 1215 may be co-located with a receiver 1210 in a transceiver module. The transmitter 1215 may utilize a single antenna or a set of multiple antennas.

The communications manager 1220, the receiver 1210, the transmitter 1215, or various combinations or components thereof may be examples of means for performing various aspects of device coordination for holographic communications as described herein. For example, the communications manager 1220, the receiver 1210, the transmitter 1215, or various combinations or components thereof may be capable of performing one or more of the functions described herein.

In some examples, the communications manager 1220, the receiver 1210, the transmitter 1215, or various combinations or components thereof may be implemented in hardware (e.g., in communications management circuitry). The hardware may include at least one of a processor, a digital signal processor (DSP), a central processing unit (CPU), an application-specific integrated circuit (ASIC), a field-programmable gate array (FPGA) or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 1220, the receiver 1210, the transmitter 1215, or various combinations or components thereof may be implemented in code (e.g., as communications management software or firmware) executed by at least one processor (e.g., referred to as a processor-executable code). If implemented in code executed by at least one processor, the functions of the communications manager 1220, the receiver 1210, the transmitter 1215, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 1220 may be configured to perform various operations (e.g., receiving, obtaining, monitoring, outputting, transmitting) using or otherwise in cooperation with the receiver 1210, the transmitter 1215, or both. For example, the communications manager 1220 may receive information from the receiver 1210, send information to the transmitter 1215, or be integrated in combination with the receiver 1210, the transmitter 1215, or both to obtain information, output information, or perform various other operations as described herein.

The communications manager 1220 may support wireless communications in accordance with examples as disclosed herein. For example, the communications manager 1220 is capable of, configured to, or operable to support a means for receiving a first control message indicating a first communication mode associated with holographic communications between a set of multiple wireless communication devices, the set of multiple wireless communication devices including the wireless communication device. The communications manager 1220 is capable of, configured to, or operable to support a means for modifying an uplink frame timing based on a round trip time and a set of multiple data frames received while operating in accordance with the first communication mode. The communications manager 1220 is capable of, configured to, or operable to support a means for transmitting, based on modifying the uplink frame timing, a message including a request to exit the first communication mode. The communications manager 1220 is capable of, configured to, or operable to support a means for receiving a second control message indicating a configuration of a power-saving mode associated with the holographic communications, where receiving the second control message is in accordance with the request to exit the first communication mode, and where the power-saving mode corresponds to less frequent communications than the first communication mode.

Additionally, or alternatively, the communications manager 1220 may support wireless communications in accordance with examples as disclosed herein. For example, the communications manager 1220 is capable of, configured to, or operable to support a means for transmitting a timing information report indicative of a transmission time of a data frame transmitted by the wireless communication device and respective reception times of a set of multiple data frames received by the wireless communication device, where the data frame and the set of multiple data frames are associated with holographic communications between a set of multiple wireless communication devices including the wireless communication device. The communications manager 1220 is capable of, configured to, or operable to support a means for receiving a timing update message including an indication to modify an uplink frame timing associated with the holographic communications, where the indication to modify the uplink frame timing is based on the timing information report. The communications manager 1220 is capable of, configured to, or operable to support a means for modifying the uplink frame timing in accordance with the timing update message.

By including or configuring the communications manager 1220 in accordance with examples as described herein, the device 1205 (e.g., at least one processor controlling or otherwise coupled with the receiver 1210, the transmitter 1215, the communications manager 1220, or a combination thereof) may support techniques for reduced processing, reduced power consumption, and more efficient utilization of communication resources. For example, the techniques supported by the device 1205 may enable efficient power saving operations when exchanging frames for holographic communications, which may also be associated with reduced latency. Further, the techniques supported by the device 1205 may enable improved rendering and processing of data frames (e.g., video frames) based on the frames being received in a coordinated manner, where a single rendering operation may be performed for groups of frames that are received at approximately the same time (e.g., within a threshold duration).

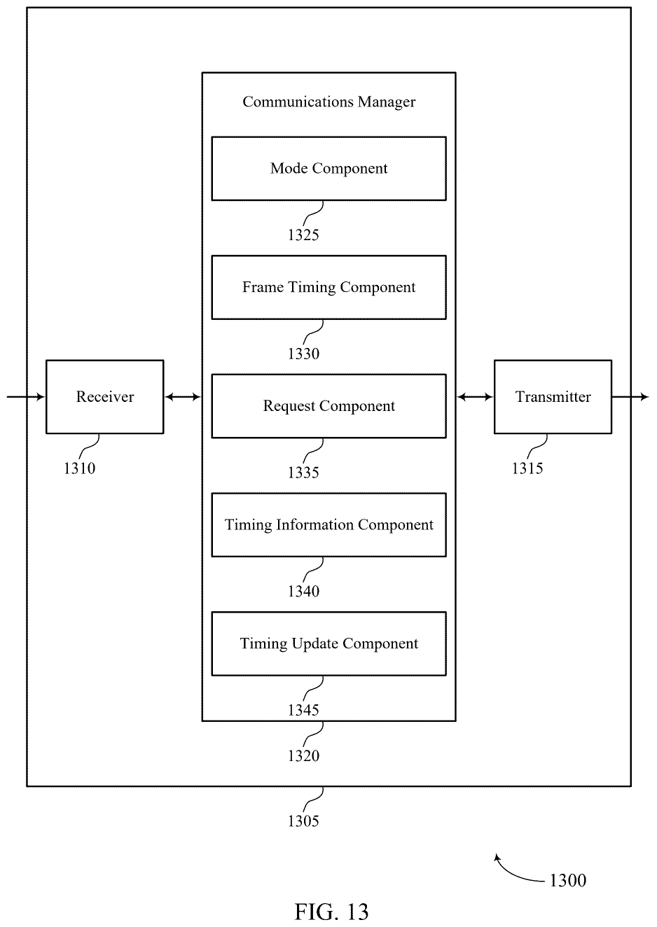

FIG. 13 shows a block diagram 1300 of a device 1305 that supports device coordination for holographic communications in accordance with one or more aspects of the present disclosure. The device 1305 may be an example of aspects of a device 1205 or a UE 115 as described herein. The device 1305 may include a receiver 1310, a transmitter 1315, and a communications manager 1320. The device 1305, or one or more components of the device 1305 (e.g., the receiver 1310, the transmitter 1315, the communications manager 1320), may include at least one processor, which may be coupled with at least one memory, to support the described techniques. Each of these components may be in communication with one another (e.g., via one or more buses).

The receiver 1310 may provide a means for receiving information such as packets, user data, control information, or any combination thereof associated with various information channels (e.g., control channels, data channels, information channels related to device coordination for holographic communications). Information may be passed on to other components of the device 1305. The receiver 1310 may utilize a single antenna or a set of multiple antennas.

The transmitter 1315 may provide a means for transmitting signals generated by other components of the device 1305. For example, the transmitter 1315 may transmit information such as packets, user data, control information, or any combination thereof associated with various information channels (e.g., control channels, data channels, information channels related to device coordination for holographic communications). In some examples, the transmitter 1315 may be co-located with a receiver 1310 in a transceiver module. The transmitter 1315 may utilize a single antenna or a set of multiple antennas.

The device 1305, or various components thereof, may be an example of means for performing various aspects of device coordination for holographic communications as described herein. For example, the communications manager 1320 may include a mode component 1325, a frame timing component 1330, a request component 1335, a timing information component 1340, a timing update component 1345, or any combination thereof. The communications manager 1320 may be an example of aspects of a communications manager 1220 as described herein. In some examples, the communications manager 1320, or various components thereof, may be configured to perform various operations (e.g., receiving, obtaining, monitoring, outputting, transmitting) using or otherwise in cooperation with the receiver 1310, the transmitter 1315, or both. For example, the communications manager 1320 may receive information from the receiver 1310, send information to the transmitter 1315, or be integrated in combination with the receiver 1310, the transmitter 1315, or both to obtain information, output information, or perform various other operations as described herein.

The communications manager 1320 may support wireless communications in accordance with examples as disclosed herein. The mode component 1325 is capable of, configured to, or operable to support a means for receiving a first control message indicating a first communication mode associated with holographic communications between a set of multiple wireless communication devices, the set of multiple wireless communication devices including the wireless communication device. The frame timing component 1330 is capable of, configured to, or operable to support a means for modifying an uplink frame timing based on a round trip time and a set of multiple data frames received while operating in accordance with the first communication mode. The request component 1335 is capable of, configured to, or operable to support a means for transmitting, based on modifying the uplink frame timing, a message including a request to exit the first communication mode. The mode component 1325 is capable of, configured to, or operable to support a means for receiving a second control message indicating a configuration of a power-saving mode associated with the holographic communications, where receiving the second control message is in accordance with the request to exit the first communication mode, and where the power-saving mode corresponds to less frequent communications than the first communication mode.

Additionally, or alternatively, the communications manager 1320 may support wireless communications in accordance with examples as disclosed herein. The timing information component 1340 is capable of, configured to, or operable to support a means for transmitting a timing information report indicative of a transmission time of a data frame transmitted by the wireless communication device and respective reception times of a set of multiple data frames received by the wireless communication device, where the data frame and the set of multiple data frames are associated with holographic communications between a set of multiple wireless communication devices including the wireless communication device. The timing update component 1345 is capable of, configured to, or operable to support a means for receiving a timing update message including an indication to modify an uplink frame timing associated with the holographic communications, where the indication to modify the uplink frame timing is based on the timing information report. The frame timing component 1330 is capable of, configured to, or operable to support a means for modifying the uplink frame timing in accordance with the timing update message.

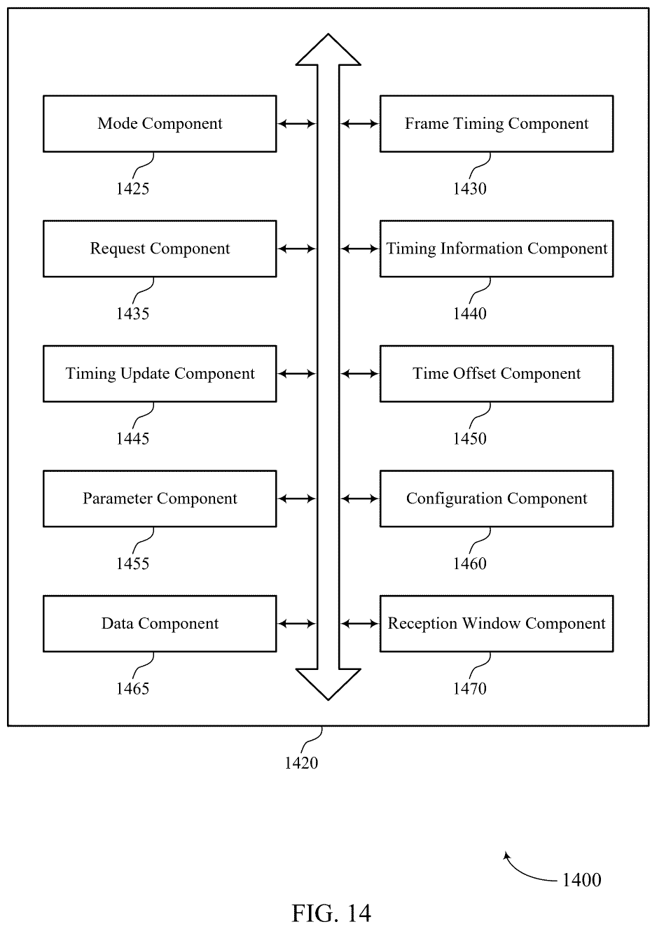

FIG. 14 shows a block diagram 1400 of a communications manager 1420 that supports device coordination for holographic communications in accordance with one or more aspects of the present disclosure. The communications manager 1420 may be an example of aspects of a communications manager 1220, a communications manager 1320, or both, as described herein. The communications manager 1420, or various components thereof, may be an example of means for performing various aspects of device coordination for holographic communications as described herein. For example, the communications manager 1420 may include a mode component 1425, a frame timing component 1430, a request component 1435, a timing information component 1440, a timing update component 1445, a time offset component 1450, a parameter component 1455, a configuration component 1460, a data component 1465, a reception window component 1470, or any combination thereof. Each of these components, or components or subcomponents thereof (e.g., one or more processors, one or more memories), may communicate, directly or indirectly, with one another (e.g., via one or more buses).

The communications manager 1420 may support wireless communications in accordance with examples as disclosed herein. The mode component 1425 is capable of, configured to, or operable to support a means for receiving a first control message indicating a first communication mode associated with holographic communications between a set of multiple wireless communication devices, the set of multiple wireless communication devices including the wireless communication device. The frame timing component 1430 is capable of, configured to, or operable to support a means for modifying an uplink frame timing based on a round trip time and a set of multiple data frames received while operating in accordance with the first communication mode. The request component 1435 is capable of, configured to, or operable to support a means for transmitting, based on modifying the uplink frame timing, a message including a request to exit the first communication mode. In some examples, the mode component 1425 is capable of, configured to, or operable to support a means for receiving a second control message indicating a configuration of a power-saving mode associated with the holographic communications, where receiving the second control message is in accordance with the request to exit the first communication mode, and where the power-saving mode corresponds to less frequent communications than the first communication mode.

In some examples, to support modifying the uplink frame timing, the time offset component 1450 is capable of, configured to, or operable to support a means for calculating a set of multiple time offsets based on the round trip time and the set of multiple data frames, where each time offset of the set of multiple time offsets includes a respective difference between a first time and a second time, the first time including a time instance that is the round trip time after transmission of a first frame by the wireless communication device, the second time including a reception time of a data frame of the set of multiple data frames from a respective wireless communication device of the set of multiple wireless communication devices. In some examples, to support modifying the uplink frame timing, the time offset component 1450 is capable of, configured to, or operable to support a means for calculating a mean time offset based on the set of multiple time offsets. In some examples, to support modifying the uplink frame timing, the frame timing component 1430 is capable of, configured to, or operable to support a means for modifying the uplink frame timing based on the mean time offset.

In some examples, the time offset component 1450 is capable of, configured to, or operable to support a means for comparing the mean time offset to the round trip time, where modifying the uplink frame timing is based on the mean time offset being different from the round trip time.

In some examples, the time offset component 1450 is capable of, configured to, or operable to support a means for calculating an evaluation time offset for each evaluation period of one or more evaluation periods, each evaluation period of the one or more evaluation periods including a set of multiple consecutive traffic periods, and each traffic period of the set of multiple consecutive traffic periods corresponding to a reception window during which the set of multiple data frames are received.

In some examples, the time offset component 1450 is capable of, configured to, or operable to support a means for calculating, for each traffic period of the set of multiple consecutive traffic periods, a respective mean time offset based on a set of time offsets associated with each traffic period, where each time offset of the set of time offsets includes the respective difference between the first time and the second time. In some examples, the time offset component 1450 is capable of, configured to, or operable to support a means for calculating the evaluation time offset based on the respective mean time offsets.

In some examples, the reception window component 1470 is capable of, configured to, or operable to support a means for calculating, for each traffic period of the set of multiple consecutive traffic periods, a reception window size of the reception window corresponding to each traffic period, the reception window size being based on a first data frame and a last data frame of the set of multiple data frames received from the set of multiple wireless communication devices. In some examples, the reception window component 1470 is capable of, configured to, or operable to support a means for calculating, for each evaluation period, a mean reception window size based on the reception window sizes. In some examples, the frame timing component 1430 is capable of, configured to, or operable to support a means for modifying the uplink frame timing based on the evaluation time offset or the mean reception window size, or both.

In some examples, to support modifying the uplink frame timing, the frame timing component 1430 is capable of, configured to, or operable to support a means for modifying the uplink frame timing in accordance with the evaluation time offset based on a time instance corresponding to the evaluation time offset being outside of a threshold timing window.

In some examples, to support modifying the uplink frame timing, the frame timing component 1430 is capable of, configured to, or operable to support a means for modifying the uplink frame timing in accordance with the mean reception window size based on a time instance corresponding to the evaluation time offset being included in a threshold timing window, where modifying the uplink frame timing is further based on the mean reception window size failing to satisfy a target reception window size.

In some examples, to support transmitting the message, the request component 1435 is capable of, configured to, or operable to support a means for transmitting the message based on a time instance corresponding to the evaluation time offset being included in a threshold timing window and based on the mean reception window size satisfying a target reception window size.

In some examples, the request component 1435 is capable of, configured to, or operable to support a means for transmitting one or more messages including a request to enter the first communication mode based on the round trip time changing from a first round trip time to a second round trip time different from the first round trip time. In some examples, the mode component 1425 is capable of, configured to, or operable to support a means for receiving a third control message indicating the first communication mode. In some examples, the frame timing component 1430 is capable of, configured to, or operable to support a means for modifying the uplink frame timing based on the second round trip time and a set of multiple additional data frames received while operating in accordance with the first communication mode.

In some examples, the request component 1435 is capable of, configured to, or operable to support a means for transmitting, based on modifying the uplink frame timing, a second message including the request to exit the first communication mode. In some examples, the mode component 1425 is capable of, configured to, or operable to support a means for receiving a fourth control message indicating a second configuration of the power-saving mode associated with the holographic communications, where receiving the fourth control message is in accordance with the request to exit the first communication mode.

In some examples, the parameter component 1455 is capable of, configured to, or operable to support a means for receiving one or more control messages including an indication of a set of parameters associated with modifying the uplink frame timing. In some examples, the frame timing component 1430 is capable of, configured to, or operable to support a means for modifying the uplink frame timing in accordance with the set of parameters. In some examples, the set of parameters includes an activation parameter, a round trip time parameter, one or more evaluation period parameters, one or more uplink offset steps, a threshold quantity of evaluation periods, a target reception window size, or any combination thereof.

In some examples, to support modifying the uplink frame timing, the frame timing component 1430 is capable of, configured to, or operable to support a means for modifying the uplink frame timing using one or more uplink offset increments. In some examples, the message includes an indication of one or more parameters associated with the power-saving mode. In some examples, the configuration of the power-saving mode is based on the indication of the one or more parameters.

In some examples, the first communication mode is based on a service associated with the holographic communications being established with one or more network entities. In some examples, the first communication mode is associated with a quantity of PDCCH monitoring occasions that satisfies a threshold quantity of PDCCH monitoring occasions, or a quantity of scheduled uplink resource grants that satisfies a threshold quantity of scheduled uplink resource grants, or any combination thereof.

In some examples, transmitting the message including the request to exit the first communication mode is via radio resource control signaling, via one or more medium access control-control elements, via uplink control information, or any combination thereof.

Additionally, or alternatively, the communications manager 1420 may support wireless communications in accordance with examples as disclosed herein. The timing information component 1440 is capable of, configured to, or operable to support a means for transmitting a timing information report indicative of a transmission time of a data frame transmitted by the wireless communication device and respective reception times of a set of multiple data frames received by the wireless communication device, where the data frame and the set of multiple data frames are associated with holographic communications between a set of multiple wireless communication devices including the wireless communication device. The timing update component 1445 is capable of, configured to, or operable to support a means for receiving a timing update message including an indication to modify an uplink frame timing associated with the holographic communications, where the indication to modify the uplink frame timing is based on the timing information report. In some examples, the frame timing component 1430 is capable of, configured to, or operable to support a means for modifying the uplink frame timing in accordance with the timing update message.

In some examples, the configuration component 1460 is capable of, configured to, or operable to support a means for receiving one or more control messages including a configuration of the timing information report. In some examples, the timing information component 1440 is capable of, configured to, or operable to support a means for transmitting the timing information report in accordance with the configuration.

In some examples, the configuration includes a periodicity associated with transmitting the timing information report, one or more reporting conditions associated with transmitting the timing information report, one or more timing thresholds associated with receiving the set of multiple data frames, one or more time windows associated with timing measurements, or any combination thereof.

In some examples, to support modifying the uplink frame timing, the frame timing component 1430 is capable of, configured to, or operable to support a means for modifying the uplink frame timing in accordance with one or more timing offsets indicated via the timing update message. In some examples, to support modifying the uplink frame timing, the data component 1465 is capable of, configured to, or operable to support a means for transmitting one or more data frames in accordance with the modified uplink frame timing. In some examples, the timing update message includes one or more data frames that are associated with the holographic communications.

In some examples, the timing information component 1440 is capable of, configured to, or operable to support a means for transmitting, based on modifying the uplink frame timing, one or more messages including an indication of the modified uplink frame timing.

In some examples, the one or more messages include a radio resource control message, a medium access control-control element, uplink control information, or any combination thereof. In some examples, the transmission time of the data frame and the respective reception times of the set of multiple data frames are based on a reference time. In some examples, the reference time is associated with a GPS time.

In some examples, the timing information report indicates the transmission time of the data frame and the respective reception times of the set of multiple data frames based on indicating a difference between the transmission time of the data frame and a reception time of a last data frame of the set of multiple data frames.

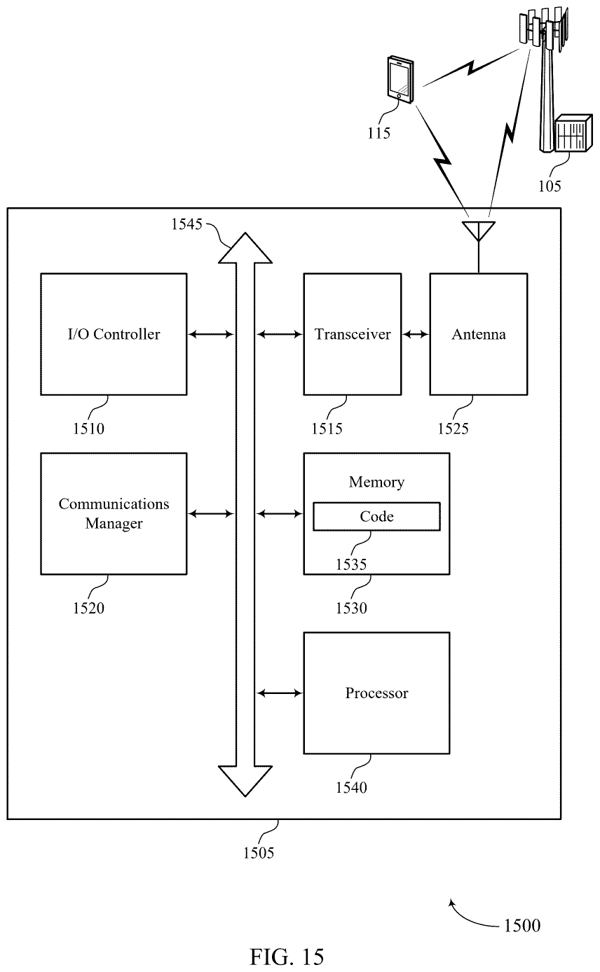

FIG. 15 shows a diagram of a system 1500 including a device 1505 that supports device coordination for holographic communications in accordance with one or more aspects of the present disclosure. The device 1505 may be an example of or include components of a device 1205, a device 1305, or a UE 115 as described herein. The device 1505 may communicate (e.g., wirelessly) with one or more other devices (e.g., network entities 105, UEs 115, or a combination thereof). The device 1505 may include components for bi-directional voice and data communications including components for transmitting and receiving communications, such as a communications manager 1520, an input/output (I/O) controller, such as an I/O controller 1510, a transceiver 1515, one or more antennas 1525, at least one memory 1530, code 1535, and at least one processor 1540. These components may be in electronic communication or otherwise coupled (e.g., operatively, communicatively, functionally, electronically, electrically) via one or more buses (e.g., a bus 1545).

The I/O controller 1510 may manage input and output signals for the device 1505. The I/O controller 1510 may also manage peripherals not integrated into the device 1505. In some cases, the I/O controller 1510 may represent a physical connection or port to an external peripheral. In some cases, the I/O controller 1510 may utilize an operating system such as iOS®, ANDROID®, MS-DOS®, MS-WINDOWS®, OS/2®, UNIX®, LINUX®, or another known operating system. Additionally, or alternatively, the I/O controller 1510 may represent or interact with a modem, a keyboard, a mouse, a touchscreen, or a similar device. In some cases, the I/O controller 1510 may be implemented as part of one or more processors, such as the at least one processor 1540. In some cases, a user may interact with the device 1505 via the I/O controller 1510 or via hardware components controlled by the I/O controller 1510.

In some cases, the device 1505 may include a single antenna. However, in some other cases, the device 1505 may have more than one antenna, which may be capable of concurrently transmitting or receiving multiple wireless transmissions. The transceiver 1515 may communicate bi-directionally via the one or more antennas 1525 using wired or wireless links as described herein. For example, the transceiver 1515 may represent a wireless transceiver and may communicate bi-directionally with another wireless transceiver. The transceiver 1515 may also include a modem to modulate the packets, to provide the modulated packets to one or more antennas 1525 for transmission, and to demodulate packets received from the one or more antennas 1525. The transceiver 1515, or the transceiver 1515 and one or more antennas 1525, may be an example of a transmitter 1215, a transmitter 1315, a receiver 1210, a receiver 1310, or any combination thereof or component thereof, as described herein.

The at least one memory 1530 may include random access memory (RAM) and read-only memory (ROM). The at least one memory 1530 may store computer-readable, computer-executable, or processor-executable code, such as the code 1535. The code 1535 may include instructions that, when executed by the at least one processor 1540, cause the device 1505 to perform various functions described herein. The code 1535 may be stored in a non-transitory computer-readable medium such as system memory or another type of memory. In some cases, the code 1535 may not be directly executable by the at least one processor 1540 but may cause a computer (e.g., when compiled and executed) to perform functions described herein. In some cases, the at least one memory 1530 may include, among other things, a basic I/O system (BIOS) which may control basic hardware or software operation such as the interaction with peripheral components or devices.

The at least one processor 1540 may include one or more intelligent hardware devices (e.g., one or more general-purpose processors, one or more DSPs, one or more CPUs, one or more graphics processing units (GPUs), one or more neural processing units (NPUs) (also referred to as neural network processors or deep learning processors (DLPs)), one or more microcontrollers, one or more ASICs, one or more FPGAs, one or more programmable logic devices, discrete gate or transistor logic, one or more discrete hardware components, or any combination thereof). In some cases, the at least one processor 1540 may be configured to operate a memory array using a memory controller. In some other cases, a memory controller may be integrated into the at least one processor 1540. The at least one processor 1540 may be configured to execute computer-readable instructions stored in a memory (e.g., the at least one memory 1530) to cause the device 1505 to perform various functions (e.g., functions or tasks supporting device coordination for holographic communications). For example, the device 1505 or a component of the device 1505 may include at least one processor 1540 and at least one memory 1530 coupled with or to the at least one processor 1540, the at least one processor 1540 and the at least one memory 1530 configured to perform various functions described herein.

In some examples, the at least one processor 1540 may include multiple processors and the at least one memory 1530 may include multiple memories. One or more of the multiple processors may be coupled with one or more of the multiple memories, which may, individually or collectively, be configured to perform various functions described herein. In some examples, the at least one processor 1540 may be a component of a processing system, which may refer to a system (such as a series) of machines, circuitry (including, for example, one or both of processor circuitry (which may include the at least one processor 1540) and memory circuitry (which may include the at least one memory 1530)), or components, that receives or obtains inputs and processes the inputs to produce, generate, or obtain a set of outputs. The processing system may be configured to perform one or more of the functions described herein. For example, the at least one processor 1540 or a processing system including the at least one processor 1540 may be configured to, configurable to, or operable to cause the device 1505 to perform one or more of the functions described herein. Further, as described herein, being “configured to,” being “configurable to,” and being “operable to” may be used interchangeably and may be associated with a capability, when executing code 1535 (e.g., processor-executable code) stored in the at least one memory 1530 or otherwise, to perform one or more of the functions described herein.

The communications manager 1520 may support wireless communications in accordance with examples as disclosed herein. For example, the communications manager 1520 is capable of, configured to, or operable to support a means for receiving a first control message indicating a first communication mode associated with holographic communications between a set of multiple wireless communication devices, the set of multiple wireless communication devices including the wireless communication device. The communications manager 1520 is capable of, configured to, or operable to support a means for modifying an uplink frame timing based on a round trip time and a set of multiple data frames received while operating in accordance with the first communication mode. The communications manager 1520 is capable of, configured to, or operable to support a means for transmitting, based on modifying the uplink frame timing, a message including a request to exit the first communication mode. The communications manager 1520 is capable of, configured to, or operable to support a means for receiving a second control message indicating a configuration of a power-saving mode associated with the holographic communications, where receiving the second control message is in accordance with the request to exit the first communication mode, and where the power-saving mode corresponds to less frequent communications than the first communication mode.

Additionally, or alternatively, the communications manager 1520 may support wireless communications in accordance with examples as disclosed herein. For example, the communications manager 1520 is capable of, configured to, or operable to support a means for transmitting a timing information report indicative of a transmission time of a data frame transmitted by the wireless communication device and respective reception times of a set of multiple data frames received by the wireless communication device, where the data frame and the set of multiple data frames are associated with holographic communications between a set of multiple wireless communication devices including the wireless communication device. The communications manager 1520 is capable of, configured to, or operable to support a means for receiving a timing update message including an indication to modify an uplink frame timing associated with the holographic communications, where the indication to modify the uplink frame timing is based on the timing information report. The communications manager 1520 is capable of, configured to, or operable to support a means for modifying the uplink frame timing in accordance with the timing update message.

By including or configuring the communications manager 1520 in accordance with examples as described herein, the device 1505 may support techniques for improved communication reliability, reduced latency, improved user experience related to reduced processing, reduced power consumption, more efficient utilization of communication resources, improved coordination between devices, longer battery life, improved utilization of processing capability, among other examples. For example, the techniques supported by the device 1505 may enable efficient power saving operations when exchanging frames for holographic communications, which may also be associated with reduced latency. Further, the techniques supported by the device 1505 may enable improved rendering and processing of data frames (e.g., video frames) based on the frames being received in a coordinated manner, where a single rendering operation may be performed for groups of frames that are received at approximately the same time (e.g., within a threshold duration).

In some examples, the communications manager 1520 may be configured to perform various operations (e.g., receiving, monitoring, transmitting) using or otherwise in cooperation with the transceiver 1515, the one or more antennas 1525, or any combination thereof. Although the communications manager 1520 is illustrated as a separate component, in some examples, one or more functions described with reference to the communications manager 1520 may be supported by or performed by the at least one processor 1540, the at least one memory 1530, the code 1535, or any combination thereof. For example, the code 1535 may include instructions executable by the at least one processor 1540 to cause the device 1505 to perform various aspects of device coordination for holographic communications as described herein, or the at least one processor 1540 and the at least one memory 1530 may be otherwise configured to, individually or collectively, perform or support such operations.

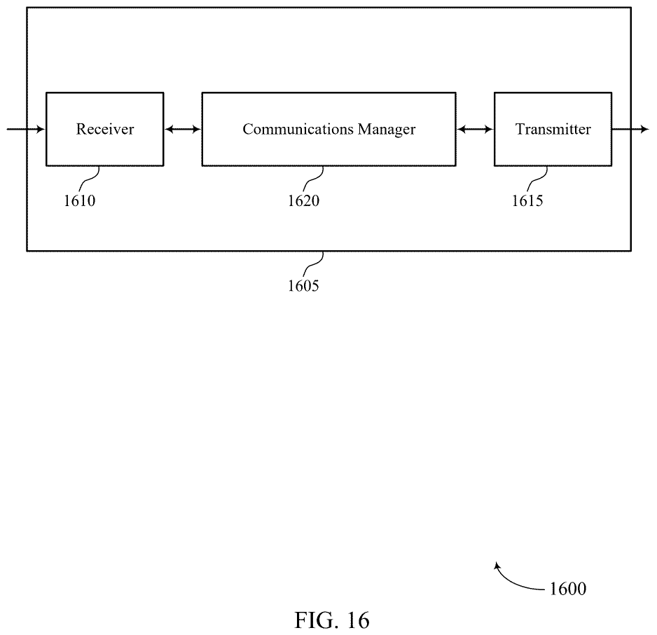

FIG. 16 shows a block diagram 1600 of a device 1605 that supports device coordination for holographic communications in accordance with one or more aspects of the present disclosure. The device 1605 may be an example of aspects of a network entity 105 as described herein. The device 1605 may include a receiver 1610, a transmitter 1615, and a communications manager 1620. The device 1605, or one or more components of the device 1605 (e.g., the receiver 1610, the transmitter 1615, the communications manager 1620), may include at least one processor, which may be coupled with at least one memory, to, individually or collectively, support or enable the described techniques. Each of these components may be in communication with one another (e.g., via one or more buses).

The receiver 1610 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 1605. In some examples, the receiver 1610 may support obtaining information by receiving signals via one or more antennas. Additionally, or alternatively, the receiver 1610 may support obtaining information by receiving signals via one or more wired (e.g., electrical, fiber optic) interfaces, wireless interfaces, or any combination thereof.

The transmitter 1615 may provide a means for outputting (e.g., transmitting, providing, conveying, sending) information generated by other components of the device 1605. For example, the transmitter 1615 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 1615 may support outputting information by transmitting signals via one or more antennas. Additionally, or alternatively, the transmitter 1615 may support outputting information by transmitting signals via one or more wired (e.g., electrical, fiber optic) interfaces, wireless interfaces, or any combination thereof. In some examples, the transmitter 1615 and the receiver 1610 may be co-located in a transceiver, which may include or be coupled with a modem.

The communications manager 1620, the receiver 1610, the transmitter 1615, or various combinations or components thereof may be examples of means for performing various aspects of device coordination for holographic communications as described herein. For example, the communications manager 1620, the receiver 1610, the transmitter 1615, or various combinations or components thereof may be capable of performing one or more of the functions described herein.

In some examples, the communications manager 1620, the receiver 1610, the transmitter 1615, or various combinations or components thereof may be implemented in hardware (e.g., in communications management circuitry). The hardware may include at least one of a processor, a DSP, a CPU, an ASIC, an FPGA or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 1620, the receiver 1610, the transmitter 1615, or various combinations or components thereof may be implemented in code (e.g., as communications management software or firmware) executed by at least one processor (e.g., referred to as a processor-executable code). If implemented in code executed by at least one processor, the functions of the communications manager 1620, the receiver 1610, the transmitter 1615, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 1620 may be configured to perform various operations (e.g., receiving, obtaining, monitoring, outputting, transmitting) using or otherwise in cooperation with the receiver 1610, the transmitter 1615, or both. For example, the communications manager 1620 may receive information from the receiver 1610, send information to the transmitter 1615, or be integrated in combination with the receiver 1610, the transmitter 1615, or both to obtain information, output information, or perform various other operations as described herein.

The communications manager 1620 may support wireless communications in accordance with examples as disclosed herein. For example, the communications manager 1620 is capable of, configured to, or operable to support a means for outputting a first control message indicating a first communication mode associated with holographic communications between a set of multiple wireless communication devices, the set of multiple wireless communication devices including a first wireless communication device. The communications manager 1620 is capable of, configured to, or operable to support a means for obtaining a message including a request to exit the first communication mode, where obtaining the message occurs after modification of an uplink frame timing of the first wireless communication device in accordance with round trip time and a set of multiple data frames associated with the first communication mode. The communications manager 1620 is capable of, configured to, or operable to support a means for outputting a second control message indicating a configuration of a power-saving mode associated with the holographic communications, where outputting the second control message is in accordance with the request to exit the first communication mode.

By including or configuring the communications manager 1620 in accordance with examples as described herein, the device 1605 (e.g., at least one processor controlling or otherwise coupled with the receiver 1610, the transmitter 1615, the communications manager 1620, or a combination thereof) may support techniques for reduced processing, reduced power consumption, and more efficient utilization of communication resources. For example, the techniques supported by the device 1605 may enable efficient power saving operations when exchanging frames for holographic communications, which may also be associated with reduced latency.

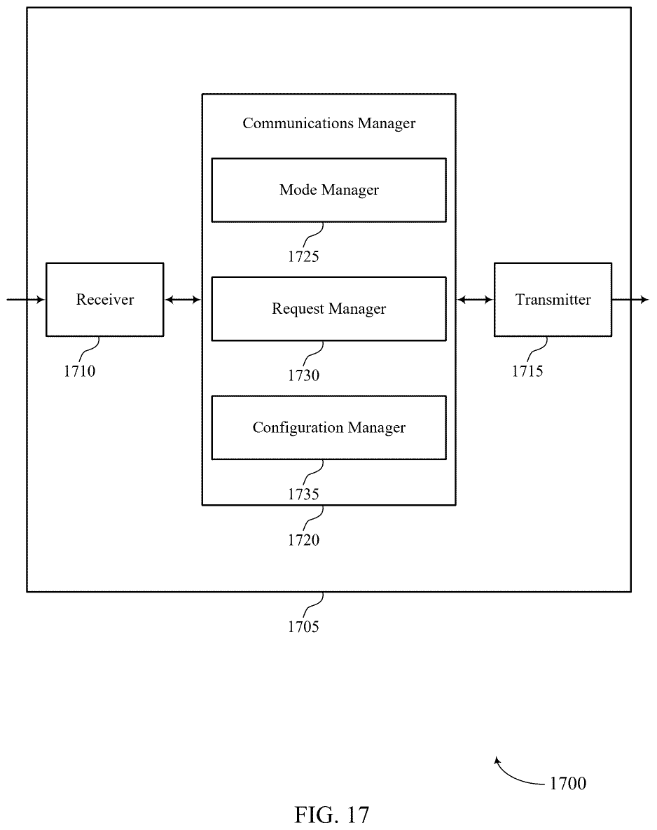

FIG. 17 shows a block diagram 1700 of a device 1705 that supports device coordination for holographic communications in accordance with one or more aspects of the present disclosure. The device 1705 may be an example of aspects of a device 1605 or a network entity 105 as described herein. The device 1705 may include a receiver 1710, a transmitter 1715, and a communications manager 1720. The device 1705, or one or more components of the device 1705 (e.g., the receiver 1710, the transmitter 1715, the communications manager 1720), may include at least one processor, which may be coupled with at least one memory, to support the described techniques. Each of these components may be in communication with one another (e.g., via one or more buses).

The receiver 1710 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 1705. In some examples, the receiver 1710 may support obtaining information by receiving signals via one or more antennas. Additionally, or alternatively, the receiver 1710 may support obtaining information by receiving signals via one or more wired (e.g., electrical, fiber optic) interfaces, wireless interfaces, or any combination thereof.

The transmitter 1715 may provide a means for outputting (e.g., transmitting, providing, conveying, sending) information generated by other components of the device 1705. For example, the transmitter 1715 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 1715 may support outputting information by transmitting signals via one or more antennas. Additionally, or alternatively, the transmitter 1715 may support outputting information by transmitting signals via one or more wired (e.g., electrical, fiber optic) interfaces, wireless interfaces, or any combination thereof. In some examples, the transmitter 1715 and the receiver 1710 may be co-located in a transceiver, which may include or be coupled with a modem.

The device 1705, or various components thereof, may be an example of means for performing various aspects of device coordination for holographic communications as described herein. For example, the communications manager 1720 may include a mode manager 1725, a request manager 1730, a configuration manager 1735, or any combination thereof. The communications manager 1720 may be an example of aspects of a communications manager 1620 as described herein. In some examples, the communications manager 1720, or various components thereof, may be configured to perform various operations (e.g., receiving, obtaining, monitoring, outputting, transmitting) using or otherwise in cooperation with the receiver 1710, the transmitter 1715, or both. For example, the communications manager 1720 may receive information from the receiver 1710, send information to the transmitter 1715, or be integrated in combination with the receiver 1710, the transmitter 1715, or both to obtain information, output information, or perform various other operations as described herein.

The communications manager 1720 may support wireless communications in accordance with examples as disclosed herein. The mode manager 1725 is capable of, configured to, or operable to support a means for outputting a first control message indicating a first communication mode associated with holographic communications between a set of multiple wireless communication devices, the set of multiple wireless communication devices including a first wireless communication device. The request manager 1730 is capable of, configured to, or operable to support a means for obtaining a message including a request to exit the first communication mode, where obtaining the message occurs after modification of an uplink frame timing of the first wireless communication device in accordance with round trip time and a set of multiple data frames associated with the first communication mode. The configuration manager 1735 is capable of, configured to, or operable to support a means for outputting a second control message indicating a configuration of a power-saving mode associated with the holographic communications, where outputting the second control message is in accordance with the request to exit the first communication mode.

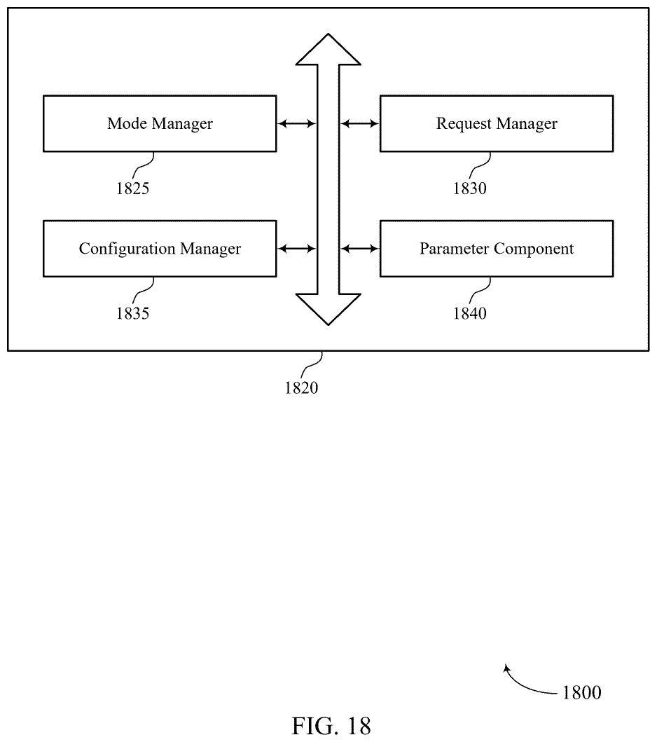

FIG. 18 shows a block diagram 1800 of a communications manager 1820 that supports device coordination for holographic communications in accordance with one or more aspects of the present disclosure. The communications manager 1820 may be an example of aspects of a communications manager 1620, a communications manager 1720, or both, as described herein. The communications manager 1820, or various components thereof, may be an example of means for performing various aspects of device coordination for holographic communications as described herein. For example, the communications manager 1820 may include a mode manager 1825, a request manager 1830, a configuration manager 1835, a parameter component 1840, or any combination thereof. Each of these components, or components or subcomponents thereof (e.g., one or more processors, one or more memories), may communicate, directly or indirectly, with one another (e.g., via one or more buses). The communications may include communications within a protocol layer of a protocol stack, communications associated with a logical channel of a protocol stack (e.g., between protocol layers of a protocol stack, within a device, component, or virtualized component associated with a network entity 105, between devices, components, or virtualized components associated with a network entity 105), or any combination thereof.

The communications manager 1820 may support wireless communications in accordance with examples as disclosed herein. The mode manager 1825 is capable of, configured to, or operable to support a means for outputting a first control message indicating a first communication mode associated with holographic communications between a set of multiple wireless communication devices, the set of multiple wireless communication devices including a first wireless communication device. The request manager 1830 is capable of, configured to, or operable to support a means for obtaining a message including a request to exit the first communication mode, where obtaining the message occurs after modification of an uplink frame timing of the first wireless communication device in accordance with round trip time and a set of multiple data frames associated with the first communication mode. The configuration manager 1835 is capable of, configured to, or operable to support a means for outputting a second control message indicating a configuration of a power-saving mode associated with the holographic communications, where outputting the second control message is in accordance with the request to exit the first communication mode.

In some examples, the request manager 1830 is capable of, configured to, or operable to support a means for obtaining one or more messages including a request for the first communication mode based on the round trip time changing from a first round trip time to a second round trip time different from the first round trip time. In some examples, the mode manager 1825 is capable of, configured to, or operable to support a means for outputting a third control message indicating the first communication mode. In some examples, the request manager 1830 is capable of, configured to, or operable to support a means for obtaining a second message after the uplink frame timing is further modified in accordance with the second round trip time, the second message including the request to exit the first communication mode. In some examples, the configuration manager 1835 is capable of, configured to, or operable to support a means for outputting a fourth control message indicating a second configuration of the power-saving mode associated with the holographic communications, where outputting the fourth control message is in accordance with the request to exit the first communication mode.

In some examples, the parameter component 1840 is capable of, configured to, or operable to support a means for outputting one or more messages including an indication of a set of parameters associated with modifying the uplink frame timing, where the set of parameters includes an activation parameter, a round trip time parameter, one or more evaluation period parameters, one or more uplink offset steps, a threshold quantity of evaluation periods, a target reception window size, or any combination thereof.

In some examples, the message includes an indication of one or more parameters associated with the power-saving mode. In some examples, the configuration of the power-saving mode is based on the indication of the one or more parameters. In some examples, the first communication mode is based on a service associated with the holographic communications being established with the network entity. In some examples, the first communication mode is associated with a quantity of PDCCH monitoring occasions that satisfies a threshold quantity of PDCCH monitoring occasions, or a quantity of scheduled uplink resource grants that satisfies a threshold quantity of scheduled uplink resource grants, or any combination thereof.

In some examples, obtaining the message including the request to exit the first communication mode is via radio resource control signaling, via one or more medium access control-control elements, via uplink control information, or any combination thereof.

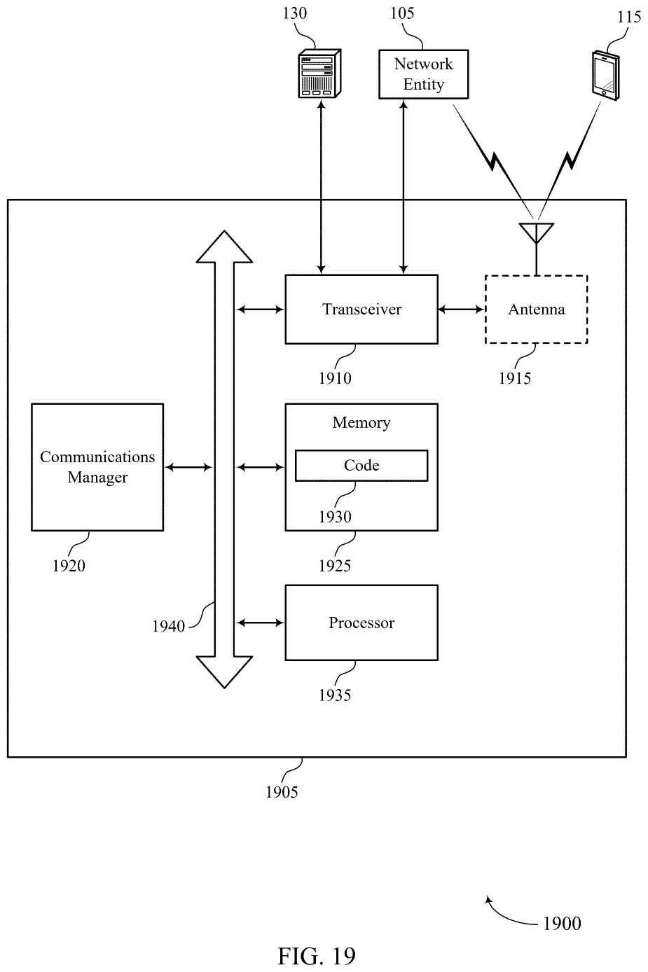

FIG. 19 shows a diagram of a system 1900 including a device 1905 that supports device coordination for holographic communications in accordance with one or more aspects of the present disclosure. The device 1905 may be an example of or include components of a device 1605, a device 1705, or a network entity 105 as described herein. The device 1905 may communicate with other network devices or network equipment such as one or more of the network entities 105, UEs 115, or any combination thereof. The communications may include communications over one or more wired interfaces, over one or more wireless interfaces, or any combination thereof. The device 1905 may include components that support outputting and obtaining communications, such as a communications manager 1920, a transceiver 1910, one or more antennas 1915, at least one memory 1925, code 1930, and at least one processor 1935. These components may be in electronic communication or otherwise coupled (e.g., operatively, communicatively, functionally, electronically, electrically) via one or more buses (e.g., a bus 1940).

The transceiver 1910 may support bi-directional communications via wired links, wireless links, or both as described herein. In some examples, the transceiver 1910 may include a wired transceiver and may communicate bi-directionally with another wired transceiver. Additionally, or alternatively, in some examples, the transceiver 1910 may include a wireless transceiver and may communicate bi-directionally with another wireless transceiver. In some examples, the device 1905 may include one or more antennas 1915, which may be capable of transmitting or receiving wireless transmissions (e.g., concurrently). The transceiver 1910 may also include a modem to modulate signals, to provide the modulated signals for transmission (e.g., by one or more antennas 1915, by a wired transmitter), to receive modulated signals (e.g., from one or more antennas 1915, from a wired receiver), and to demodulate signals. In some implementations, the transceiver 1910 may include one or more interfaces, such as one or more interfaces coupled with the one or more antennas 1915 that are configured to support various receiving or obtaining operations, or one or more interfaces coupled with the one or more antennas 1915 that are configured to support various transmitting or outputting operations, or a combination thereof. In some implementations, the transceiver 1910 may include or be configured for coupling with one or more processors or one or more memory components that are operable to perform or support operations based on received or obtained information or signals, or to generate information or other signals for transmission or other outputting, or any combination thereof. In some implementations, the transceiver 1910, or the transceiver 1910 and the one or more antennas 1915, or the transceiver 1910 and the one or more antennas 1915 and one or more processors or one or more memory components (e.g., the at least one processor 1935, the at least one memory 1925, or both), may be included in a chip or chip assembly that is installed in the device 1905. In some examples, the transceiver 1910 may be operable to support communications via one or more communications links (e.g., communication link(s) 125, backhaul communication link(s) 120, a midhaul communication link 162, a fronthaul communication link 168).

The at least one memory 1925 may include RAM, ROM, or any combination thereof. The at least one memory 1925 may store computer-readable, computer-executable, or processor-executable code, such as the code 1930. The code 1930 may include instructions that, when executed by one or more of the at least one processor 1935, cause the device 1905 to perform various functions described herein. The code 1930 may be stored in a non-transitory computer-readable medium such as system memory or another type of memory. In some cases, the code 1930 may not be directly executable by a processor of the at least one processor 1935 but may cause a computer (e.g., when compiled and executed) to perform functions described herein. In some cases, the at least one memory 1925 may include, among other things, a BIOS which may control basic hardware or software operation such as the interaction with peripheral components or devices. In some examples, the at least one processor 1935 may include multiple processors and the at least one memory 1925 may include multiple memories. One or more of the multiple processors may be coupled with one or more of the multiple memories which may, individually or collectively, be configured to perform various functions herein (for example, as part of a processing system).

The at least one processor 1935 may include one or more intelligent hardware devices (e.g., one or more general-purpose processors, one or more DSPs, one or more CPUs, one or more graphics processing units (GPUs), one or more neural processing units (NPUs) (also referred to as neural network processors or deep learning processors (DLPs)), one or more microcontrollers, one or more ASICs, one or more FPGAs, one or more programmable logic devices, discrete gate or transistor logic, one or more discrete hardware components, or any combination thereof). In some cases, the at least one processor 1935 may be configured to operate a memory array using a memory controller. In some other cases, a memory controller may be integrated into one or more of the at least one processor 1935. The at least one processor 1935 may be configured to execute computer-readable instructions stored in a memory (e.g., one or more of the at least one memory 1925) to cause the device 1905 to perform various functions (e.g., functions or tasks supporting device coordination for holographic communications). For example, the device 1905 or a component of the device 1905 may include at least one processor 1935 and at least one memory 1925 coupled with one or more of the at least one processor 1935, the at least one processor 1935 and the at least one memory 1925 configured to perform various functions described herein. The at least one processor 1935 may be an example of a cloud-computing platform (e.g., one or more physical nodes and supporting software such as operating systems, virtual machines, or container instances) that may host the functions (e.g., by executing code 1930) to perform the functions of the device 1905. The at least one processor 1935 may be any one or more suitable processors capable of executing scripts or instructions of one or more software programs stored in the device 1905 (such as within one or more of the at least one memory 1925).

In some examples, the at least one processor 1935 may include multiple processors and the at least one memory 1925 may include multiple memories. One or more of the multiple processors may be coupled with one or more of the multiple memories, which may, individually or collectively, be configured to perform various functions herein. In some examples, the at least one processor 1935 may be a component of a processing system, which may refer to a system (such as a series) of machines, circuitry (including, for example, one or both of processor circuitry (which may include the at least one processor 1935) and memory circuitry (which may include the at least one memory 1925)), or components, that receives or obtains inputs and processes the inputs to produce, generate, or obtain a set of outputs. The processing system may be configured to perform one or more of the functions described herein. For example, the at least one processor 1935 or a processing system including the at least one processor 1935 may be configured to, configurable to, or operable to cause the device 1905 to perform one or more of the functions described herein. Further, as described herein, being “configured to,” being “configurable to,” and being “operable to” may be used interchangeably and may be associated with a capability, when executing code stored in the at least one memory 1925 or otherwise, to perform one or more of the functions described herein.

In some examples, a bus 1940 may support communications of (e.g., within) a protocol layer of a protocol stack. In some examples, a bus 1940 may support communications associated with a logical channel of a protocol stack (e.g., between protocol layers of a protocol stack), which may include communications performed within a component of the device 1905, or between different components of the device 1905 that may be co-located or located in different locations (e.g., where the device 1905 may refer to a system in which one or more of the communications manager 1920, the transceiver 1910, the at least one memory 1925, the code 1930, and the at least one processor 1935 may be located in one of the different components or divided between different components).

In some examples, the communications manager 1920 may manage aspects of communications with a core network 130 (e.g., via one or more wired or wireless backhaul links). For example, the communications manager 1920 may manage the transfer of data communications for client devices, such as one or more UEs 115. In some examples, the communications manager 1920 may manage communications with one or more other network entities 105, and may include a controller or scheduler for controlling communications with UEs 115 (e.g., in cooperation with the one or more other network devices). In some examples, the communications manager 1920 may support an X2 interface within an LTE/LTE-A wireless communications network technology to provide communication between network entities 105.

The communications manager 1920 may support wireless communications in accordance with examples as disclosed herein. For example, the communications manager 1920 is capable of, configured to, or operable to support a means for outputting a first control message indicating a first communication mode associated with holographic communications between a set of multiple wireless communication devices, the set of multiple wireless communication devices including a first wireless communication device. The communications manager 1920 is capable of, configured to, or operable to support a means for obtaining a message including a request to exit the first communication mode, where obtaining the message occurs after modification of an uplink frame timing of the first wireless communication device in accordance with round trip time and a set of multiple data frames associated with the first communication mode. The communications manager 1920 is capable of, configured to, or operable to support a means for outputting a second control message indicating a configuration of a power-saving mode associated with the holographic communications, where outputting the second control message is in accordance with the request to exit the first communication mode.

By including or configuring the communications manager 1920 in accordance with examples as described herein, the device 1905 may support techniques for improved communication reliability, reduced latency, improved user experience related to reduced processing, reduced power consumption, more efficient utilization of communication resources, improved coordination between devices, longer battery life, improved utilization of processing capability, among other improvements. For example, the techniques supported by the device 1905 may enable efficient power saving operations when exchanging frames for holographic communications, which may also be associated with reduced latency.

In some examples, the communications manager 1920 may be configured to perform various operations (e.g., receiving, obtaining, monitoring, outputting, transmitting) using or otherwise in cooperation with the transceiver 1910, the one or more antennas 1915 (e.g., where applicable), or any combination thereof. Although the communications manager 1920 is illustrated as a separate component, in some examples, one or more functions described with reference to the communications manager 1920 may be supported by or performed by the transceiver 1910, one or more of the at least one processor 1935, one or more of the at least one memory 1925, the code 1930, or any combination thereof (for example, by a processing system including at least a portion of the at least one processor 1935, the at least one memory 1925, the code 1930, or any combination thereof). For example, the code 1930 may include instructions executable by one or more of the at least one processor 1935 to cause the device 1905 to perform various aspects of device coordination for holographic communications as described herein, or the at least one processor 1935 and the at least one memory 1925 may be otherwise configured to, individually or collectively, perform or support such operations.

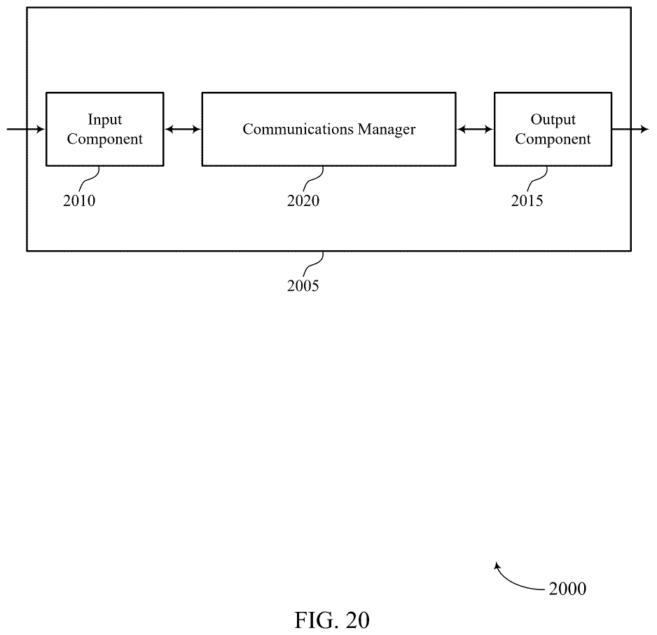

FIG. 20 shows a block diagram 2000 of a device 2005 that supports device coordination for holographic communications in accordance with one or more aspects of the present disclosure. The device 2005 may be an example of aspects of an application server as described herein. The device 2005 may include an input component 2010, an output component 2015, and a communications manager 2020. The device 2005, or one or more components of the device 2005 (e.g., the input component 2010, the output component 2015, the communications manager 2020), may include at least one processor, which may be coupled with at least one memory, to, individually or collectively, support or enable the described techniques. Each of these components may be in communication with one another (e.g., via one or more buses).

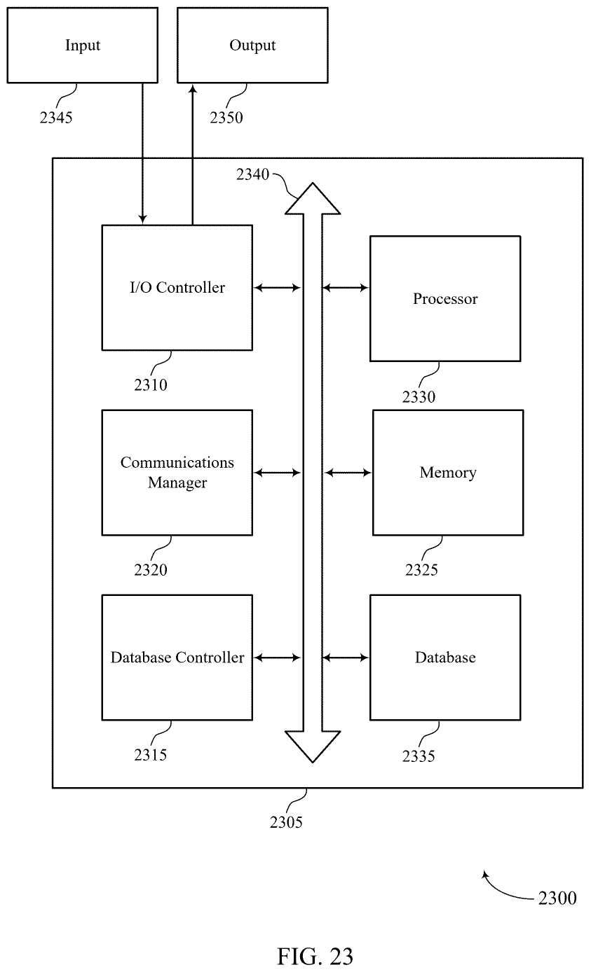

The input component 2010 may manage input signals for the device 2005. For example, the input component 2010 may identify input signals based on an interaction with a modem, a keyboard, a mouse, a touchscreen, or a similar device. These input signals may be associated with user input or processing at other components or devices. In some cases, the input component 2010 may utilize an operating system such as iOS®, ANDROID®, MS-DOS®, MS-WINDOWS®, OS/2®, UNIX®, LINUX®, or another known operating system to handle input signals. The input component 2010 may send aspects of these input signals to other components of the device 2005 for processing. For example, the input component 2010 may transmit input signals to the communications manager 2020 to support device coordination for holographic communications. In some cases, the input component 2010 may be a component of an I/O controller 2310 as described with reference to FIG. 23.

The output component 2015 may manage output signals for the device 2005. For example, the output component 2015 may receive signals from other components of the device 2005, such as the communications manager 2020, and may transmit these signals to other components or devices. In some specific examples, the output component 2015 may transmit output signals for display in a user interface, for storage in a database or data store, for further processing at a server or server cluster, or for any other processes at any number of devices or systems. In some cases, the output component 2015 may be a component of an I/O controller 2310 as described with reference to FIG. 23.

The communications manager 2020, the input component 2010, the output component 2015, or various combinations or components thereof may be examples of means for performing various aspects of device coordination for holographic communications as described herein. For example, the communications manager 2020, the input component 2010, the output component 2015, or various combinations or components thereof may be capable of performing one or more of the functions described herein.

In some examples, the communications manager 2020, the input component 2010, the output component 2015, or various combinations or components thereof may be implemented in hardware (e.g., in communications management circuitry). The hardware may include at least one of a processor, a DSP, a CPU, an ASIC, an FPGA or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 2020, the input component 2010, the output component 2015, or various combinations or components thereof may be implemented in code (e.g., as communications management software or firmware) executed by at least one processor (e.g., referred to as a processor-executable code). If implemented in code executed by at least one processor, the functions of the communications manager 2020, the input component 2010, the output component 2015, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 2020 may be configured to perform various operations (e.g., receiving, obtaining, monitoring, outputting, transmitting) using or otherwise in cooperation with the input component 2010, the output component 2015, or both. For example, the communications manager 2020 may receive information from the input component 2010, send information to the output component 2015, or be integrated in combination with the input component 2010, the output component 2015, or both to obtain information, output information, or perform various other operations as described herein.

The communications manager 2020 may support wireless communications in accordance with examples as disclosed herein. For example, the communications manager 2020 is capable of, configured to, or operable to support a means for obtaining a respective timing information report from each wireless communication device of a set of multiple wireless communication devices, where the respective timing information reports are each indicative of a transmission time of a data frame transmitted by a respective wireless communication device and respective reception times of a set of multiple data frames received by the respective wireless communication device, the data frame and the set of multiple data frames associated with holographic communications between the set of multiple wireless communication devices. The communications manager 2020 is capable of, configured to, or operable to support a means for outputting, to each wireless communication device of the set of multiple wireless communication devices, a respective timing update message including an indication to modify an uplink frame timing associated with the holographic communications, where the indication to modify the uplink frame timing is based on the respective timing information reports.

By including or configuring the communications manager 2020 in accordance with examples as described herein, the device 2005 (e.g., at least one processor controlling or otherwise coupled with the input component 2010, the output component 2015, the communications manager 2020, or a combination thereof) may support techniques for reduced processing, reduced power consumption, and more efficient utilization of communication resources.

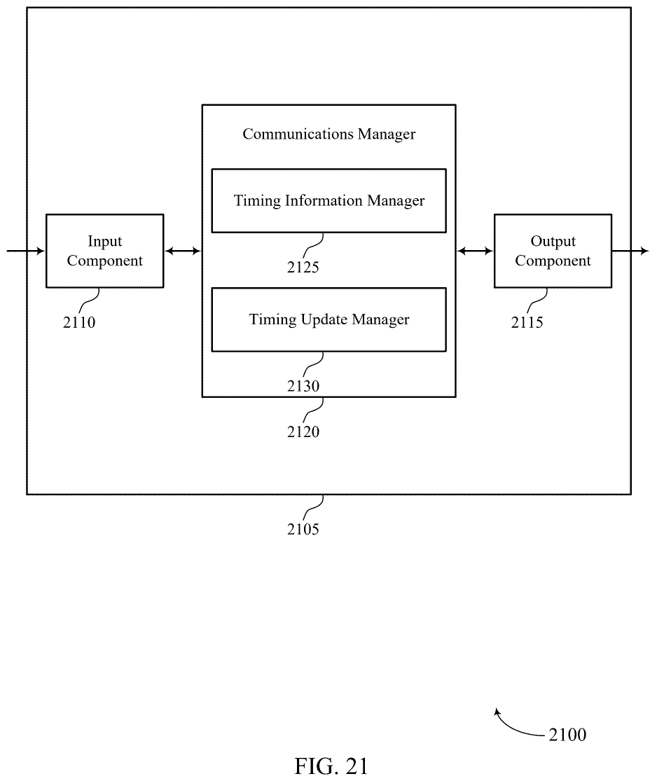

FIG. 21 shows a block diagram 2100 of a device 2105 that supports device coordination for holographic communications in accordance with one or more aspects of the present disclosure. The device 2105 may be an example of aspects of a device 2005 or an application server as described herein. The device 2105 may include an input component 2110, an output component 2115, and a communications manager 2120. The device 2105, or one or more components of the device 2105 (e.g., the input component 2110, the output component 2115, the communications manager 2120), may include at least one processor, which may be coupled with at least one memory, to support the described techniques. Each of these components may be in communication with one another (e.g., via one or more buses).

The input component 2110 may manage input signals for the device 2105. For example, the input component 2110 may identify input signals based on an interaction with a modem, a keyboard, a mouse, a touchscreen, or a similar device. These input signals may be associated with user input or processing at other components or devices. In some cases, the input component 2110 may utilize an operating system such as iOS®, ANDROID®, MS-DOS®, MS-WINDOWS®, OS/2®, UNIX®, LINUX®, or another known operating system to handle input signals. The input component 2110 may send aspects of these input signals to other components of the device 2105 for processing. For example, the input component 2110 may transmit input signals to the communications manager 2120 to support device coordination for holographic communications. In some cases, the input component 2110 may be a component of an I/O controller 2310 as described with reference to FIG. 23.

The output component 2115 may manage output signals for the device 2105. For example, the output component 2115 may receive signals from other components of the device 2105, such as the communications manager 2120, and may transmit these signals to other components or devices. In some specific examples, the output component 2115 may transmit output signals for display in a user interface, for storage in a database or data store, for further processing at a server or server cluster, or for any other processes at any number of devices or systems. In some cases, the output component 2115 may be a component of an I/O controller 2310 as described with reference to FIG. 23.

The device 2105, or various components thereof, may be an example of means for performing various aspects of device coordination for holographic communications as described herein. For example, the communications manager 2120 may include a timing information manager 2125 a timing update manager 2130, or any combination thereof. The communications manager 2120 may be an example of aspects of a communications manager 2020 as described herein. In some examples, the communications manager 2120, or various components thereof, may be configured to perform various operations (e.g., receiving, obtaining, monitoring, outputting, transmitting) using or otherwise in cooperation with the input component 2110, the output component 2115, or both. For example, the communications manager 2120 may receive information from the input component 2110, send information to the output component 2115, or be integrated in combination with the input component 2110, the output component 2115, or both to obtain information, output information, or perform various other operations as described herein.

The communications manager 2120 may support wireless communications in accordance with examples as disclosed herein. The timing information manager 2125 is capable of, configured to, or operable to support a means for obtaining a respective timing information report from each wireless communication device of a set of multiple wireless communication devices, where the respective timing information reports are each indicative of a transmission time of a data frame transmitted by a respective wireless communication device and respective reception times of a set of multiple data frames received by the respective wireless communication device, the data frame and the set of multiple data frames associated with holographic communications between the set of multiple wireless communication devices. The timing update manager 2130 is capable of, configured to, or operable to support a means for outputting, to each wireless communication device of the set of multiple wireless communication devices, a respective timing update message including an indication to modify an uplink frame timing associated with the holographic communications, where the indication to modify the uplink frame timing is based on the respective timing information reports.

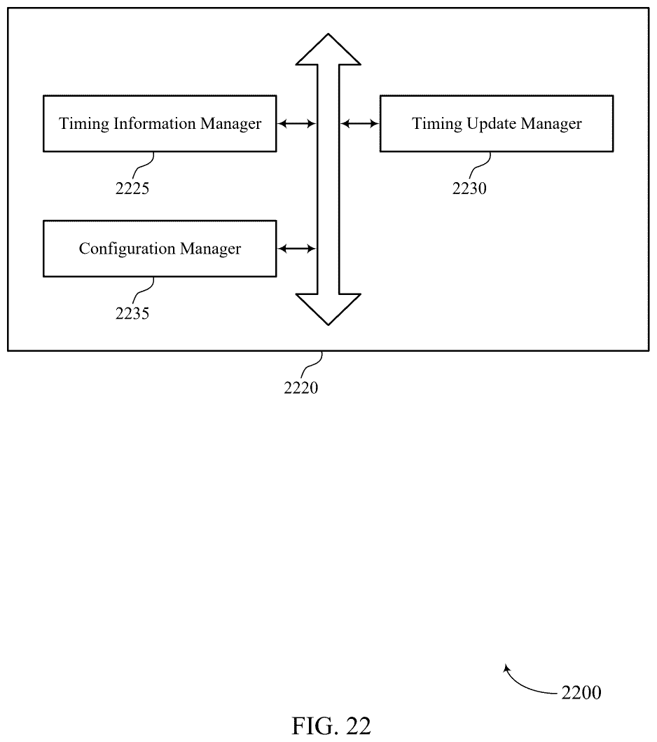

FIG. 22 shows a block diagram 2200 of a communications manager 2220 that supports device coordination for holographic communications in accordance with one or more aspects of the present disclosure. The communications manager 2220 may be an example of aspects of a communications manager 2020, a communications manager 2120, or both, as described herein. The communications manager 2220, or various components thereof, may be an example of means for performing various aspects of device coordination for holographic communications as described herein. For example, the communications manager 2220 may include a timing information manager 2225, a timing update manager 2230, a configuration manager 2235, or any combination thereof. Each of these components, or components or subcomponents thereof (e.g., one or more processors, one or more memories), may communicate, directly or indirectly, with one another (e.g., via one or more buses).

The communications manager 2220 may support wireless communications in accordance with examples as disclosed herein. The timing information manager 2225 is capable of, configured to, or operable to support a means for obtaining a respective timing information report from each wireless communication device of a set of multiple wireless communication devices, where the respective timing information reports are each indicative of a transmission time of a data frame transmitted by a respective wireless communication device and respective reception times of a set of multiple data frames received by the respective wireless communication device, the data frame and the set of multiple data frames associated with holographic communications between the set of multiple wireless communication devices. The timing update manager 2230 is capable of, configured to, or operable to support a means for outputting, to each wireless communication device of the set of multiple wireless communication devices, a respective timing update message including an indication to modify an uplink frame timing associated with the holographic communications, where the indication to modify the uplink frame timing is based on the respective timing information reports.

In some examples, the configuration manager 2235 is capable of, configured to, or operable to support a means for outputting one or more control messages including a configuration of the respective timing information reports. In some examples, the timing information manager 2225 is capable of, configured to, or operable to support a means for obtaining the respective timing information report in accordance with the configuration.

In some examples, the configuration includes a periodicity associated with transmitting the respective timing information reports, one or more reporting conditions associated with transmitting the respective timing information reports, one or more timing thresholds associated with receiving the set of multiple data frames, one or more time windows associated with timing measurements, or any combination thereof.

In some examples, the respective timing update messages indicate one or more timing offsets associated with modifying the uplink frame timing. In some examples, the transmission time of the data frame and the respective reception times of the set of multiple data frames are based on a reference time. In some examples, the reference time is associated with a GPS time.

In some examples, the respective timing information report indicates the transmission time of the data frame and the respective reception times of the set of multiple data frames based on indicating a difference between the transmission time of the data frame a reception time of a last data frame of the set of multiple data frames.

FIG. 23 shows a diagram of a system 2300 including a device 2305 that supports device coordination for holographic communications in accordance with one or more aspects of the present disclosure. The device 2305 may be an example of or include components of a device 2005, a device 2105, or an application server as described herein. The device 2305 may include components for bi-directional voice and data communications including components for transmitting and receiving communications, such as a communications manager 2320, an I/O controller, such as an I/O controller 2310, a database controller 2315, at least one memory 2325, at least one processor 2330, and a database 2335. These components may be in electronic communication or otherwise coupled (e.g., operatively, communicatively, functionally, electronically, electrically) via one or more buses (e.g., a bus 2340).

The I/O controller 2310 may manage input signals 2345 and output signals 2350 for the device 2305. The I/O controller 2310 may also manage peripherals not integrated into the device 2305. In some cases, the I/O controller 2310 may represent a physical connection or port to an external peripheral. In some cases, the I/O controller 2310 may utilize an operating system such as iOS®, ANDROID®, MS-DOS®, MS-WINDOWS®, OS/2®, UNIX®, LINUX®, or another known operating system. Additionally, or alternatively, the I/O controller 2310 may represent or interact with a modem, a keyboard, a mouse, a touchscreen, or a similar device. In some cases, the I/O controller 2310 may be implemented as part of a processor. In some examples, a user may interact with the device 2305 via the I/O controller 2310 or via hardware components controlled by the I/O controller 2310.

The database controller 2315 may manage data storage and processing in a database 2335. The database 2335 may be external to the device 2305, temporarily or permanently connected to the device 2305, or a data storage component of the device 2305. In some cases, a user may interact with the database controller 2315. In some other cases, the database controller 2315 may operate automatically without user interaction. The database 2335 may be an example of a persistent data store, a single database, a distributed database, multiple distributed databases, a database management system, or an emergency backup database.

Memory 2325 may include random-access memory (RAM) and ROM. The memory 2325 may store computer-readable, computer-executable software including instructions that, when executed, cause the processor to perform various functions described herein. In some cases, the memory 2325 may contain, among other things, a BIOS which may control basic hardware or software operation such as the interaction with peripheral components or devices.

The processor 2330 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some cases, the processor 2330 may be configured to operate a memory array using a memory controller. In some other cases, a memory controller may be integrated into the processor 2330. The processor 2330 may be configured to execute computer-readable instructions stored in memory 2325 to perform various functions (e.g., functions or tasks supporting device coordination for holographic communications).

The communications manager 2320 may support wireless communications in accordance with examples as disclosed herein. For example, the communications manager 2320 is capable of, configured to, or operable to support a means for obtaining a respective timing information report from each wireless communication device of a set of multiple wireless communication devices, where the respective timing information reports are each indicative of a transmission time of a data frame transmitted by a respective wireless communication device and respective reception times of a set of multiple data frames received by the respective wireless communication device, the data frame and the set of multiple data frames associated with holographic communications between the set of multiple wireless communication devices. The communications manager 2320 is capable of, configured to, or operable to support a means for outputting, to each wireless communication device of the set of multiple wireless communication devices, a respective timing update message including an indication to modify an uplink frame timing associated with the holographic communications, where the indication to modify the uplink frame timing is based on the respective timing information reports.

By including or configuring the communications manager 2320 in accordance with examples as described herein, the device 2305 may support techniques for improved communication reliability, reduced latency, improved user experience related to reduced processing, reduced power consumption, more efficient utilization of communication resources, improved coordination between devices, longer battery life, improved utilization of processing capability, among other improvements.

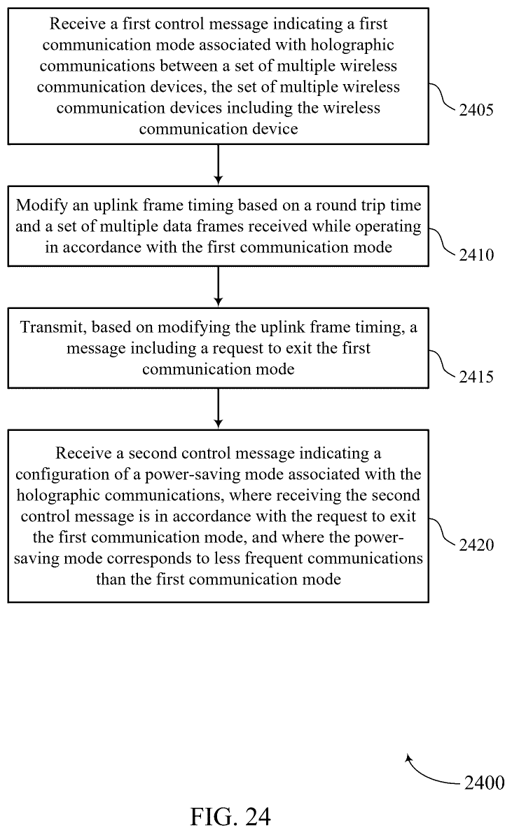

FIG. 24 shows a flowchart illustrating a method 2400 that supports device coordination for holographic communications in accordance with one or more aspects of the present disclosure. The operations of the method 2400 may be implemented by a UE or its components as described herein. For example, the operations of the method 2400 may be performed by a UE 115 as described with reference to FIGS. 1 through 15. In some examples, a UE may execute a set of instructions to control the functional elements of the UE to perform the described functions. Additionally, or alternatively, the UE may perform aspects of the described functions using special-purpose hardware.

At 2405, the method may include receiving a first control message indicating a first communication mode associated with holographic communications between a set of multiple wireless communication devices, the set of multiple wireless communication devices including the wireless communication device. The operations of 2405 may be performed in accordance with examples as disclosed herein, such as the configuration of the first communication mode at 710, as described with reference to FIG. 7. In some examples, aspects of the operations of 2405 may be performed by a mode component 1425 as described with reference to FIG. 14.

At 2410, the method may include modifying an uplink frame timing based on a round trip time and a set of multiple data frames received while operating in accordance with the first communication mode. The operations of 2410 may be performed in accordance with examples as disclosed herein, such as the modification of the uplink frame timing at 725, as described with reference to FIG. 7, or the modification of the frame timing in accordance with the process flow 600 that is described with, and illustrated in, FIG. 6. In some examples, aspects of the operations of 2410 may be performed by a frame timing component 1430 as described with reference to FIG. 14.

At 2415, the method may include transmitting, based on modifying the uplink frame timing, a message including a request to exit the first communication mode. The operations of 2415 may be performed in accordance with examples as disclosed herein, such as the transmission of the message at 730, as described with reference to FIG. 7. In some examples, aspects of the operations of 2415 may be performed by a request component 1435 as described with reference to FIG. 14.

At 2420, the method may include receiving a second control message indicating a configuration of a power-saving mode associated with the holographic communications, where receiving the second control message is in accordance with the request to exit the first communication mode, and where the power-saving mode corresponds to less frequent communications than the first communication mode. The operations of 2420 may be performed in accordance with examples as disclosed herein, such as the reception of the control message at 735, as described with reference to FIG. 7. In some examples, aspects of the operations of 2420 may be performed by a mode component 1425 as described with reference to FIG. 14.

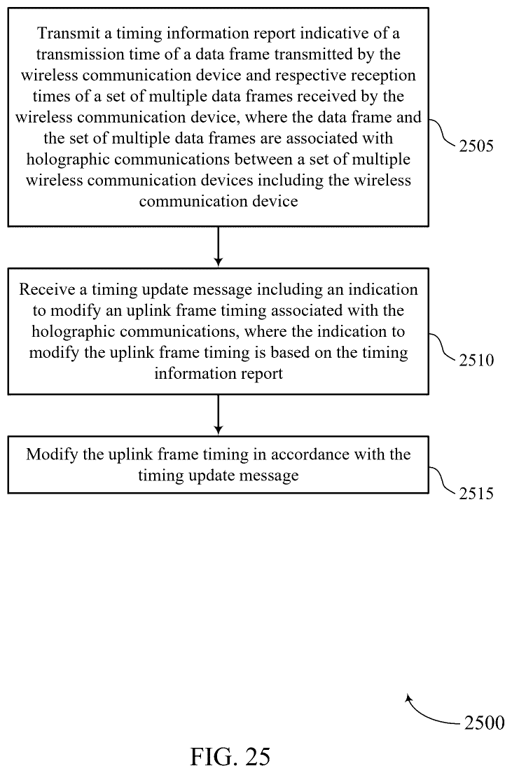

FIG. 25 shows a flowchart illustrating a method 2500 that supports device coordination for holographic communications in accordance with one or more aspects of the present disclosure. The operations of the method 2500 may be implemented by a UE or its components as described herein. For example, the operations of the method 2500 may be performed by a UE 115 as described with reference to FIGS. 1 through 15. In some examples, a UE may execute a set of instructions to control the functional elements of the UE to perform the described functions. Additionally, or alternatively, the UE may perform aspects of the described functions using special-purpose hardware.

At 2505, the method may include transmitting a timing information report indicative of a transmission time of a data frame transmitted by the wireless communication device and respective reception times of a set of multiple data frames received by the wireless communication device, where the data frame and the set of multiple data frames are associated with holographic communications between a set of multiple wireless communication devices including the wireless communication device. The operations of 2505 may be performed in accordance with examples as disclosed herein, such as the transmission of the timing information report via in-band signaling with a frame at 905, as described with reference to FIG. 9, and as similarly described with reference to the frames 1005 and 1105 as described with reference to FIGS. 10 and 11, respectively. In some examples, aspects of the operations of 2505 may be performed by a timing information component 1440 as described with reference to FIG. 14.

At 2510, the method may include receiving a timing update message including an indication to modify an uplink frame timing associated with the holographic communications, where the indication to modify the uplink frame timing is based on the timing information report. The operations of 2510 may be performed in accordance with examples as disclosed herein, such as the reception of the timing update message at 925 as described with reference to FIG. 9, and as similarly described with reference to the indication to modify the uplink timing and timing offset described with reference to FIG. 11. In some examples, aspects of the operations of 2510 may be performed by a timing update component 1445 as described with reference to FIG. 14.

At 2515, the method may include modifying the uplink frame timing in accordance with the timing update message. The operations of 2515 may be performed in accordance with examples as disclosed herein, such as the timing update at 930 described with reference to FIG. 9, as well as the timing update 1150 described with reference to FIG. 11. In some examples, aspects of the operations of 2515 may be performed by a frame timing component 1430 as described with reference to FIG. 14.

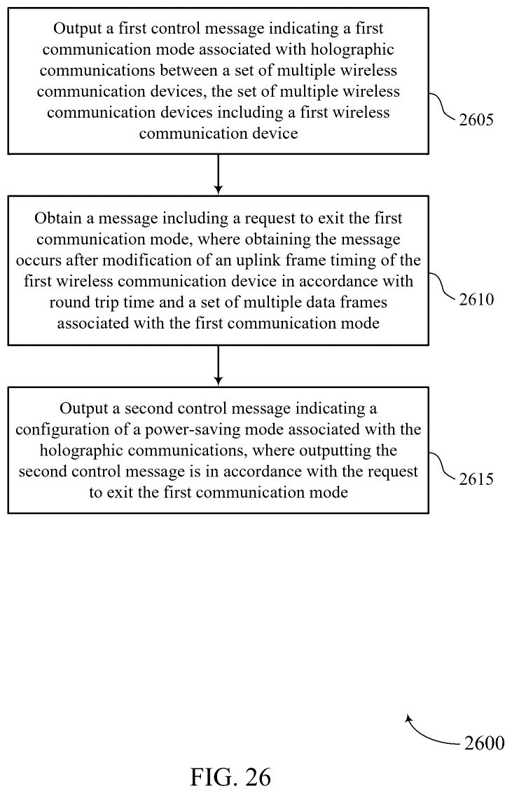

FIG. 26 shows a flowchart illustrating a method 2600 that supports device coordination for holographic communications in accordance with one or more aspects of the present disclosure. The operations of the method 2600 may be implemented by a network entity or its components as described herein. For example, the operations of the method 2600 may be performed by a network entity as described with reference to FIGS. 1 through 11 and 16 through 19. In some examples, a network entity may execute a set of instructions to control the functional elements of the network entity to perform the described functions. Additionally, or alternatively, the network entity may perform aspects of the described functions using special-purpose hardware.

At 2605, the method may include outputting a first control message indicating a first communication mode associated with holographic communications between a set of multiple wireless communication devices, the set of multiple wireless communication devices including a first wireless communication device. The operations of 2605 may be performed in accordance with examples as disclosed herein, such as the configuration of the first communication mode at 710, as described with reference to FIG. 7. In some examples, aspects of the operations of 2605 may be performed by a mode manager 1825 as described with reference to FIG. 18.

At 2610, the method may include obtaining a message including a request to exit the first communication mode, where obtaining the message occurs after modification of an uplink frame timing of the first wireless communication device in accordance with round trip time and a set of multiple data frames associated with the first communication mode. The operations of 2610 may be performed in accordance with examples as disclosed herein, such as the reception of the message at 730, as described with reference to FIG. 7. In some examples, aspects of the operations of 2610 may be performed by a request manager 1830 as described with reference to FIG. 18.

At 2615, the method may include outputting a second control message indicating a configuration of a power-saving mode associated with the holographic communications, where outputting the second control message is in accordance with the request to exit the first communication mode. The operations of 2615 may be performed in accordance with examples as disclosed herein, such as the reception of the control message at 735, as described with reference to FIG. 7. In some examples, aspects of the operations of 2615 may be performed by a configuration manager 1835 as described with reference to FIG. 18.

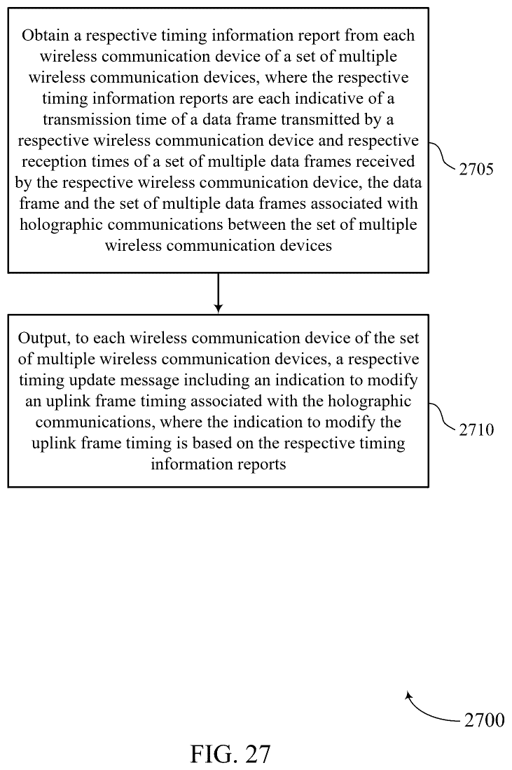

FIG. 27 shows a flowchart illustrating a method 2700 that supports device coordination for holographic communications in accordance with one or more aspects of the present disclosure. The operations of the method 2700 may be implemented by an application server or its components as described herein. For example, the operations of the method 2700 may be performed by an application server as described with reference to FIGS. 1 through 11 and 20 through 23. In some examples, an application server may execute a set of instructions to control the functional elements of the application server to perform the described functions. Additionally, or alternatively, the application server may perform aspects of the described functions using special-purpose hardware.

At 2705, the method may include obtaining a respective timing information report from each wireless communication device of a set of multiple wireless communication devices, where the respective timing information reports are each indicative of a transmission time of a data frame transmitted by a respective wireless communication device and respective reception times of a set of multiple data frames received by the respective wireless communication device, the data frame and the set of multiple data frames associated with holographic communications between the set of multiple wireless communication devices. The operations of 2705 may be performed in accordance with examples as disclosed herein, such as the transmission of the timing information report via in-band signaling with a frame at 905, as described with reference to FIG. 9, and as similarly described with reference to the frames 1005 and 1105 as described with reference to FIGS. 10 and 11, respectively. In some examples, aspects of the operations of 2705 may be performed by a timing information manager 2225 as described with reference to FIG. 22.

At 2710, the method may include outputting, to each wireless communication device of the set of multiple wireless communication devices, a respective timing update message including an indication to modify an uplink frame timing associated with the holographic communications, where the indication to modify the uplink frame timing is based on the respective timing information reports. The operations of 2710 may be performed in accordance with examples as disclosed herein, such as the timing update at 930 described with reference to FIG. 9, as well as the timing update 1150 described with reference to FIG. 11. In some examples, aspects of the operations of 2710 may be performed by a timing update manager 2230 as described with reference to FIG. 22.

The following provides an overview of aspects of the present disclosure:

Aspect 1: A method for wireless communications by a wireless communication device, comprising: receiving a first control message indicating a first communication mode associated with holographic communications between a plurality of wireless communication devices, the plurality of wireless communication devices including the wireless communication device; modifying an uplink frame timing based at least in part on a round trip time and a plurality of data frames received while operating in accordance with the first communication mode; transmitting, based at least in part on modifying the uplink frame timing, a message comprising a request to exit the first communication mode; and receiving a second control message indicating a configuration of a power-saving mode associated with the holographic communications, wherein receiving the second control message is in accordance with the request to exit the first communication mode, and wherein the power-saving mode corresponds to less frequent communications than the first communication mode.

Aspect 2: The method of aspect 1, wherein modifying the uplink frame timing comprises: calculating a plurality of time offsets based at least in part on the round trip time and the plurality of data frames, wherein each time offset of the plurality of time offsets comprises a respective difference between a first time and a second time, the first time comprising a time instance that is the round trip time after transmission of a first frame by the wireless communication device, the second time comprising a reception time of a data frame of the plurality of data frames from a respective wireless communication device of the plurality of wireless communication devices; calculating a mean time offset based at least in part on the plurality of time offsets; and modifying the uplink frame timing based at least in part on the mean time offset.

Aspect 3: The method of aspect 2, further comprising: comparing the mean time offset to the round trip time, wherein modifying the uplink frame timing is based at least in part on the mean time offset being different from the round trip time.

Aspect 4: The method of any of aspects 2 through 3, further comprising: calculating an evaluation time offset for each evaluation period of one or more evaluation periods, each evaluation period of the one or more evaluation periods comprising a plurality of consecutive traffic periods, and each traffic period of the plurality of consecutive traffic periods corresponding to a reception window during which the plurality of data frames are received.

Aspect 5: The method of aspect 4, further comprising: calculating, for each traffic period of the plurality of consecutive traffic periods, a respective mean time offset based at least in part on a set of time offsets associated with each traffic period, wherein each time offset of the set of time offsets comprises the respective difference between the first time and the second time, and wherein calculating the evaluation time offset comprises: calculating the evaluation time offset based at least in part on the respective mean time offsets.

Aspect 6: The method of any of aspects 4 through 5, further comprising: calculating, for each traffic period of the plurality of consecutive traffic periods, a reception window size of the reception window corresponding to each traffic period, the reception window size being based at least in part on a first data frame and a last data frame of the plurality of data frames received from the plurality of wireless communication devices; and calculating, for each evaluation period, a mean reception window size based at least in part on the reception window sizes, wherein modifying the uplink frame timing comprises: modifying the uplink frame timing based at least in part on the evaluation time offset or the mean reception window size, or both.

Aspect 7: The method of aspect 6, wherein modifying the uplink frame timing comprises: modifying the uplink frame timing in accordance with the evaluation time offset based at least in part on a time instance corresponding to the evaluation time offset being outside of a threshold timing window.

Aspect 8: The method of aspect 6, wherein modifying the uplink frame timing comprises: modifying the uplink frame timing in accordance with the mean reception window size based at least in part on a time instance corresponding to the evaluation time offset being included in a threshold timing window, wherein modifying the uplink frame timing is further based at least in part on the mean reception window size failing to satisfy a target reception window size.

Aspect 9: The method of any of aspects 6 through 8, wherein transmitting the message comprises: transmitting the message based at least in part on a time instance corresponding to the evaluation time offset being included in a threshold timing window and based at least in part on the mean reception window size satisfying a target reception window size.

Aspect 10: The method of any of aspects 1 through 9, further comprising: transmitting one or more messages comprising a request to enter the first communication mode based at least in part on the round trip time changing from a first round trip time to a second round trip time different from the first round trip time; receiving a third control message indicating the first communication mode; and modifying the uplink frame timing based at least in part on the second round trip time and a plurality of additional data frames received while operating in accordance with the first communication mode.

Aspect 11: The method of aspect 10, further comprising: transmitting, based at least in part on modifying the uplink frame timing, a second message comprising the request to exit the first communication mode; and receiving a fourth control message indicating a second configuration of the power-saving mode associated with the holographic communications, wherein receiving the fourth control message is in accordance with the request to exit the first communication mode.

Aspect 12: The method of any of aspects 1 through 11, further comprising: receiving one or more control messages comprising an indication of a set of parameters associated with modifying the uplink frame timing, wherein modifying the uplink frame timing comprises: modifying the uplink frame timing in accordance with the set of parameters.

Aspect 13: The method of aspect 12, wherein the set of parameters comprises an activation parameter, a round trip time parameter, one or more evaluation period parameters, one or more uplink offset steps, a threshold quantity of evaluation periods, a target reception window size, or any combination thereof.

Aspect 14: The method of any of aspects 1 through 13, wherein modifying the uplink frame timing comprises: modifying the uplink frame timing using one or more uplink offset increments.

Aspect 15: The method of any of aspects 1 through 14, wherein the message comprises an indication of one or more parameters associated with the power-saving mode, and the configuration of the power-saving mode is based at least in part on the indication of the one or more parameters.

Aspect 16: The method of any of aspects 1 through 15, wherein the first communication mode is based at least in part on a service associated with the holographic communications being established with one or more network entities, and the first communication mode is associated with a quantity of PDCCH monitoring occasions that satisfies a threshold quantity of PDCCH monitoring occasions, or a quantity of scheduled uplink resource grants that satisfies a threshold quantity of scheduled uplink resource grants, or any combination thereof.

Aspect 17: The method of any of aspects 1 through 16, wherein transmitting the message comprising the request to exit the first communication mode is via radio resource control signaling, via one or more medium access control-control elements, via uplink control information, or any combination thereof.

Aspect 18: A method for wireless communications by a wireless communication device, comprising: transmitting a timing information report indicative of a transmission time of a data frame transmitted by the wireless communication device and respective reception times of a plurality of data frames received by the wireless communication device, wherein the data frame and the plurality of data frames are associated with holographic communications between a plurality of wireless communication devices including the wireless communication device; receiving a timing update message comprising an indication to modify an uplink frame timing associated with the holographic communications, wherein the indication to modify the uplink frame timing is based at least in part on the timing information report; and modifying the uplink frame timing in accordance with the timing update message.

Aspect 19: The method of aspect 18, further comprising: receiving one or more control messages comprising a configuration of the timing information report, wherein transmitting the timing information report comprises: transmitting the timing information report in accordance with the configuration.

Aspect 20: The method of aspect 19, wherein the configuration comprises a periodicity associated with transmitting the timing information report, one or more reporting conditions associated with transmitting the timing information report, one or more timing thresholds associated with receiving the plurality of data frames, one or more time windows associated with timing measurements, or any combination thereof.

Aspect 21: The method of any of aspects 18 through 20, wherein modifying the uplink frame timing comprises: modifying the uplink frame timing in accordance with one or more timing offsets indicated via the timing update message, the method further comprising: transmitting one or more data frames in accordance with the modified uplink frame timing.

Aspect 22: The method of any of aspects 18 through 21, wherein the timing update message comprises one or more data frames that are associated with the holographic communications.

Aspect 23: The method of any of aspects 18 through 22, further comprising: transmitting, based at least in part on modifying the uplink frame timing, one or more messages comprising an indication of the modified uplink frame timing.

Aspect 24: The method of aspect 23, wherein the one or more messages comprise a radio resource control message, a medium access control-control element, uplink control information, or any combination thereof.

Aspect 25: The method of any of aspects 18 through 24, wherein the transmission time of the data frame and the respective reception times of the plurality of data frames are based at least in part on a reference time.

Aspect 26: The method of aspect 25, wherein the reference time is associated with a GPS time.

Aspect 27: The method of any of aspects 18 through 26, wherein the timing information report indicates the transmission time of the data frame and the respective reception times of the plurality of data frames based at least in part on indicating a difference between the transmission time of the data frame and a reception time of a last data frame of the plurality of data frames.

Aspect 28: A method for wireless communications by a network entity, comprising: outputting a first control message indicating a first communication mode associated with holographic communications between a plurality of wireless communication devices, the plurality of wireless communication devices including a first wireless communication device; obtaining a message comprising a request to exit the first communication mode, wherein obtaining the message occurs after modification of an uplink frame timing of the first wireless communication device in accordance with round trip time and a plurality of data frames associated with the first communication mode; and outputting a second control message indicating a configuration of a power-saving mode associated with the holographic communications, wherein outputting the second control message is in accordance with the request to exit the first communication mode.

Aspect 29: The method of aspect 28, further comprising: obtaining one or more messages comprising a request for the first communication mode based at least in part on the round trip time changing from a first round trip time to a second round trip time different from the first round trip time; outputting a third control message indicating the first communication mode; obtaining a second message after the uplink frame timing is further modified in accordance with the second round trip time, the second message comprising the request to exit the first communication mode; and outputting a fourth control message indicating a second configuration of the power-saving mode associated with the holographic communications, wherein outputting the fourth control message is in accordance with the request to exit the first communication mode.

Aspect 30: The method of any of aspects 28 through 29, further comprising: outputting one or more messages comprising an indication of a set of parameters associated with modifying the uplink frame timing, wherein the set of parameters comprises an activation parameter, a round trip time parameter, one or more evaluation period parameters, one or more uplink offset steps, a threshold quantity of evaluation periods, a target reception window size, or any combination thereof.

Aspect 31: The method of any of aspects 28 through 30, wherein the message comprises an indication of one or more parameters associated with the power-saving mode, and the configuration of the power-saving mode is based at least in part on the indication of the one or more parameters.

Aspect 32: The method of any of aspects 28 through 31, wherein the first communication mode is based at least in part on a service associated with the holographic communications being established with the network entity, and the first communication mode is associated with a quantity of PDCCH monitoring occasions that satisfies a threshold quantity of PDCCH monitoring occasions, or a quantity of scheduled uplink resource grants that satisfies a threshold quantity of scheduled uplink resource grants, or any combination thereof.

Aspect 33: The method of any of aspects 28 through 32, wherein obtaining the message comprising the request to exit the first communication mode is via radio resource control signaling, via one or more medium access control-control elements, via uplink control information, or any combination thereof.

Aspect 34: A method for wireless communications by an application server, comprising: obtaining a respective timing information report from each wireless communication device of a plurality of wireless communication devices, wherein the respective timing information reports are each indicative of a transmission time of a data frame transmitted by a respective wireless communication device and respective reception times of a plurality of data frames received by the respective wireless communication device, the data frame and the plurality of data frames associated with holographic communications between the plurality of wireless communication devices; and outputting, to each wireless communication device of the plurality of wireless communication devices, a respective timing update message comprising an indication to modify an uplink frame timing associated with the holographic communications, wherein the indication to modify the uplink frame timing is based at least in part on the respective timing information reports.

Aspect 35: The method of aspect 34, further comprising: outputting one or more control messages comprising a configuration of the respective timing information reports, wherein obtaining the respective timing information report comprises: obtaining the respective timing information report in accordance with the configuration.

Aspect 36: The method of aspect 35, wherein the configuration comprises a periodicity associated with transmitting the respective timing information reports, one or more reporting conditions associated with transmitting the respective timing information reports, one or more timing thresholds associated with receiving the plurality of data frames, one or more time windows associated with timing measurements, or any combination thereof.

Aspect 37: The method of any of aspects 34 through 36, wherein the respective timing update messages indicate one or more timing offsets associated with modifying the uplink frame timing.

Aspect 38: The method of any of aspects 34 through 37, wherein the transmission time of the data frame and the respective reception times of the plurality of data frames are based at least in part on a reference time.

Aspect 39: The method of aspect 38, wherein the reference time is associated with a GPS time.

Aspect 40: The method of aspect 35, wherein the respective timing information report indicates the transmission time of the data frame and the respective reception times of the plurality of data frames based at least in part on indicating a difference between the transmission time of the data frame a reception time of a last data frame of the plurality of data frames.

Aspect 41: A wireless communication device for wireless communications, comprising one or more memories storing processor-executable code, and one or more processors coupled with the one or more memories and individually or collectively operable to execute the code to cause the wireless communication device to perform a method of any of aspects 1 through 17.

Aspect 42: A wireless communication device for wireless communications, comprising at least one means for performing a method of any of aspects 1 through 17.

Aspect 43: A non-transitory computer-readable medium storing code for wireless communications, the code comprising instructions executable by one or more processors to perform a method of any of aspects 1 through 17.

Aspect 44: A wireless communication device for wireless communications, comprising one or more memories storing processor-executable code, and one or more processors coupled with the one or more memories and individually or collectively operable to execute the code to cause the wireless communication device to perform a method of any of aspects 18 through 27.

Aspect 45: A wireless communication device for wireless communications, comprising at least one means for performing a method of any of aspects 18 through 27.

Aspect 46: A non-transitory computer-readable medium storing code for wireless communications, the code comprising instructions executable by one or more processors to perform a method of any of aspects 18 through 27.

Aspect 47: A network entity for wireless communications, comprising one or more memories storing processor-executable code, and one or more processors coupled with the one or more memories and individually or collectively operable to execute the code to cause the network entity to perform a method of any of aspects 28 through 33.

Aspect 48: A network entity for wireless communications, comprising at least one means for performing a method of any of aspects 28 through 33.

Aspect 49: A non-transitory computer-readable medium storing code for wireless communications, the code comprising instructions executable by one or more processors to perform a method of any of aspects 28 through 33.

Aspect 50: An application server for wireless communications, comprising one or more memories storing processor-executable code, and one or more processors coupled with the one or more memories and individually or collectively operable to execute the code to cause the application server to perform a method of any of aspects 34 through 40.

Aspect 51: An application server for wireless communications, comprising at least one means for performing a method of any of aspects 34 through 40.

Aspect 52: A non-transitory computer-readable medium storing code for wireless communications, the code comprising instructions executable by one or more processors to perform a method of any of aspects 34 through 40.

It should be noted that the methods described herein describe possible implementations. The operations and the steps may be rearranged or otherwise modified and other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed using a general-purpose processor, a DSP, an ASIC, a CPU, a graphics processing unit (GPU), a neural processing unit (NPU), an FPGA or other programmable logic device, discrete gate or transistor logic, discrete hardware components, or any combination thereof designed to perform the functions described herein. A general-purpose processor may be a microprocessor but, in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration). Any functions or operations described herein as being capable of being performed by a processor may be performed by multiple processors that, individually or collectively, are capable of performing the described functions or operations.

The functions described herein may be implemented using hardware, software executed by a processor, firmware, or any combination thereof. If implemented using software executed by a processor, the functions may be stored as or transmitted using one or more instructions or code of a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one location to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk, and Blu-ray disc. Disks may reproduce data magnetically, and discs may reproduce data optically using lasers. Combinations of the above are also included within the scope of computer-readable media. Any functions or operations described herein as being capable of being performed by a memory may be performed by multiple memories that, individually or collectively, are capable of performing the described functions or operations.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

As used herein, including in the claims, the article “a” before a noun is open-ended and understood to refer to “at least one” of those nouns or “one or more” of those nouns. Thus, the terms “a,” “at least one,” “one or more,” and “at least one of one or more” may be interchangeable. For example, if a claim recites “a component” that performs one or more functions, each of the individual functions may be performed by a single component or by any combination of multiple components. Thus, the term “a component” having characteristics or performing functions may refer to “at least one of one or more components” having a particular characteristic or performing a particular function. Subsequent reference to a component introduced with the article “a” using the terms “the” or “said” may refer to any or all of the one or more components. For example, a component introduced with the article “a” may be understood to mean “one or more components,” and referring to “the component” subsequently in the claims may be understood to be equivalent to referring to “at least one of the one or more components.” Similarly, subsequent reference to a component introduced as “one or more components” using the terms “the” or “said” may refer to any or all of the one or more components. For example, referring to “the one or more components” subsequently in the claims may be understood to be equivalent to referring to “at least one of the one or more components.”

The term “determine” or “determining” encompasses a variety of actions and, therefore, “determining” can include calculating, computing, processing, deriving, investigating, looking up (such as via looking up in a table, a database, or another data structure), ascertaining, and the like. Also, “determining” can include receiving (e.g., receiving information), accessing (e.g., accessing data stored in memory), and the like. Also, “determining” can include resolving, obtaining, selecting, choosing, establishing, and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label or other subsequent reference label.

The description set forth herein, in connection with the appended drawings, describes example configurations and does not represent all the examples that may be implemented or that are within the scope of the claims. The term “example” used herein means “serving as an example, instance, or illustration” and not “preferred” or “advantageous over other examples.” The detailed description includes specific details for the purpose of providing an understanding of the described techniques. These techniques, however, may be practiced without these specific details. In some figures, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A wireless communication device, comprising:
one or more memories storing processor-executable code; and
one or more processors coupled with the one or more memories and individually or collectively operable to execute the code to cause the wireless communication device to:
receive a first control message indicating a first communication mode associated with holographic communications between a plurality of wireless communication devices, the plurality of wireless communication devices including the wireless communication device;
modify an uplink frame timing based at least in part on a round trip time and a plurality of data frames received while operating in accordance with the first communication mode;
transmit, based at least in part on modifying the uplink frame timing, a message comprising a request to exit the first communication mode; and
receive a second control message indicating a configuration of a power-saving mode associated with the holographic communications, wherein receiving the second control message is in accordance with the request to exit the first communication mode, and wherein the power-saving mode corresponds to less frequent communications than the first communication mode.

2. The wireless communication device of claim 1, wherein, to modify the uplink frame timing, the one or more processors are individually or collectively operable to execute the code to cause the wireless communication device to:
calculate a plurality of time offsets based at least in part on the round trip time and the plurality of data frames, wherein each time offset of the plurality of time offsets comprises a respective difference between a first time and a second time, the first time comprising a time instance that is the round trip time after transmission of a first frame by the wireless communication device, the second time comprising a reception time of a data frame of the plurality of data frames from a respective wireless communication device of the plurality of wireless communication devices;
calculate a mean time offset based at least in part on the plurality of time offsets; and
modify the uplink frame timing based at least in part on the mean time offset.

3. The wireless communication device of claim 2, wherein the one or more processors are individually or collectively further operable to execute the code to cause the wireless communication device to:
compare the mean time offset to the round trip time, wherein modifying the uplink frame timing is based at least in part on the mean time offset being different from the round trip time.

4. The wireless communication device of claim 2, wherein the one or more processors are individually or collectively further operable to execute the code to cause the wireless communication device to:
calculate an evaluation time offset for each evaluation period of one or more evaluation periods, each evaluation period of the one or more evaluation periods comprising a plurality of consecutive traffic periods, and each traffic period of the plurality of consecutive traffic periods corresponding to a reception window during which the plurality of data frames are received.

5. The wireless communication device of claim 4, wherein the one or more processors are individually or collectively further operable to execute the code to cause the wireless communication device to:
calculate, for each traffic period of the plurality of consecutive traffic periods, a respective mean time offset based at least in part on a set of time offsets associated with each traffic period, wherein each time offset of the set of time offsets comprises the respective difference between the first time and the second time, and wherein, to calculate the evaluation time offset, the one or more processors are individually or collectively operable to execute the code to cause the wireless communication device to:
calculate the evaluation time offset based at least in part on the respective mean time offsets.

6. The wireless communication device of claim 4, wherein the one or more processors are individually or collectively further operable to execute the code to cause the wireless communication device to:
calculate, for each traffic period of the plurality of consecutive traffic periods, a reception window size of the reception window corresponding to each traffic period, the reception window size being based at least in part on a first data frame and a last data frame of the plurality of data frames received from the plurality of wireless communication devices; and
calculate, for each evaluation period, a mean reception window size based at least in part on the reception window sizes, wherein, to modify the uplink frame timing, the one or more processors are individually or collectively operable to execute the code to cause the wireless communication device to:
modify the uplink frame timing based at least in part on the evaluation time offset or the mean reception window size, or both.

7. The wireless communication device of claim 6, wherein, to modify the uplink frame timing, the one or more processors are individually or collectively operable to execute the code to cause the wireless communication device to:
modify the uplink frame timing in accordance with the evaluation time offset based at least in part on a time instance corresponding to the evaluation time offset being outside of a threshold timing window.

8. The wireless communication device of claim 6, wherein, to modify the uplink frame timing, the one or more processors are individually or collectively operable to execute the code to cause the wireless communication device to:
modify the uplink frame timing in accordance with the mean reception window size based at least in part on a time instance corresponding to the evaluation time offset being included in a threshold timing window, wherein modifying the uplink frame timing is further based at least in part on the mean reception window size failing to satisfy a target reception window size.

9. The wireless communication device of claim 6, wherein, to transmit the message, the one or more processors are individually or collectively operable to execute the code to cause the wireless communication device to:
transmit the message based at least in part on a time instance corresponding to the evaluation time offset being included in a threshold timing window and based at least in part on the mean reception window size satisfying a target reception window size.

10. The wireless communication device of claim 1, wherein the one or more processors are individually or collectively further operable to execute the code to cause the wireless communication device to:
transmit one or more messages comprising a request to enter the first communication mode based at least in part on the round trip time changing from a first round trip time to a second round trip time different from the first round trip time;
receive a third control message indicating the first communication mode; and
modify the uplink frame timing based at least in part on the second round trip time and a plurality of additional data frames received while operating in accordance with the first communication mode.

11. The wireless communication device of claim 10, wherein the one or more processors are individually or collectively further operable to execute the code to cause the wireless communication device to:
transmit, based at least in part on modifying the uplink frame timing, a second message comprising the request to exit the first communication mode; and
receive a fourth control message indicating a second configuration of the power-saving mode associated with the holographic communications, wherein receiving the fourth control message is in accordance with the request to exit the first communication mode.

12. The wireless communication device of claim 1, wherein the one or more processors are individually or collectively further operable to execute the code to cause the wireless communication device to:
receive one or more control messages comprising an indication of a set of parameters associated with modifying the uplink frame timing, wherein, to modify the uplink frame timing, the one or more processors are individually or collectively operable to execute the code to cause the wireless communication device to:
modify the uplink frame timing in accordance with the set of parameters.

13. The wireless communication device of claim 1, wherein, to modify the uplink frame timing, the one or more processors are individually or collectively operable to execute the code to cause the wireless communication device to:
modify the uplink frame timing using one or more uplink offset increments.

14. The wireless communication device of claim 1, wherein the message comprises an indication of one or more parameters associated with the power-saving mode, and wherein the configuration of the power-saving mode is based at least in part on the indication of the one or more parameters.

15. A wireless communication device, comprising:
one or more memories storing processor-executable code; and
one or more processors coupled with the one or more memories and individually or collectively operable to execute the code to cause the wireless communication device to:
transmit a timing information report indicative of a transmission time of a data frame transmitted by the wireless communication device and respective reception times of a plurality of data frames received by the wireless communication device, wherein the data frame and the plurality of data frames are associated with holographic communications between a plurality of wireless communication devices including the wireless communication device;
receive a timing update message comprising an indication to modify an uplink frame timing associated with the holographic communications, wherein the indication to modify the uplink frame timing is based at least in part on the timing information report; and
modify the uplink frame timing in accordance with the timing update message.

16. The wireless communication device of claim 15, wherein the one or more processors are individually or collectively further operable to execute the code to cause the wireless communication device to:
receive one or more control messages comprising a configuration of the timing information report, wherein, to transmit the timing information report, the one or more processors are individually or collectively operable to execute the code to cause the wireless communication device to:
transmit the timing information report in accordance with the configuration.

17. The wireless communication device of claim 15, wherein, to modify the uplink frame timing, the one or more processors are individually or collectively operable to execute the code to cause the wireless communication device to:
modify the uplink frame timing in accordance with one or more timing offsets indicated via the timing update message, wherein the one or more processors are individually or collectively further operable to execute the code to cause the wireless communication device to:
transmit one or more data frames in accordance with the modified uplink frame timing.

18. A network entity, comprising:
one or more memories storing processor-executable code; and
one or more processors coupled with the one or more memories and individually or collectively operable to execute the code to cause the network entity to:
output a first control message indicating a first communication mode associated with holographic communications between a plurality of wireless communication devices, the plurality of wireless communication devices including a first wireless communication device;
obtain a message comprising a request to exit the first communication mode, wherein obtaining the message occurs after modification of an uplink frame timing of the first wireless communication device in accordance with round trip time and a plurality of data frames associated with the first communication mode; and
output a second control message indicating a configuration of a power-saving mode associated with the holographic communications, wherein outputting the second control message is in accordance with the request to exit the first communication mode.

19. The network entity of claim 18, wherein the one or more processors are individually or collectively further operable to execute the code to cause the network entity to:
obtain one or more messages comprising a request for the first communication mode based at least in part on the round trip time changing from a first round trip time to a second round trip time different from the first round trip time;
output a third control message indicating the first communication mode;
obtain a second message after the uplink frame timing is further modified in accordance with the second round trip time, the second message comprising the request to exit the first communication mode; and
output a fourth control message indicating a second configuration of the power-saving mode associated with the holographic communications, wherein outputting the fourth control message is in accordance with the request to exit the first communication mode.

20. The network entity of claim 18, wherein the message comprises an indication of one or more parameters associated with the power-saving mode, and wherein the configuration of the power-saving mode is based at least in part on the indication of the one or more parameters.
